SEQUENCE LISTING (33 sequences)

SEQ ID NO: 1 - DNA, 53 bp, Artificial Sequence
  Synthetic
agctacctaactggatacgattctaatgactctttttgagtcattagaatcgt

SEQ ID NO: 2 - DNA, 20 bp, Artificial Sequence
  Synthetic
tacaggcctcacgttacctg

SEQ ID NO: 3 - DNA, 20 bp, Artificial Sequence
  Synthetic
caggtaacgtgaggcctgtt

SEQ ID NO: 4 - DNA, 9 bp, Artificial Sequence
  Synthetic
ggaccactt

SEQ ID NO: 5 - DNA, 9 bp, Artificial Sequence
  Synthetic
agaccttag

SEQ ID NO: 6 - DNA, 9 bp, Artificial Sequence
  Synthetic
cctctaagg

SEQ ID NO: 7 - DNA, 9 bp, Artificial Sequence
  Synthetic
ctgaccaga

SEQ ID NO: 8 - DNA, 9 bp, Artificial Sequence
  Synthetic
tacttctga

SEQ ID NO: 9 - DNA, 9 bp, Artificial Sequence
  Synthetic
agtaatact

SEQ ID NO: 10 - DNA, 9 bp, Artificial Sequence
  Synthetic
actcagaac

SEQ ID NO: 11 - DNA, 9 bp, Artificial Sequence
  Synthetic
ataaggaga

SEQ ID NO: 12 - DNA, 9 bp, Artificial Sequence
  Synthetic
tagagctgt

SEQ ID NO: 13 - DNA, 9 bp, Artificial Sequence
  Synthetic
gagtgtgtc

SEQ ID NO: 14 - DNA, 9 bp, Artificial Sequence
  Synthetic
ctgttactc

SEQ ID NO: 15 - DNA, 9 bp, Artificial Sequence
  Synthetic
tacaggtag

SEQ ID NO: 16 - DNA, 9 bp, Artificial Sequence
  Synthetic
ctctcaaga

SEQ ID NO: 17 - DNA, 9 bp, Artificial Sequence
  Synthetic
tgtactagt

SEQ ID NO: 18 - DNA, 9 bp, Artificial Sequence
  Synthetic
actctatgt

SEQ ID NO: 19 - DNA, 9 bp, Artificial Sequence
  Synthetic
gtaagaaca

SEQ ID NO: 20 - protein, 9 aa, Artificial Sequence
  Synthetic
GPACYAWYT

SEQ ID NO: 21 - protein, 9 aa, Artificial Sequence
  Synthetic
PFGHHCQNR

SEQ ID NO: 22 - protein, 9 aa, Artificial Sequence
  Synthetic
QGVRRKRSW

SEQ ID NO: 23 - protein, 9 aa, Artificial Sequence
  Synthetic
SGFMIVLGD

SEQ ID NO: 24 - protein, 9 aa, Artificial Sequence
  Synthetic
YACGHHVRR

SEQ ID NO: 25 - protein, 9 aa, Artificial Sequence
  Synthetic
AWHVRRFMI

SEQ ID NO: 26 - protein, 9 aa, Artificial Sequence
  Synthetic
SWRFMICGH

SEQ ID NO: 27 - protein, 9 aa, Artificial Sequence
  Synthetic
GDMHCQHVR

SEQ ID NO: 28 - protein, 9 aa, Artificial Sequence
  Synthetic
RRQRKRRFM

SEQ ID NO: 29 - protein, 9 aa, Artificial Sequence
  Synthetic
MISGVRRNF

SEQ ID NO: 30 - protein, 9 aa, Artificial Sequence
  Synthetic
GHQEFMIDG

SEQ ID NO: 31 - protein, 9 aa, Artificial Sequence
  Synthetic
MRERQRKRR

SEQ ID NO: 32 - DNA, 41 bp, Artificial Sequence
  misc_feature 22, 23, 24, 25, 26, 27, 28, 29, 30, 31, 32, 33, 34, 35,36, 37, 38, 39, 40, 41: n = A,T,C or G
  based on Saccharomyces cerevisiae
ggaattccagctaccaccatgnnnnnnnnnnnnnnnnnnnn

SEQ ID NO: 33 - DNA, 40 bp, Artificial Sequence
  misc_feature 21, 22, 23, 24, 25, 26, 27, 28, 29, 30, 31, 32, 33, 34,35, 36, 37, 38, 39, 40: n = A,T,C or G
  based on Saccharomyces cerevisiae
gatccccgggaattgccatgnnnnnnnnnnnnnnnnnnnn

(19) United States
(12) Patent Application Publication
(10) Pub. No.: US 2003/0182068 A1
(43) Pub. Date: Sep. 25, 2003

(54) Device and methods for directed synthesis of chemical libraries

(76) Inventors: Bronwyn J. Battersby, Riverhills (AU); Christopher R. Miller, MacGregor (AU); Mathias Trau, Balmoral (AU); Jeffery C. Way, Cambridge, MA (US); Angus Johnston, St. Lucia (AU)

Correspondence Address: CLARK & ELBING LLP, 101 FEDERAL STREET, BOSTON, MA, 02110, US

(21) Appl. No.: 10/283,741

(22) Filed: Oct. 30, 2002

Related U.S. Application Data
(60) Provisional application No. 60/330,759, filed on Oct. 30, 2001.

(51) Int. Cl. G01N 31/00; G06F 19/00

(52) U.S. Cl. 702/22; 702/27

(57) ABSTRACT

The invention features a sort computer which interfaces with a sorting device in order to control the sorting of beads on a bead by bead basis. The invention further features novel methods for the directed synthesis of encoded libraries of oligomers, e.g., oligonucleotides, on beads. These methods allow the synthesis of libraries that are sufficiently large to permit complex genomic analyses to be carried out. New methods of using the encoded libraries also are described.

### CROSS-REFERENCE TO RELATED APPLICATIONS

This application claims priority to U.S. Provisional Application No. 60/330,759, filed Oct. 30, 2001, hereby incorporated by reference.

### BACKGROUND OF THE INVENTION

The invention relates to the fields of cytometry and combinatorial chemistry.

Recently, the demand for more economical and flexible alternatives in genomics, proteomics, and drug discovery research has greatly increased. While incremental improvements continue to be made in the technology as applied to these applications, the technology is still largely limited to two-dimensional array approaches for screening libraries. Currently, this research is performed using DNA microarrays, protein microarrays, or microplates coupled with sophisticated robotic and detection instrumentation. The widespread adoption of microarrays has been limited by their expense and the fact that the arrays typically cannot be custom-made at individual companies or institutions. Microarrays are complex and expensive to produce and use, and even the best DNA arrays are limited to several hundred thousand oligonucleotide probes. This number is not ideal for sequencing, SNP analysis, or other operations that may be required for cost effective research, diagnostic, and therapeutic applications of genomics. Furthermore, although microarrays have the capability of detecting a wide range of gene expression levels, such measurements are subject to variability relating to probe hybridization differences and cross-reactivity, differences between elements within microarrays, and differences from one array to another [Audic, S. and Claverie, J. 1997. Genome Res. 7, 986-995; Wittes, J. and Friedman, H. P. 1999. J. Natl. Cancer Inst. 91, 400-401; Richmond, C. S. et al. .1999; Nucleic Acids Res. 27, 3821-3835]. Similarly, the miniaturization of existing microplate formats is intrinsically limited by the physical constraints of delivering small volumes to wells.

Large numbers of compounds may be synthesized on or coupled to libraries of beads. Colloid-based libraries are inexpensive to produce in enormous numbers, can be conveniently stored in small volumes of fluid, and can be “optically barcoded” and screened using various detection technologies. Depending on the specific application, such colloid-based chemical libraries may be comprised of different families of chemical compounds. For example, certain genomics applications require a library containing single-stranded DNA molecules (oligonucleotides), each of which has a unique sequence. Proteomics studies employ a library of proteins to explore protein diversity, interaction, structure, and function. For drug discovery applications, a wide variety of molecular families (e.g., polypeptides and polysaccharides) can be attached to the colloidal supports and screened for biological activity.

One of the most powerful library synthesis methods is the iterative split and mix synthesis on colloidal support beads. This technique is an efficient method for accessing all combinations of chosen monomers, such as nucleic acids, amino acids, or sugars, in a small number of reactions. In a split and mix synthesis, a large number of solid support beads is partitioned into several vessels, a different monomer is reacted with each portion, and the beads are recombined to complete the cycle. The split and mix process is repeated for a chosen number of cycles, resulting in a chemical library, ideally consisting of all monomer combinations. Compound identification from such large pools of compounds, bound to solid supports (one compound per bead) or free in solution, may be achieved through covalent attachment of molecular tags to the beads or through iterative deconvolution technologies. The quantity of compound on a microscopic colloid is often adequate to allow detection of bioactivity; however, the amount is typically insufficient to permit structural elucidation by conventional analysis techniques. Compounds on colloidal particles are not positionally-encoded as they are in microarrays or microplates, and thus alternative methods of encoding are required. This requirement is particularly important in combinatorial libraries that involve a large number of different colloid-based moieties. The covalent binding of molecular identifier tags (e.g., oligonucleotides, electrophoretic molecular tags, cleavable dialkylamine tags, secondary amines, fluorophenyl ethers, and trityl mass-tags) to the colloids in parallel with the compound synthesis is a common approach to reducing this problem. The requirement, however, for compatible compound and tag synthesis places substantial limitations on the procedure. Additional chemical steps are also needed to synthesize the tags, and artifacts may arise as a result of interfering chemistries between the combinatorial step and the tagging step. Furthermore, tag analysis frequently involves laborious and expensive procedures.

In order to make tag analysis quicker, some workers have attempted to use fluorophores for tagging solid supports. The concept of tagging solid support beads with fluorophores has been present in the literature for several years. In 1994, Furka and colleagues recognized that fluorophores and chromophores could be covalently synthesized onto aminoalkyl resins before or during split-and-mix synthesis [Campian, E. et al. (1994) Drug Develop. Res. 33, 98-101; Campian, E. et al. (1994) Colored and fluorescent solid supports in Innovation and Perspectives in Solid Phase Synthesis and Complementary Technologies (Epton, R., ed.), pp 469-472, Mayflower.] In 1997, Egner et al. presented a study in which six dyes were covalently coupled to six portions of TentaGel beads to encode the first reaction step in the synthesis of a small peptide library (448 compounds) [Egner, B. J. et al. (1997) Chem. Commun. 8, 735-736]. Scott and Balasubramanian [Scott, R. H. and Balasubramanian S. (1997) Bioorg. Medic. Chem. Lett. 7, 1567-1572] explored the fluorescence properties of a variety of commonly used fluorophores attached to TentaGel and aminomethylpolystyrene-1% divinylbenzene at high and low loading levels. A self quenching effect on the fluorescence in the resin bead was examined by Yan et al. [Yan, B. et al. (1999) J. Comb. Chem. 1, 78-81], who called for careful selection of fluorophores and rigorous control of the labeling reaction yield in order to generate labeled beads for combinatorial chemistry. Nanthakumar and co-workers demonstrated oligonucleotide synthesis on fluorescently encoded support beads generated by covalent attachment of linkers and dye and showed the feasibility of using flow sorting to identify and separate four bead sets [Nanthakumar, A. et al. (2000) Bioconj. Chem. 11, 282-288]. The sequences synthesized on each bead set were identified by performing hybridization with fluorescently labeled complementary sequences. A common theme behind all of these examples is the covalent manner in which attachment of the fluorescent tags is performed. Despite the fact that fluorescent encoding of combinatorial libraries has been well documented for several years, the maximum library size that can be encoded is surprisingly small.

The major disadvantages of using fluorophores as tags in this way include fluorescence resonance energy transfer (FRET), and the high incidence of non-specific binding (i.e., non-covalent adsorption) of the dyes inside or on the surface of beads. The dyes which are not covalently bound will leach out of the bead when placed into different solvents, and thus the optical signature will be significantly altered.

A method of keeping track of the reaction history in chemical synthesis is the Irori method. This method involves the use of NanoKan reactors, which are rigid containers with mesh sidewalls and a mesh cap. Kan reactors have a 75-micron mesh. Each Kan contains a radiofrequency tag (reusable devices that act as a unique identifier for each Kan reactor) and the actual solid phase resin used for synthesis. Each NanoKan is used to synthesize one discrete compound. The NanoKan Sorting Station implements a directed sorting approach to library generation. The NanoKan Sorting Station reads the RF tag of each NanoKan and sorts it according to its predetermined chemical destiny. Sorting is performed before and between each synthesis step. One of the major disadvantages of the Irori technology is that only one discrete compound is synthesized in each NanoKan. This system does not permit combinatorial chemistry to be performed efficiently, without use of an extremely large volume of beads. Another disadvantage of the encoding system is a radiofrequency tag that encodes large batches of beads (8 mg of beads, 200 μm in diameter) rather than one uniquely encoded bead. This encoding means that batches of beads are processed together, rather than on a bead by bead basis. The mesh used in the NanoKans is also 75 μm, which is too large to permit the use of 10-20 μm beads.

The technique of using multiple intensities and multiple emission wavelengths (i.e., multiplexed encoding) to barcode colloids (3-6 μm in diameter) for small library applications has been employed by a number of groups. By entrapping various ratios of two fluorescent dyes or lanthanide complexes in the interior of colloidal particles, up to 100 different colloidal suspensions have been produced [K. G. Oliver, J. R. Kettman, R. J. Fulton, Clin. Chem., 1998, 44, 2057; P. L. Smith, C. R. WalkerPeach, R. J. Fulton, D. B. DuBois, Clin. Chem., 1998, 44, 2054; R. J. Fulton, R. L. McDade, P. L. Smith, L. J. Kienker, J. R. Kettman Jr., Clin. Chem., 1997, 43, 1749; D. A. A. Vignali, J. Immunol. Methods, 2000, 243, 243; F. Szurdoki, K. L. Michael, D. R. Walt, Anal. Biochem., 2001, 291,219; D. R. Walt, Science, 2000, 287(5452), 451; M. Lee and D. R. Walt, Anal. Biochem., 2000, 282, 142; F. J. Steemers, J. A. Ferguson, D. R. Walt, Nat. Biotechnol., 2000, 18, 91]. For each suspension, the polymeric colloids are swollen in a solvent/dye mixture containing a certain ratio of the two dyes/complexes. Rapid contraction of the colloids occurs upon exposure to an aqueous or alcoholic solution, thereby entrapping the fluorescent dyes/complexes within the colloids. Typical solvents used are dimethylformamide or tetrahydrofuran. Decoding the colloids is achieved by a variety of methods including flow cytometry and optical fibre microarrays.

An alternative method of optical barcoding involves the incorporation of zinc sulfide-capped cadmium selenide nanocrystals into 1.2 μm polymer colloids in controlled ratios [M. Han, X. Gao, J. Z. Su and S. Nie, Nature Biotech., 2001, 19, 631]. Many sizes of nanocrystals can be excited at a single wavelength, resulting in several emission wavelengths (colours) that can be detected simultaneously. Nie and colleagues reported a DNA hybridisation experiment which involved four oligonucleotide probes and four colloidal suspensions barcoded with nanocrystals. Barcoding was performed by swelling polymer colloids (0.1-5.0 μm) in a propanol (or butanol)/chloroform mixture and adding a controlled ratio of three nanocrystal colours (sizes) to the mixture. The colloids are sealed with a thin polysilane layer which seals in the nanocrystals and improves their stability in aqueous conditions.

Screening of Combinatorial Libraries

It is often desirable to screen large libraries of related compounds. For example, Hudson et al. (Genome Res. 1997, 7:1169-73) constructed a so-called “uni-gene” set of the yeast coding sequences. This construction was acheived by synthesizing PCR primers corresponding to the 5′ and 3′ ends of each open reading frame in the yeast genome, then using the primer pairs to amplify each coding sequence using PCR and yeast DNA as a template. However, the synthesis of the ˜12,000 primers by conventional techniques was laborious and expensive.

Similarly, Ren et al. (Science 2000, 290:2306-9) constructed a set of hybridization probes corresponding to the intergenic spaces in yeast. Again, the probes were constructed by laborious synthesis of pairs of oligonucleotides followed by PCR amplification of intergenic regions from the yeast genome.

Such experiments are feasible only because the yeast genome contains 6,000 genes. To perform analogous experiments with organisms having larger genomes, such as C. elegans, D. melanogaster, or a mammal such as a human, many tens or hundreds of thousands of specific oligonucleotides would need to be synthesized, rendering existing methods impractical.

One approach to screening combinatorial libraries involves on-bead assays in which the fluorescent labeling of beads facilitates the identification of beads that display a positive outcome (i.e., a ‘hit’). Positive beads can be detected using flow cytometry or fluorescence microscopy. Alternatively, the compound can be cleaved in a multi-well plate, and the fluorescence measured in solution by, for example, fluorescence polarization, homogeneous time resolved fluorescence, or fluorescence correlation spectroscopy.

From the foregoing description, it is apparent that improved methods for synthesizing and screening large sets of defined oligonucleotides and other compounds are greatly desired. New methods for synthesizing and screening compounds on solid substrates are also highly desirable.

### SUMMARY OF THE INVENTION

The invention features a device for sorting carriers and methods of use thereof. The device couples the detection of a distinguishable feature of each carrier with a procedure that determines the direction in which each carrier is sorted, once it is identified. Methods of the invention include the directed synthesis of large combinatorial libraries using encoded carrier support systems. The libraries can be separated and identified using various detection schemes, for example, by flow cytometry. The methods are useful, for example, for synthesis of large sets of oligonucleotides or peptides. Beads represent an exemplary carrier although the invention is not limited to the use of beads.

In one aspect, the invention features a method for directing the synthesis of a combinatorial library of oligomers including the steps of assigning, prior to coupling, a predetermined oligomer sequence to each of a plurality of carriers each of which includes a distinguishable feature; sorting the carriers into a plurality of reaction vessels, wherein the vessel into which each carrier is sorted is determined by the oligomer assigned to each carrier based on the distinguishable feature, and wherein each carrier is sorted independently of the other carriers; performing a reaction to couple a chemical moiety to each carrier in each vessel, wherein the chemical moiety is the same or different in different vessels; and repeating the sorting and coupling steps at least once, wherein, in each step, a subsequent chemical moiety is coupled to the previously added chemical moiety to produce a plurality of oligomers. In one embodiment, the carriers in each of the vessels are pooled prior to the second, and any subsequent, sorting steps. In alternative embodiments, a linker, e.g., one that is cleavable or not cleavable, is coupled to each of the plurality of carriers prior to a coupling step. The method may further include cleaving an oligomer from a carrier, e.g., by cleaving a linker or any bond between an oligomer and a carrier. Desirably, each carrier in the plurality has a unique distinguishable feature. In preferred embodiments, the plurality of carriers is sorted into at least four vessels.

The invention further features a library of encoded carriers that includes a plurality of carriers wherein each of the carriers includes a unique distinguishing feature and a unique oligomer bound to the carrier. In desirable embodiments, the library includes at least 1,000, 10,000, 100,000, or 1,000,000 carriers, e.g., between 1,000 and 1,000,000 carriers.

In another aspect, the invention features a device for sorting carriers including a sorter that includes a flow path that splits into at least two branches into which carriers can be sorted; one or more detectors capable of detecting carriers in the flow path, wherein the one or more detectors are disposed to detect the carriers prior to passing into one of the branches; and a computer that determines the branch into which each carrier is sorted based on one or more signals from each carrier obtained from the one or more detectors. In desirable embodiments, the flow path splits into at least four branches. At least one of the detectors desirably detects fluorescence, light scatter, color, luminescence, phosphorescence, infrared radiation, x-ray scatter, light absorbance, surface plasmon resonance, or electrical impedance.

In yet another aspect, the invention features a sort computer including an interface that is capable of receiving data that encodes a distinguishable feature of a carrier as it is passed through a sorting device comprising a flow path that splits into at least two branches; one or more memories that store the number of carriers having each distinguishable feature; a controller that is capable of controlling the sorting device to sort a carrier into one of the branches; and a sorting selector that determines into which branch a carrier is sorted based on the number of carriers having that distinguishable feature stored in the one or more memories. In an alternative embodiment, the sorting selector is replaced with means responsive to the data that encodes the distinguishable feature that determines into which branch a carrier is sorted based on the number of carriers having that distinguishable feature stored in the one or more memories. The sort computer may further include the sorting device electrically coupled to the interface. The sort computer may also include a fluorescence compensation device that is capable of performing real-time hardware linear fluorescence compensation on the data that encodes the distinguishable feature of the carrier, wherein the fluorescence compensation device accesses the raw data from the sorting device and passes linearly compensated data to the interface.

The invention further features a method for discontinuously sorting carriers including the step of passing a plurality of carriers, each of which comprises a distinguishable feature, through a flow path that splits into at least two branches, wherein each carrier is sorted into one of the branches independently of the other carriers. In onve embodiment, the flow path is included in a flow cytometer. Exemplary distinguishable features include intensity of light scatter and fluorescence intensity. At least one of the plurality of carriers may be coupled to an oligomer. Desirably, carriers with widely varying distinguishable features are directed into the same branch or carriers with similar distinguishable features are directed into the same branch.

In another aspect, the invention features a method for identifying an oligomer that binds to a species including the steps of contacting a plurality of carriers, each of which comprises a unique oligomer and a unique distinguishable feature, with a tagged species; passing the plurality of carriers through a flow path; detecting any tagged species associated with any of the plurality of carriers, thereby identifying the oligomer that binds to the species by identification of its unique distinguishable feature. In one embodiment, the tagged species includes a first sequence of nucleotides and each of the oligomers includes a second sequence of oligonucleotides, wherein each of the second sequences is identifiable by the unique distinguishable feature on each carrier, and the distinguishing feature of the carrier to which said tagged species is associated is indicative of the second sequence. An exemplary second sequence includes a polymorphism, e.g., a single nucleotide polymorphism. In other embodiments, the flow path splits into at least a first and a second branch, and any carrier to which the tagged species is associated is directed down the first branch, and any carrier to which the tagged species is not associated is directed down said second branch. The method may further include repeating the above three steps with the plurality of carriers formed by the carriers directed down the first branch.

In still another aspect, the invention features a method of synthesizing a library of oligonucleotides including the steps of providing a plurality of carriers, wherein each of the carriers includes a unique distinguishable feature; assigning a predetermined sequence of nucleotides to be coupled to each carrier, wherein the distinguishable feature of each carrier is indicative of the sequence to be coupled to each carrier; passing the carriers through a flow path that splits into at least four branches; detecting the distinguishable feature of each carrier as it passes through the flow path; directing each carrier through one of the branches into a vessel based on the first nucleotide of each carrier, wherein the vessel represents a nitrogenous base; in each vessel, coupling the first nucleotide comprising the nitrogenous base to the carriers; and repeating the passing, detecting, directing, and coupling steps, wherein in each step, the subsequent nucleotide in each of the sequences is added to the previous nucleotide until each assigned predetermined sequence is coupled to each carrier. The method may further include the step of coupling a linker to the predetermined sequence and sequentially adding a complementary sequence of nucleotides to the linker by the method above, wherein the complementary sequence is capable of hybridizing to at least a portion of the predetermined sequence to form a hairpin structure.

The invention further features a method of isolating a subpopulation of carriers from a diverse population of carriers including the steps of synthesizing a diverse population of carriers, each of which includes a distinguishable feature, wherein at least three dimensions of parameters are required to characterize the distinguishable features of all carriers; defining a gate around a region of parameters in at least two dimensions in a flow cytometer; and passing the diverse population of carriers through the flow cytometer, wherein all of the carriers with distinguishable features within the gate are sorted into a vessel and all of the carriers with distinguishable features not within the gate are not sorted into the vessel. The parameters of the distinguishable features of any carriers within the gate may be stored in a memory.

In another aspect, the invention features a method of identifying an oligomer that binds to a species including the steps of providing a plurality of populations of carriers, wherein each population includes a plurality of carriers, each of which includes a distinguishable feature that is present in only one population; coupling a different oligomer to the carriers in each population; combining an aliquot of carriers from each population; contacting the combined aliquots with a tagged species; detecting any tagged species associated with any of carriers; and determining the number of carriers from each population to which the tagged species binds, wherein each of the numbers is indicative of the relative binding ability of the tagged species to the oligomer of each population.

In yet another aspect, the invention features a method of making a non-combinatorial library including the steps of producing a subpopulation of carriers by the steps of synthesizing a diverse population of carriers, each of which includes a distinguishable feature, wherein at least three dimensions of parameters are required to characterize the distinguishable features of all carriers; defining a gate around a region of parameters in at least two dimensions in a flow cytometer; and passing the diverse population of carriers through the flow cytometer, wherein all of the carriers with distinguishable features within the gate are sorted into a vessel and all of the carriers with distinguishable features not within the gate are not sorted into the vessel; and coupling one or more compounds to the subpopulation of carriers.

The invention further features a method of synthesizing a combinatorial library including the steps of producing a plurality of subpopulations of carriers by the steps of passing a plurality of carriers through a sorting device comprising a flow path that splits into at least two branches; and sorting each carrier down one of the branches into a vessel independently of the other carriers, wherein the carriers in each subpopulation are sorted into different vessels; wherein each of the subpopulations includes a plurality of carriers, each of which includes a distinguishable feature that is present in only one subpopulation; for each subpopulation, coupling a chemical moiety to the carriers in that population; and repeating the coupling step at least once, wherein subsequent chemical moieties are coupled to the previously added chemical moiety to produce a different oligomer for each subpopulation.

In another aspect, the invention features a machine readable data memory including a oligomer encoding database that includes a list of sequences of chemical moieties that form an oligomer, with each chemical moiety associated with at least one combination of particular values of bead parameters at a given step in a synthesis, and wherein particular values of beads are accessible by machine to provide identification data for a synthesis and wherein parameter values of beads indicate that a bead should be sorted in a given direction. The sequences may be, for example, nucleotide or peptide.

The invention also features a method of synthesizing a library of oligomers including the steps of providing a plurality of carriers that include distinguishable features based on a set of independent parameters; providing machine readable data memory including an oligomer encoding database that includes a list of sequences of chemical moieties that form an oligomer, with each chemical moiety associated with at least one combination of values of said independent parameters at a given step in a synthesis; passing the carriers through a flow path that splits into at least two branches; detecting the distinguishable feature of each carrier as it passes through the flow path; directing each carrier down one of the branches into a vessel based on the chemical moiety in the database for the carrier; for each vessel, coupling the chemical moiety to each carrier in the vessel; and repeating the above steps until oligomer synthesis is complete, thereby synthesizing a library of oligomers. The method may further include pooling the carriers in each of said vessels prior to sorting.

In yet another aspect, the invention features a population of carriers from at least two topologically disconnected grid spaces, wherein each of the carriers includes a distinguishable feature that includes at least two parameters, and wherein each grid space has an upper bound of greater than zero for each parameter.

In various embodiments of the invention, exemplary chemical moieties include a deoxyribonucleotide, a ribonucleotide, an amino acid, a saccharide, a peptide nucleic acid, a carbonate, a sulphone, a sulfoxide, a nucleoside, a carbohydrate, a urea, a phosphonate, a lipid, or an ester. A chemical moiety may also be protected. Each carrier may also include a reactive group. An exemplary sorting device is a flow cytometer. Distinguishable feature may be detectable by fluorescence, light scatter, color, luminescence, phosphorescence, infrared radiation, x-ray scatter, light absorbance, surface plasmon resonance, electrical impedance, or a combination thereof. An exemplary carrier is a bead. Oligomers may be bound to a carrier via a linker, which may be cleavable or not cleavable.

The term “carrier” as used herein embraces a solid support with appropriate sites for oligomeric compound synthesis and, in some embodiments, tag attachment. The carrier may have any suitable size or shape or composition. Desirably, carriers are heterogeneous in size, shape, or composition. In general, the carrier size is in the range of between about 1 nm to 1 mm, e.g., at most 750 μm, 500 μm, 250 μm, 100 μm, 75 μm, 50 μm, 25 μm, 10 μm, 5 μm, 1 μm, 750 nm, 500 nm, 250 nm, 100 nm, 75 nm, 50 nm, 25 nm, 10 nm, or 5 nm. The carrier may be shaped in the form of spheres, cubes, rectangular prisms, pyramids, cones, ovoids, sheets, cylinders, or any arbitrary shape. Beads represent preferred carriers according to the invention.

By “bead” is meant a carrier of essentially spherical shape. Beads may, however, be slightly irregular (e.g., oviodal) or have rough or porous surfaces.

The term “oligomer” as used herein refers to molecules that include a sequence of chemical moieties including any structural unit that can be formed and/or assembled by known or conceivable synthetic operations. Thus, the oligomers of the present invention are formed from the chemical or enzymatic addition of separate moieties. Such oligomers include, for example, both linear, cyclic, and branched oligomers or polymers of nucleic acids, polysaccharides, phospholipids, ribonucleotides, peptide nucleic acids and peptides having, for example, either α-, β-, or ω-amino acids, heteropolymers in which, for example, a known drug is covalently bound to any of the above, polyurethanes, polyesters, polycarbonates, polyureas, polyamides, polyethyleneimines, polyarylene sulphides, polysiloxanes, polyimides, polyacetates, or other polymers which will be readily apparent to one skilled in the art. The number quoted and the types of oligomers listed are merely illustrative and are not limiting.

As used herein “chemical moiety” and “monomer” include any molecule that can be joined to another molecule to form a desired compound. Chemical moieties or monomers include, without limitation, nucleotides, amino acids, peptide nucleic acids, carbonates, sulphones, sulfoxides, nucleosides, carbohydrates, ureas, phosphonates, lipids, and esters. Alternatively, the chemical moiety or monomer may include inorganic units such as for example silicates and aluminosilicates. Accordingly, chemical moieties or monomers useful in the present invention include, but are not restricted to, for peptide synthesis, L-amino acids, D-amino acids, synthetic amino acids, and peptide nucleic acids. It will also be understood that different chemical moieties or monomers may be used at successive steps in the synthesis of a compound of the invention.

By “distinguishable feature” or “tag” is meant any molecule or group of molecules having one or more detectable parameters including, but not limited to, shape, size, color, optical density, differential absorbance or emission of light, chemical reactivity, magnetic or electronic encoded information, or any other distinguishable attribute. Exemplary parameters include fluorescence emission and light scattering.

By “parameter” is meant any property measured by a detector, e.g., fluorescence or light scatter.

By “detector” is meant the equipment used to detect one of the parameters described above. Often the detector is a photomultiplier tube in the case of fluorescent or side scatter parameters, or a photodiode in the case of the forward scatter parameter. Each parameter may be associated with an individual detector.

By “gate” is meant a criteria on which carriers, e.g., beads, are classified by a sorting device.

By “combinatorial library” is meant a library of discrete compounds, preferably bound to a solid support phase such as a bead, that is synthesized in parallel, e.g., using the well-known split-and-mix process, without resorting to synthesizing each discrete compound sequentially.

By “non-combinatorial library” is meant a library of discrete compounds, preferably bound to a solid support phase such as a bead, that is synthesized by directly attaching chemical moieties, such as an oligomer or peptide.

By “encoded population” is meant a population of beads that are encoded in some fashion such that each bead can be decoded or distinguished from each other by an appropriate detecting system.

By “cleavable” is meant able to be physically separated, e.g., a cleavable linker contains a bond to a carrier or chemical moiety that is labile under certain conditions, such as presence of acid or base.

By “sorting device” is meant any device that can physically separate an entity, e.g., a carrier or cell, from a larger population based on a distinguishing feature.

By “flow path” is meant a channel through which fluids flow, e.g., as in a flow cytometer. A flow path may split into two or more branches.

By an “oligomer-carrier database” is meant a database consisting of a list of sequences of oligomers, e.g., oligonucleotides or oligopeptides, coupled to a list of distinguishable features of a carrier. The carriers are chosen such that they can be sorted independently of one another. More than one carrier with a given distinguishable feature may be present in practice in order to produce more than one carrier with a specific oligomer. A particular sequence element corresponds to a flow path for a carrier at each step in a multi-step synthesis.

By “parameter value” is meant the magnitude of a parameter, e.g., fluorescence intensity, as measured by a detector. Initially this value is a raw analogue current from the detector, but it may be converted into a digital value by an analog-to-digital converter (ADC) board. The number of bits per parameter value is determined by the resolution of the ADC board.

By “parameter range” is meant the range of values that a parameter can have.

By “threshold detector” is meant a detector that registers a minimum or maximum signal level. When the magnitude of a measurement at that detector exceeds a pre-set value (i.e., the threshold), a sorting device is triggered.

When a sorting device is “triggered” a sequence of steps occurs that includes the recording of a value for each parameter. This process takes a certain amount of time to occur, known as the dead-time, during which no other event can cause a trigger.

By “event” is meant an entity whose detection causes a sorting device to trigger. An event can be, without limitation, a cell, bead, dust particle, air bubble, electrical noise, or any other entity that triggers the sorting device. For ease of discussion, the term event and carrier are often used in an interchangeable manner herein.

By “sort region” is meant either (a) a subrange of values of a single parameter, or (b) a rectangular, elliptical, or polygonal region of values of two or more parameters. The sort region is typically given a unique number for identification, e.g., region 1 or R1.

By “sort direction” is meant a particular direction of flow into which a sorting device physically separates a given element. In a two-way sort, there are two sort directions, e.g., left and right. In a four-way sort, there are four sort directions, e.g., left, right, half-left, and half-right.

By “sort logic” is meant the sort direction in which a given event should be sorted. This logic is usually a combination of Boolean logic and a number of sort regions, e.g., if inside region 1 and not inside region 3, then sort left. Software associated with a sorting device allows the user to define a sort logic.

By “lookup table” or “LUT” is meant a device or memory capable of storing either a one- or two-parameter sort region as described above. Based on information in the LUT, a determination is made on whether parameter values obtained from an event are inside or outside the sort region. The result of this test (often only one bit is needed, 1=inside, 0=outside) are placed onto the data bus. Many LUTs can be stored on one LUT board, and many LUT boards can be placed on the data bus.

By “sort classifier” is meant a procedure that produces a sort decision based on the user-defined sort logic and the data from the LUTs, and places the result on the event bus.

By “dimension” is meant parameter, and the term carries its usual mathematical meaning.

By “parameter space” is meant the n-dimensional matrix defined by the number of parameters, n, and the ranges of each of those parameters. This space represents all the combinations of parameter values a given event could possess. Each event is essentially an n-dimensional vector into this parameter space. For example, when a population of white blood cells is labeled with fluorescently labeled antibodies directed against CD4 and CD8, and then analyzed by flow cytometry, the results may be displayed in a two-dimensional scatter plot. Such a plot represents the two-dimensional parameter space, and the scattered points represent the positions of labeled cells within the parameter space.

By “division” is meant the number of divisions, d, into which a given parameter is divided. The divisions are numbered from 0 to (d−1).

By “grid space” is meant an n-dimensional volume of parameter space that is defined by a given division on each parameter. It is identical in concept to how an event is described by its combination of parameter values. Any event that has an n-dimensional vector into a given grid space is said to belong to that grid space. In FIG. 47A, the square is an example of a grid space. A grid space is characterized by its rectangularity in two dimensions or a higher-dimensional equivalent of rectangularity. Grid spaces form the basis of the grid space procedure, in which typically only one event per grid space is allowed. In this case, the status of a given grid space can be represented by a single bit, in which 1=full and 0=empty.

By “grid space memory” is meant a memory that represents the status of each grid space. Typically, the size of the grid space memory, in bits, is equal to the number of grid spaces. Each sort direction requires a grid space memory, e.g., for a four-way sort, four grid space memories are required. The sort computer of the invention, in combination with a FACS machine, is able to identify beads as being within a grid space and sort them into a desired sort direction.

By a “sort computer” is meant the collection of equipment that implements the grid space procedure in a sorting device. In the exemplary sort computer described herein, it includes the sort computer board, fluorescence compensation board, additional computer, associated software, and interface cables.

By “sort computer board” is meant an electronic board that interfaces with the data bus of a sorting device and implements the grid space procedure. The sort computer board obtains its data from the fluorescence compensation board if enabled, otherwise it uses the data from digital signal processing (DSP) board of the sorting device. It may be interfaced with an additional computer using both serial and enhanced parallel port (EPP) connections. The EPP connections are used to upload/download the grid space memory and delta event log as well as any initialization settings. The serial connection is used for debugging and monitoring of the status of the sort computer board. The grid space and delta event log memory devices are located on the sort computer board.

By “fluorescence compensation board” is meant an electronic board that implements the linear fluorescence compensation procedure described in Bagwell & Adams, Annals New York Academy of Sciences, 677, p.167, (1993). It obtains raw parameter values from the event bus of a sorting device, and outputs the compensated values to a sort computer board.

Throughout this specification and the claims, unless the context requires otherwise, the words “comprise”, “comprises” and “comprising” will be understood to imply the inclusion of a stated integer or step or group of integers or steps but not the exclusion of any other integer or step or group of integers or steps.

By a “grid space library” is meant a collection of objects that can be positioned in discrete, topologically disconnected grid spaces within a parameter space. In FIG. 58B, the objects within the two squares, taken together, are an example of a grid space library. A sort computer of the invention, in combination with a sorting device, is able to identify objects within topologically disconnected unit blocks and sort them into the same channel.

Other features and advantages of the invention will be apparent from the following description and the claims.

### BRIEF DESCRIPTION OF THE DRAWINGS

FIG. 1 is a plot of data from a sort computer showing optically unique beads sorted from an optically diverse population. The beads were pre-encoded with Oregon Green 488, Rhodamine B, and AlexaFluor 350 dyes. Fluorescence was detected through the FL1 (λ=530/40), FL2 (λ=580/30) and FL4 (λ=450/65) parameters.

FIG. 2 is a diagram of a division of two-dimensional parameter space into grid spaces. The width of each grid space can be different for each parameter.

FIGS. 3A-E are an example of a real-time algorithm for selecting optically unique beads. In (a), five beads have already been collected and hence the corresponding grid space labels have been labeled full. In (b), a new bead occupies a vacant grid space and hence is sorted in (c). In (d), another new bead occupies a full grid space and hence is rejected from the system in (e).

FIG. 4 is a schematic diagram of a method of selecting optically unique beads. Only beads that occupy the internal sort region are collected. No beads are collected from the buffer region.

FIG. 5 is a schematic diagram of a random combinatorial synthesis, where each bead is tracked by a sorting device/sort computer after the coupling reaction.

FIG. 6 is a schematic diagram of a directed synthesis, where the optical signature of each bead is recorded by the sort computer before the coupling reaction, and/or each bead is directed into a vessel according to a predetermined reaction sequence.

FIG. 7 is a conceptual diagram of how a bead is detected and measured by a flow cytometer.

FIG. 8 is a schematic diagram of a sort computer.

FIG. 9 is a picture of the main screen of Cytowin.

FIG. 10 is a picture of the file menu of Cytowin.

FIG. 11 is a picture of the configure menu of Cytowin.

FIG. 12 is a picture of the configure menu—lookup table settings of Cytowin.

FIG. 13 is a picture of the configure menu—compensation settings of Cytowin.

FIG. 14 is a schematic diagram of the interactions between a sort computer board, a fluorescence compensation board, and an event bus during an event.

FIGS. 15-28 are schematic circuit diagrams for a sort computer board. The manufacturers of the chips are given in FIG. 15.

FIGS. 29-40 are schematic circuit diagrams for a fluorescence compensation board. The manufacturers of the chip are given in FIG. 29.

FIG. 41 is a schematic diagram of how sort computer board implements gridspace algorithm.

FIG. 42 is a flow chart of delta event logging.

FIG. 43A is a graph of an optodiverse population of QFITC-coated 4 μm blue-green beads on two parameters (FL1 and FL3) before pre-encoding. (

FIG. 43B is a graph of fifty-six optically unique beads extracted from the population in FIG. 43A (rl=rh=30).

FIG. 44 is a schematic diagram of recording the reaction history of a population of beads through a combinatorial synthesis.

FIG. 45 is a schematic diagram of directed synthesis using a sort computer.

FIG. 46 is a graph of the number of unique beads obtained as a function of population size for random data. The total number of available grid spaces is 10,000.

FIG. 47A is a schematic example of a unit block. A unit block is a particular type of a “sort region” further characterized by its rectangularity in two dimensions or a higher-dimensional equivalent of rectangularity.

FIG. 47B is a schematic diagram of objects within the two squares, taken together, forming a unit block library. A sort computer of the invention, in combination with a sorting device, is able to identify objects within topologically disconnected unit blocks and sort them into the same channel.

FIG. 48 is a schematic diagram of grid space memories employed for directed synthesis. To perform directed synthesis, upload predetermined grid space memories to a sort computer board (one grid space memory per sort direction). Wherever there is a 0, the bead corresponding to that grid space will be sorted in that sort direction.

FIG. 49 is a flow chart of sorting an event.

FIG. 50 is a schematic diagram of assaying a library with the ‘hits’ detected by a sorting device such as a flow cytometer.

FIG. 51 is an example of a hairpin structure. Each bead has a linker group on which an oligonucleotide sequence is synthesized, followed by a spacer group, followed by the complementary sequence, thereby forming a hairpin duplex.

FIG. 52 is a three-dimensional plot of intensity parameters from three detectors (FL1, FL6, and FL9) in a flow cytomer, which demonstrates the optical diversity in a combinatorially synthesized set of beads using FITC, BODIPY 630, and AlexaFluor 350. Parameters were FL1 (λ=530/20), FL6 (λ=670/20), and FL9 (λ=450/15).

FIG. 53 is a graph of a gating experiment. An optically diverse population of beads is sorted in a flow cytometer, and only those beads which appear in the 16 gates (illustrated by the 16 white boxes) are collected. The rest of the beads run to waste.

FIGS. 54A-B are graphs of the number of hybridizations of a tagged sequence to (A) a mismatched sequence and (B) a complementary sequence. DNA hybridization of complementary (5′TACAGGCCTCACGTTACCTG) and mismatched (5′CAGGTAACGTGAGGCCTGTT) sequences was performed by hybridizing the beads with fluorescently labeled target sequences (5′CAGGTAACGTGAGGCCTGTT). These data show that the complementary sequence (average fluorescent intensity of 287 A.U.) can be discriminated from the non-complementary mismatched sequence (average fluorescent intensity of 16 A.U.) using a flow cytometer.

FIG. 55 is a graph of an optically diverse set of beads before they are sorted in a flow cytometer. The beads contained Oregon Green 488 and Rhodamine B dyes, which emit at 530 nm and 580 nm respectively.

FIG. 56 is a graph of the distinct populations of the beads from FIG. 55 after they have been sorted by the flow cytometer and passed through the flow cytometer for a second time.

FIG. 57 is a graph of the same set of particles as in FIG. 56, passed through the flow cytometer for a third time.

FIGS. 58A-D are schematic diagrams of grid spaces that define subsets of beads that are scattered within a two-dimensional parameter space. Locations of beads in the parameter space are represented by small black dots. FIG. 58A shows a single grid space (small square) that can be defined by conventional flow cytometers. FIG. 58B shows two grid spaces, one square and one circular, that can be defined by a sort computer of the invention. A sort computer coupled to a sorting device is capable of simultaneously sorting beads within both the circle and the square into a single channel. FIG. 58C shows three grid spaces defined within the parameter space, enclosing a subset of beads that may be sorted into a channel by a flow cytometer with an attached sort computer. FIG. 58D shows the population of beads sorted from FIG. 58C. These beads lie within discrete grid spaces in the parameter space, and this population of beads is essentially depleted of beads lying outside the grid spaces.

### DETAILED DESCRIPTION OF THE INVENTION

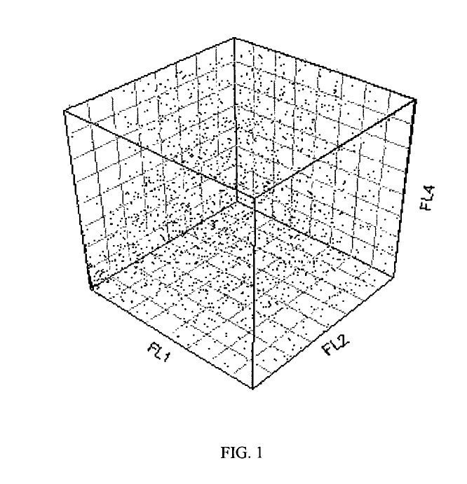

The invention is based on the use of a sort computer that interfaces with a device for sorting carriers, e.g., a flow cytometer. The sort computer receives data from the detection of individual carriers. Based on user defined sorting logic (i.e., which carriers are to be sorted in which directions), the sort computer directs the sorter to send a particular carrier down a specified path. This ability is useful in many applications including the separation of a subpopulation of diverse carriers from a larger population, the separation of unique carriers from a large population (FIG. 1), and the directed synthesis of oligomers on carriers. Other methods employing the sort computer are described herein. The following discussion focuses on the use of beads as exemplary carriers, but the discussion is also applicable to any type of carrier.

Sort Computer

A sort computer includes an interface that can write data to and retrieve data from a sorting device, e.g., a flow cytometer. The sort computer implements a grid space procedure, for example, as described in WO 00/32542 for flow cytometry, that uses user-defined sorting logic (i.e., which beads are directed into which paths) to control the direction that a particular bead is sorted. See Shapiro, H, Practical Flow Cytometry, 3^{rd} Ed., Wiley and Sons, 1995 for a discussion of flow cytometry, as exemplary sorting device for use in the invention.

Grid Space

To identify a given bead positively in a population by measurement of its detectable properties requires that the given bead has a set of properties that is unique from every other bead in the population. For two beads to be different, they need only differ in one of their properties. That is, all of their respective properties could be identical except for one distinguishable difference.

When a sorting device, e.g., a flow cytometer, measures each property or parameter, the electrical current output from the corresponding detector, e.g., photomultiplier tube, is converted to a relative value or channel number, which is an integer value between 0 and 1023 for an instrument operating in linear mode at a resolution of 1024 channels. Therefore, using only one optical property, e.g., light scattering intensity at 90°, the maximum possible number of unique beads would be 1024.

If an additional property is measured, each of the original 1024 unique values could be paired with any of the 1024 new values, leading to 1024² possible combinations. For a total of k measurable parameters, the maximum number of unique combinations would hence be 1024^{k}.

Using set theory (Hrbacek and Jech 1984, “Introduction to set theory” 2nd Ed, New York, M. Dekker), this can be expressed as:

Set of values possible for the ith property=R₁={xεZ+|0≦x<max} (1.1)

where Z+ is the set of all positive integers including zero. The value of max is equal to the resolution of the instrument, which throughout this discussion is assumed to be 1024.

If the instrument can measure k independent properties, then each bead in the population can be represented by:

Ordered set of k properties for a given bead=S₁=<r₁, r₂, r₃, . . . rₖ> (1.2)

where r₁εR₁, r₂εR₂, r₃εR₃, etc.

For an unordered collection of beads:

Population of n beads=P={S₁, S₂, S₃, . . . , Sₙ} (1.3)

where S₁=Sⱼ means that the two beads, Sᵢ and Sⱼ, are indistinguishable from the k properties measured. The number of unique beads in the population, P is thus:

|U| where U⊂P and (∀Sᵢ,SⱼεU) Sᵢ≠Sⱼ (1.4)

Diversity

To maximize the number of unique beads in the system, a diverse population needs to be synthesized.

Diversity is a recursive term that is based on the measurement of several independent parameters. A population of beads is deemed diverse over k parameters if a sub-population of beads with identical values for one of the parameters is indistinguishable from the total population when both populations are measured using only the remaining (i.e., k−1) parameters.

A diverse population of beads would thus be expressed by:

D⊃P and D⊃R₁xR₂xR₃ . . . xRₖ (1.5)

where R₁xR₂xR₃ . . . xRₖ is the parameter space for the k parameters. P is a subset of D because not every population is necessarily diverse. The parameter space is also a subset of D to allow for the possibility of indistinguishable beads within an overall diverse population.

Pre-Screening of Diverse Beads

The above carries two crucial assumptions: a given bead does not vary in any of its intrinsic properties, and there is no variation in the detection of each bead. A large body of work (Shapiro, H. M., 1995, Practical Flow Cytometry, 3^{rd} ed, Brisbane, Wiley-Liss; Melamed M R, Lindmo, T, Mendelsohn, M L, 1990, Flow cytometry and sorting, 2^{nd} ed, New York, Wiley-Liss; Kettman J R, Davies, T, Chandler, D, Oliver, K G, Fulton, R J, 1998 Cytometry, 33: 234-243) suggests that both of these assumptions are invalid due to factors such as the effects of photodegradation, solvent polarity, and pH on fluorophores, not to mention the inherent error in any detection system.

This problem may be overcome by describing each property of a given bead as a range of values instead of just a single value. The range of values represents the possible variation in repeated measurements of the same bead by the detector employed.

The maximum number of unique beads using only one property then becomes equal to the resolution of the instrument divided by the range, with the range expressed in channel numbers.

For k measurable properties, the maximum number of unique beads would thus equal:

$$\vert U \vert = \frac{{1024}^{k}}{{\prod }_{i = 1}^{k} ( {v}_{i} )} \qquad ( 1.6 )$$

where vᵢ is the range of the ith optical parameter.

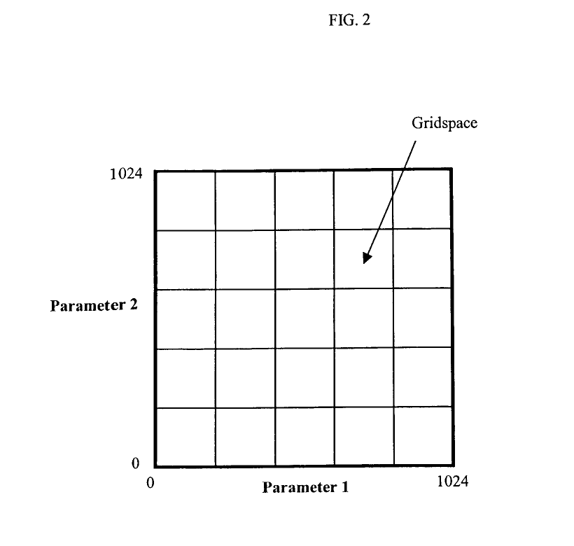

A procedure employed by the sort computer of the invention divides the parameter space into smaller pre-defined grid spaces (see FIG. 2). Initially all the grid spaces are labeled empty (represented by a zero). As beads from a sample population pass through the sorting device, e.g., in single file, the combination of properties belonging to each bead will correspond to a particular grid space. Two possible outcomes can then occur: the grid space is labeled as empty, the bead is sorted and the grid space label is changed to present (e.g., represented by a one); and if the grid space is already labeled as present, the bead may be rejected or sorted as a second copy of a particular type of bead. In desirable embodiments, only one copy of each type of bead is retained in a population of beads.

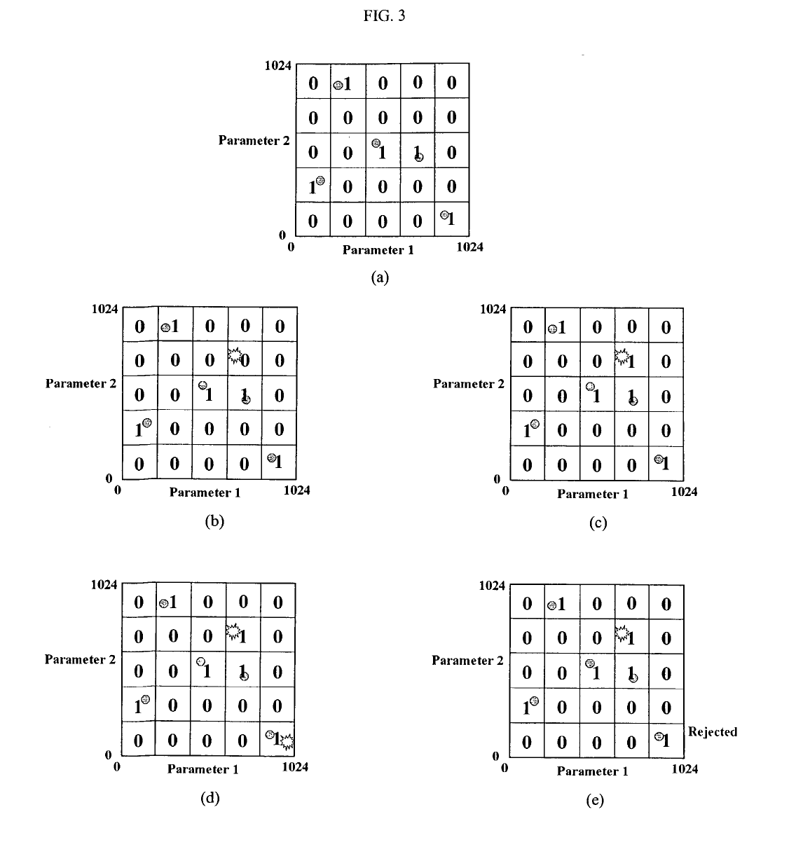

An example of this process is given in FIG. 3. As there is a one-to-one relationship between the beads and the grid spaces, each bead can be represented by the grid space it occupies.

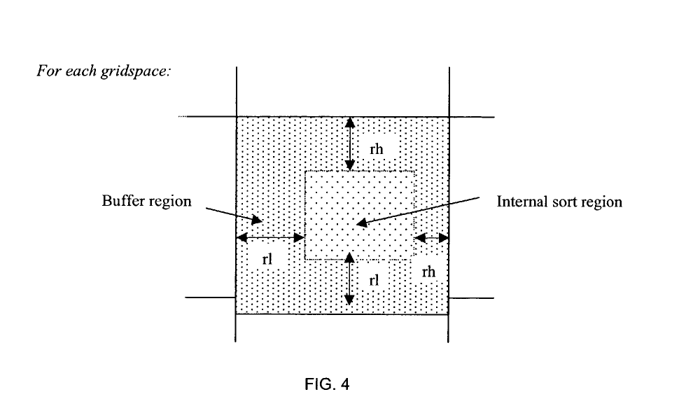

A further refinement of each grid space is preferably required to avoid the case of a bead with a range that overlaps multiple grid spaces. An internal sort region is thus established within each grid space, surrounded by a buffer region defined by the lower, rl, and higher, rh, ranges required for each parameter (see FIG. 4). Beads may now only be collected if they fall into the internal sort region of each grid space. In this manner, a population of unique beads can be extracted from a raw population.

Tracking Beads Through Combinatorial Synthesis

Having generated a population of unique beads from a raw population using the real-time procedure, the population is now pre-encoded for use in a combinatorial split-and-mix synthesis.

Every time the population is split into m batches, each one of the batches is analyzed using a sorting device to determine which of the unique beads are in each batch. A database of all the beads (or corresponding grid spaces) can thus be updated to show the synthetic history of the compound synthesized on each bead. The internal sort region, as described above, is no longer required. Each bead should now remain within the confines of its allotted grid space. Hence, all the beads in a given batch can be identified. In fact, the entire synthetic history of every bead could be determined at a later stage by compiling all the recorded data from every batch in every cycle of the complete combinatorial synthesis.

Description of Sort Computer

Described below is an exemplary sort computer that was developed to interface with a flow cytometer to illustrate the general principles of the sort computer. Based on this description, one skilled in the art could adapt the sort computer to the electronics, detectors, and data structures of any other type of sorting device.

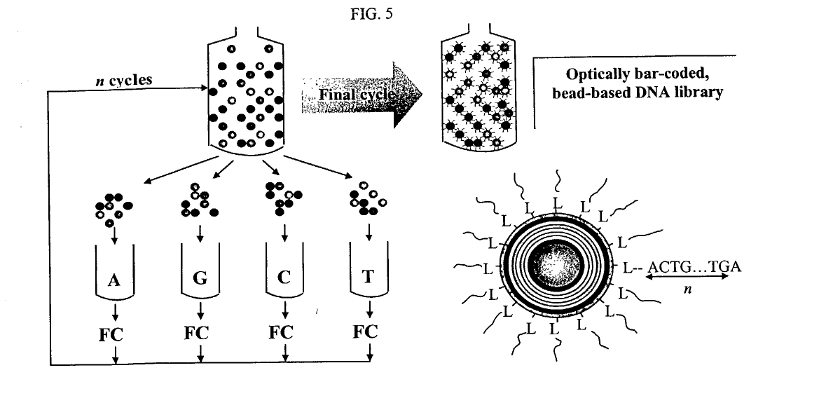

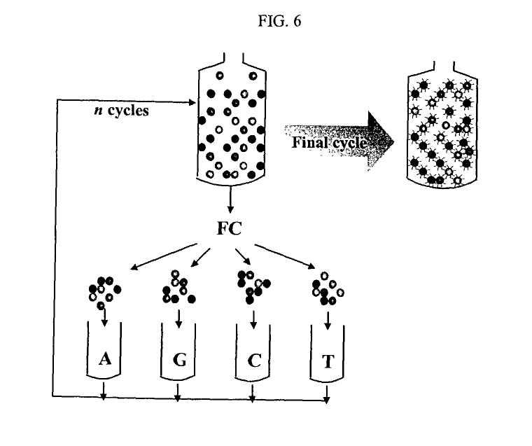

The following description is for a stream-in-air flow cytometer with 8 parameters, 12-bit resolution, and a four-way sort capability. To understand how the sort computer works, it is useful to first understand how a bead is detected, and its properties measured, by a flow cytometer. The use of a flow cytometer or other fluorescence detection device for tracking encoded, solvent-resistant solid support beads through a combinatorial split-and-mix synthesis based on their “optical signatures” is described in WO 00/32542 (see FIGS. 5 and 6).

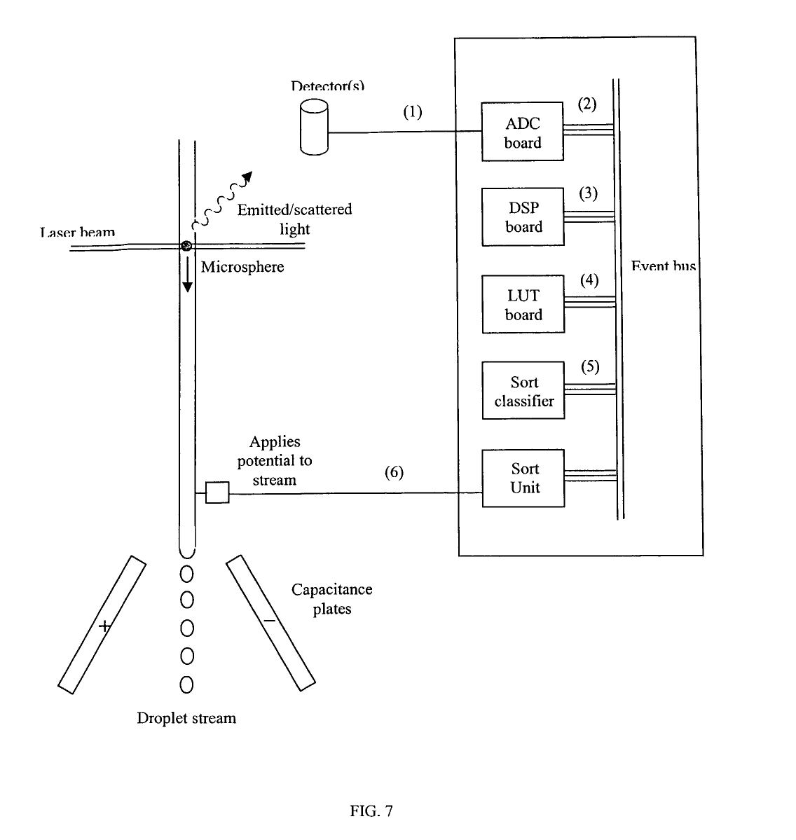

For a bead to be detected by a flow cytometer it must first cause the intensity on a detector, such as a photodiode or photomultiplier tube, to exceed a user-defined threshold value. Once this condition is met, a sequence of well-defined electronic steps, known as an event packet, occurs (FIG. 7):

1. Each detector will generate an electrical current dependent upon the intensity of the signal from a bead.

2. These raw current signals are passed to the corresponding analog-to-digital converter board for each detector, which performs analog-to-digital (ADC) conversion of the raw signals and places the converted parameter values onto the event bus. The parameter values are expressed as channel numbers in a discrete range from 0−(2ⁿ−1), where n equals the resolution or number of bits per parameter value.

3. If necessary, digital signal processing (DSP) may also be performed on the parameter values, such as fluorescence compensation or calculating the ratio of two values. The processed parameter values are then placed onto the event bus.

4. Each lookup table (LUT) board obtains the appropriate values from the event bus and places a result onto the event bus that indicates if those values satisfy user-defined sort regions or not.

5. The sort classifier board then obtains all the results from the LUT boards and places a sort decision result onto the event bus based on the user-defined sort logic. The sort decision describes whether the droplet containing the bead is to be sorted left, right, half-left, half-right or not sorted at all.

6. The sort unit obtains the sort decision result from the sort classifier board and arranges for the bead to be sorted in a particular direction.

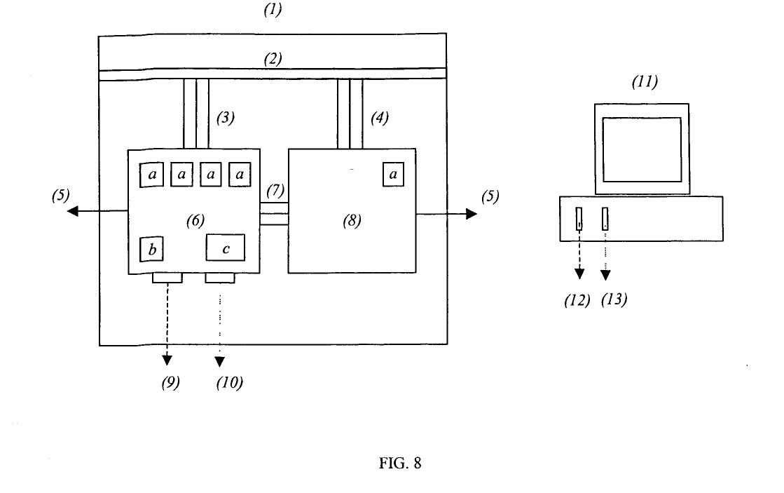

An exemplary sort computer of the invention includes three main components: (FIG. 8) an electronic board (known as a sort computer board that can interface with the flow cytometer via its event bus; an electronic board (known as a fluorescence compensation board) that can also interface with the sorting device; and a master computer that is interfaced with the sort computer board.

Both the sort computer board and the fluorescence compensation board may be powered on or off independently of the sorting device. Through the interface to the cytometer, the sort computer board can read and write data onto the event bus of the cytometer. The sort computer board also contains grid space memory devices, the delta event log memory device, and a microprocessor.

The fluorescence compensation board can read data but does not write data to the event bus. The fluorescence compensation board is also interfaced to the sort computer board. It cannot operate independently of the sort computer board and may be enabled or disabled by the user. When the fluorescence compensation board is enabled, the sort computer board obtains the parameter values from the fluorescence compensation board. When the fluorescence compensation board is disabled, the sort computer instead uses the parameter values placed by the flow cytometer's DSP board onto the event bus.

The master computer is connected via both a serial and an enhanced parallel port (EPP) connection to the sort computer board. Other types of ports, e.g., universal serial bus and firewire, may be used to communicate with a given sorting device. The fluorescence compensation board can be accessed by the master computer through the sort computer board. The EPP connection is used to upload or download data to the memory devices and microprocessor. The serial connection is used to monitor the status of the sort computer board, and for debugging purposes. Customized software is installed on the master computer for use of the sort computer's functions.

Software

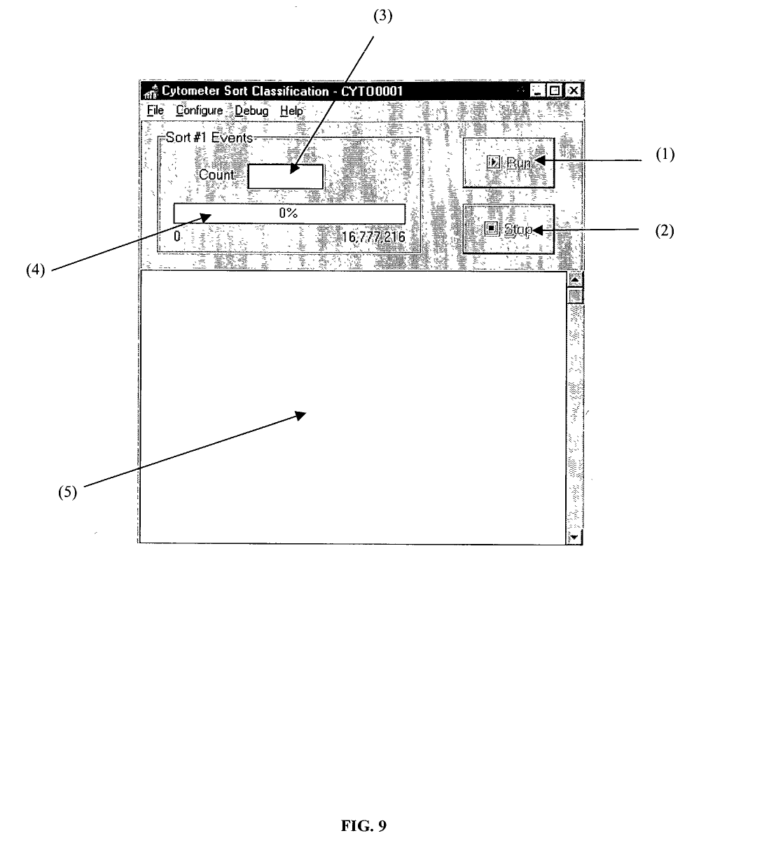

For a description of exemplary software (referred to as Cytowin 1.0) installed on the master computer that is used to control the operation of the sort computer, see FIGS. 9-13.

The software has five main features:

(1) allows the user to alter settings such as the number of parameters (detectors) used and the compensation matrix values, etc.

(2) uploads/downloads data from the sort computer board and fluorescence compensation board, e.g., via serial and enhanced parallel port connections.

(3) allows the user to monitor the status of the sort computer while in operation.

(4) allows the user to debug the sort computer board and fluorescence compensation board.

(5) allows the user to load or save projects.

In this exemplary software, for a given project for the sort computer, three types of files are generated:

a. An initialization file containing the software settings used, e.g., the compensation matrix and which parameters were used. These values are obtained from the software itself and stored as a text file;

b. A separate file for each grid space memory. Each grid space memory is downloaded from the sort computer board and stored as a binary file; and

c. A file containing the delta event log memory. The delta event log memory is downloaded from the sort computer board and stored as a binary file.

Referring to FIG. 9, (1) starts the sort computer, i.e., events are sorted using the grid space procedure; (2) stops the sort computer; (3) displays the count of how many events have been sorted by the sort computer; (4) displays the count as a percentage of the total number of available grid spaces; and (5) is message window used for status information and debugging.

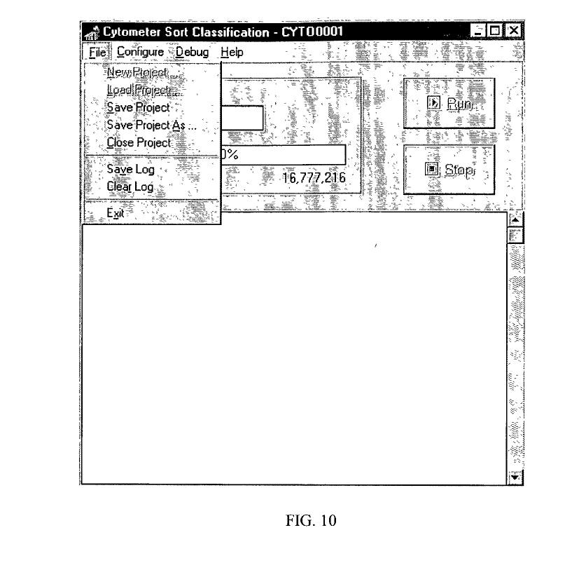

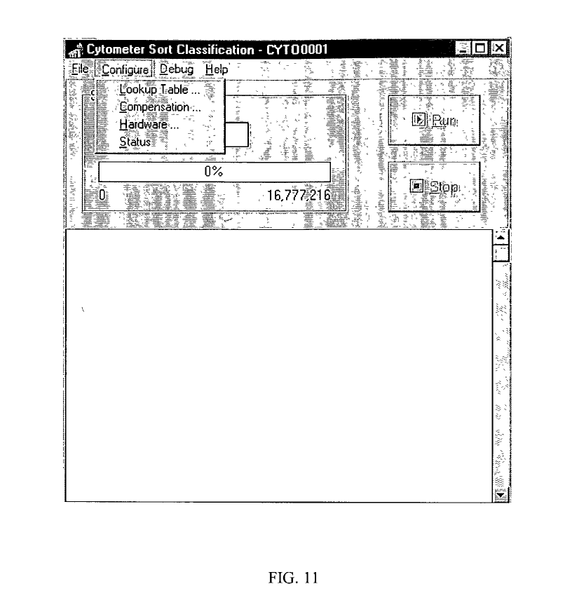

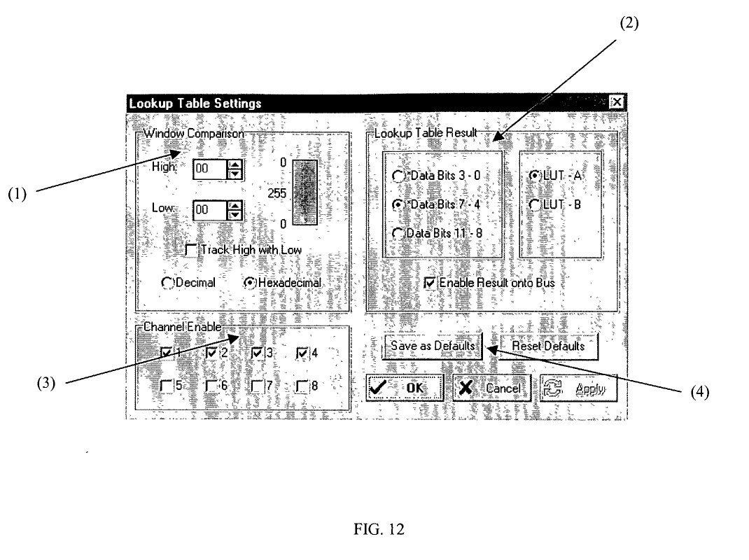

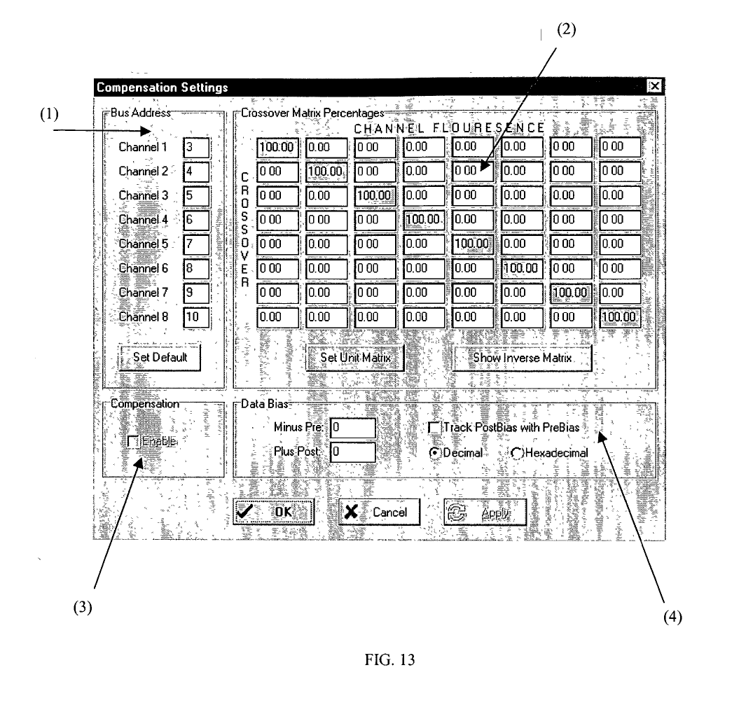

Referring to FIG. 10, the commands in the file menu are defined as follows:

| | |
|---|---|
| New Project: | Clears each grid space memory and the delta event log memory on |
| | the sort computer board. |
| Load Project: | Loads a previous project. Each grid space binary file is uploaded to |
| | its corresponding grid space memory device. The delta event file is |
| | also uploaded to the delta event log memory device. Software |
| | settings are updated to those settings in the initialization file. Note: |
| | this allows directed synthesis to be achieved by uploading pre- |
| | determined grid space memories for each sort direction. |
| Save Project: | Saves the current project. The grid space memories and the delta |
| | event log memory are downloaded and stored as binary files. |
| | Current software settings are saved in the initialization file. |
| Save Project As: | As above, but can specify where to save the project files. |
| Close Project: | Similar to New Project. The current project needs to be closed |
| | before a new or previous project can be loaded. This prevents |
| | accidental loss of data. |
| Save Log: | Saves the text displayed in the message window as a text file. |
| Clear Log: | Clears the text displayed in the message window. |
| Exit: | Closes software program. Prompts to save unsaved project. |
| Referring to Figure 11, | |
| the commands in the | |
| configure menu are | |
| defined as follows: | |
| Lookup Table: | Opens a new window containing settings used in the grid space |
| | procedure, e.g., which parameters are used, how wide is the internal |
| | sort region, etc. (see FIG. 12). |
| Compensation: | Opens a new window containing the compensation matrix and |
| | settings (see FIG. 13). |
| Hardware: | Opens a new window which allows user to select which parallel port |
| | is used to communicate with sort computer board. |
| Status: | Retrieves current status information from sort computer board via |
| | the serial port connection. Status information is displayed in the |
| | message window. |

Referring to FIG. 12, the following features are present in the Lookup Table settings window.

(1) Window comparison: the settings used in the window comparator. The lower and higher boundaries of the internal sort region can be set, using either decimal or hexadecimal notation. The internal sort region is also displayed graphically in the adjacent box.

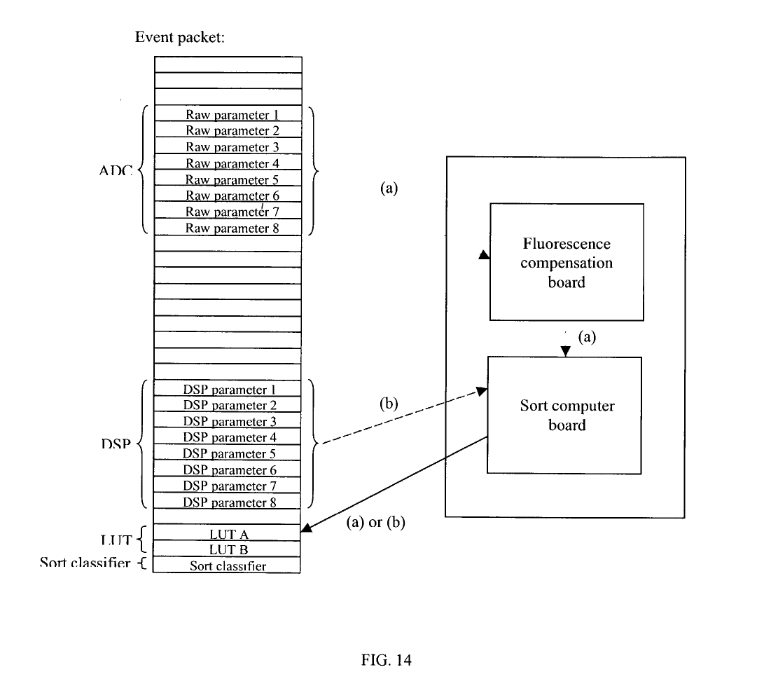

(2) Lookup table result: the settings that determine where in the event packet (see FIG. 14) the sort decision made by the sort computer is placed onto the event bus.

(3) Channel enable: the settings that determine how many parameters are to be used. In the diagram, there are four parameters selected (channels 1 to 4).

(4) Allows software settings to be saved as defaults. Referring to FIG. 13, the features of the compensation settings window are as follows:

(1) Bus Address: the settings used to match a given channel with a given parameter on the event bus.

(2) Crossover matrix percentages: the settings used to compensate each channel with every other channel. Percentages are entered either directly into each textbox or by using a slider bar. The inverse matrix is calculated by the software, and the inverse matrix is uploaded to the fluorescence compensation matrix memory devices on the fluorescence compensation board via the parallel port connection to the sort computer board, which is also interfaced to the fluorescence compensation board. Alternatively, the crossover matrix can be reset by the Set Unit Matrix button.

(3) Compensation: this checkbox enables or disables the compensation board.

(4) Data bias: the settings used to set the auto-fluorescence correction described in Bagwell and Adams supra.

By inputting the appropriate parameters in the above referenced software, the exemplary sort computer of the invention can be used to sort beads based on a user-defined sort logic. Variations to this software may be employed in order to interface with a particular sorting device. Based on the present description, one skilled in the art could program software with the above-described functions. Alternatively, the functions of the sort computer may be programmed into hardware.

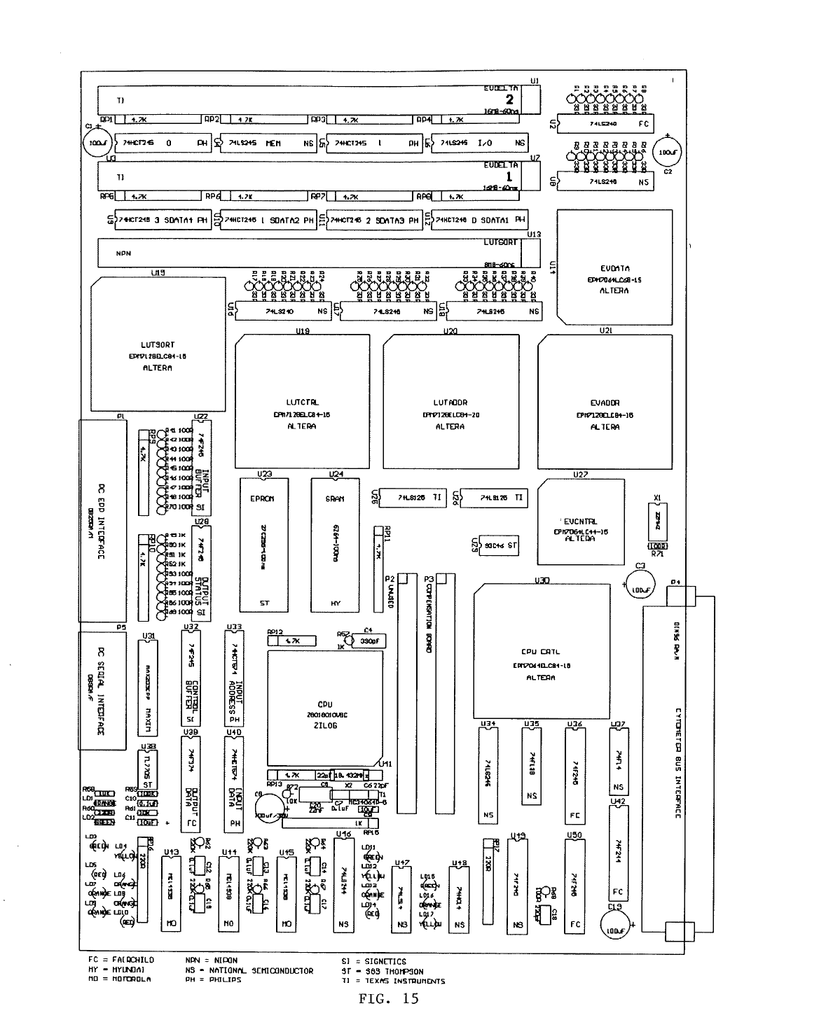

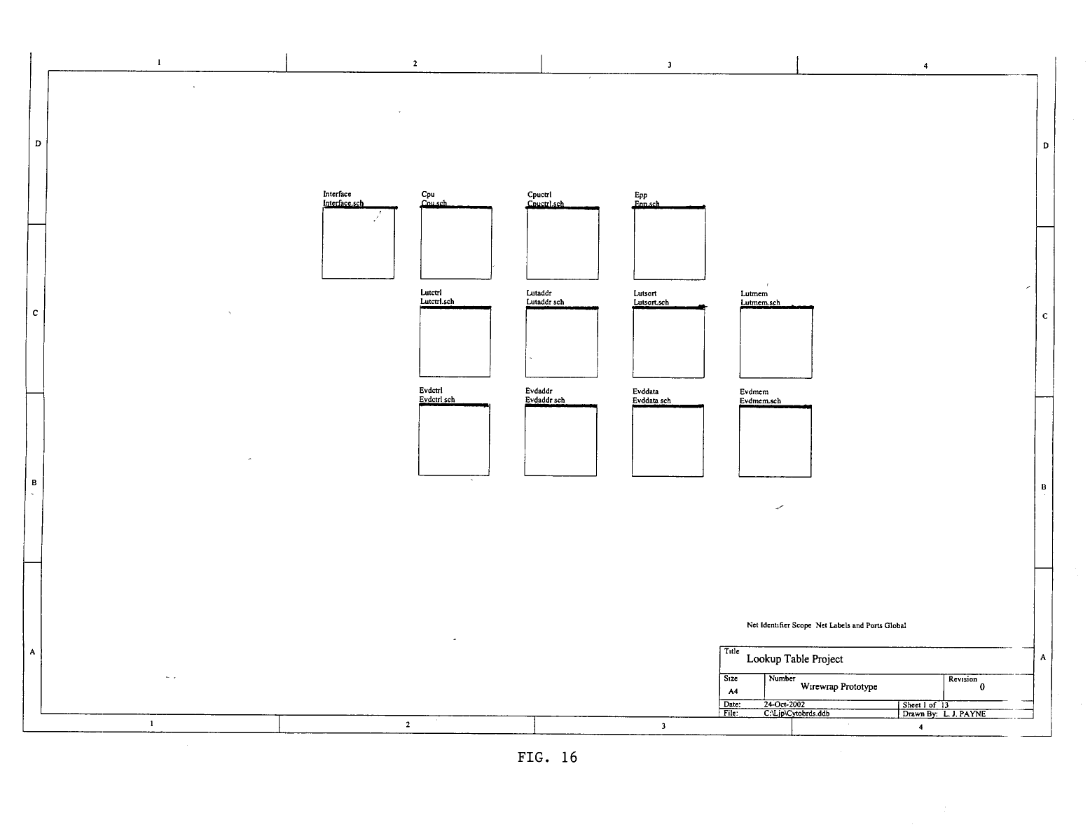

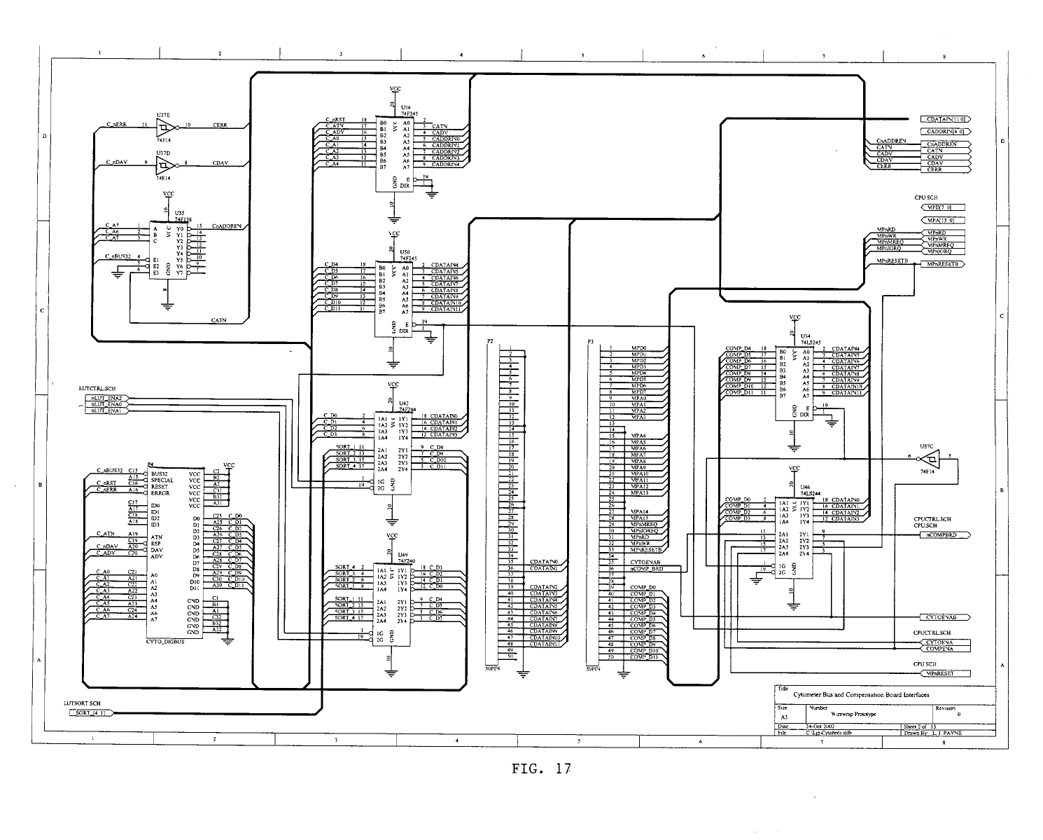

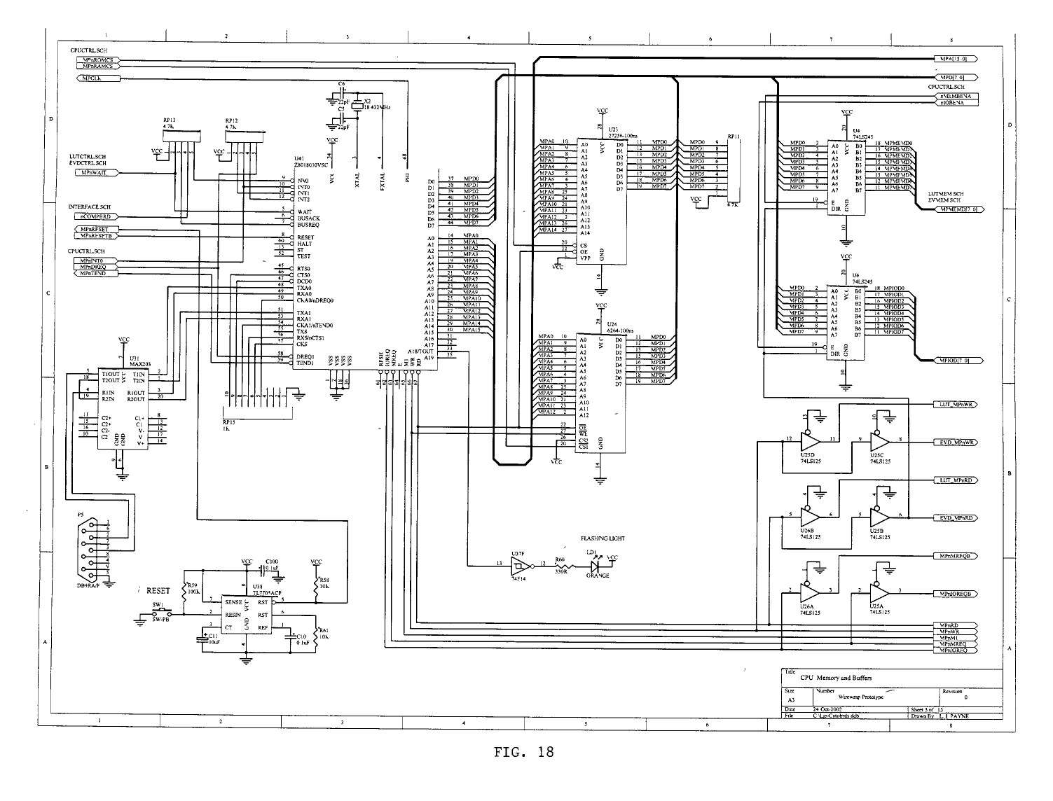

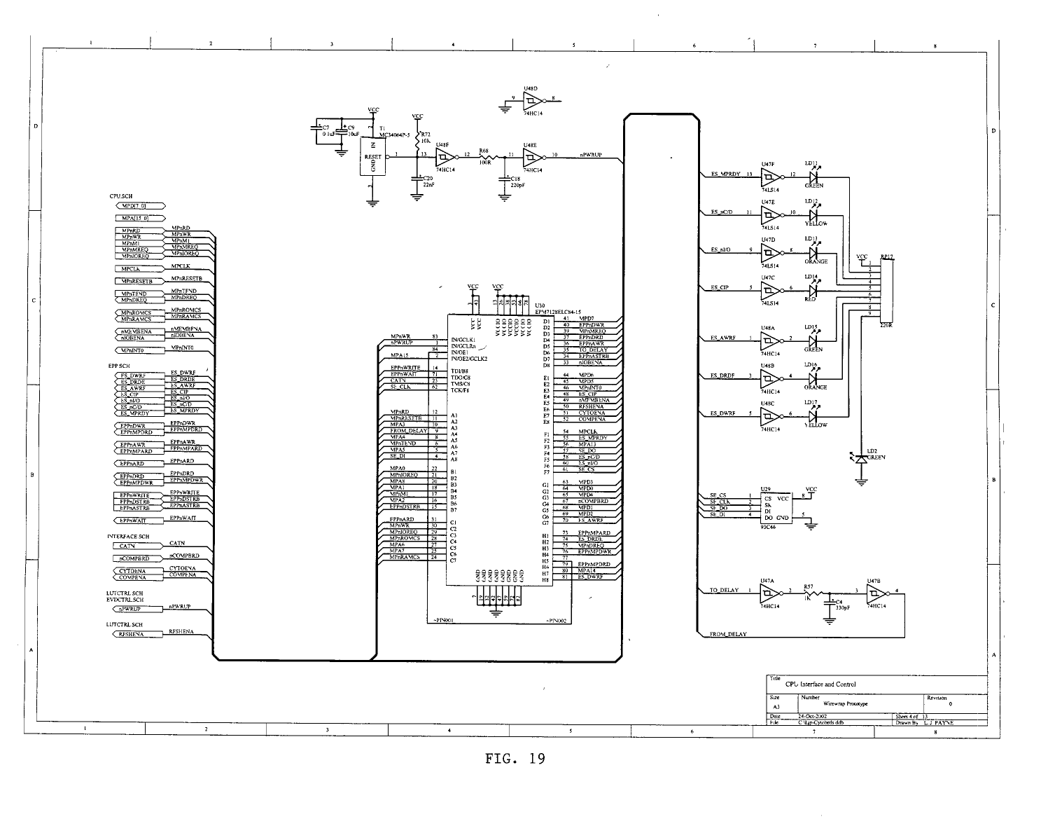

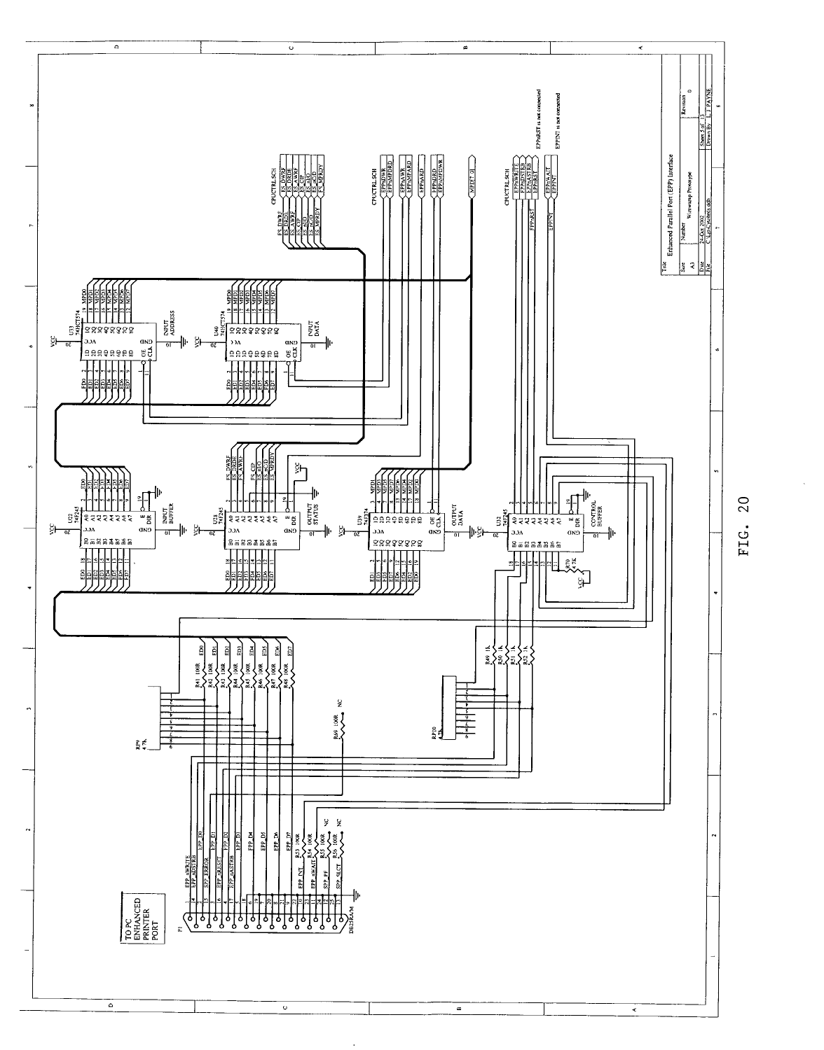

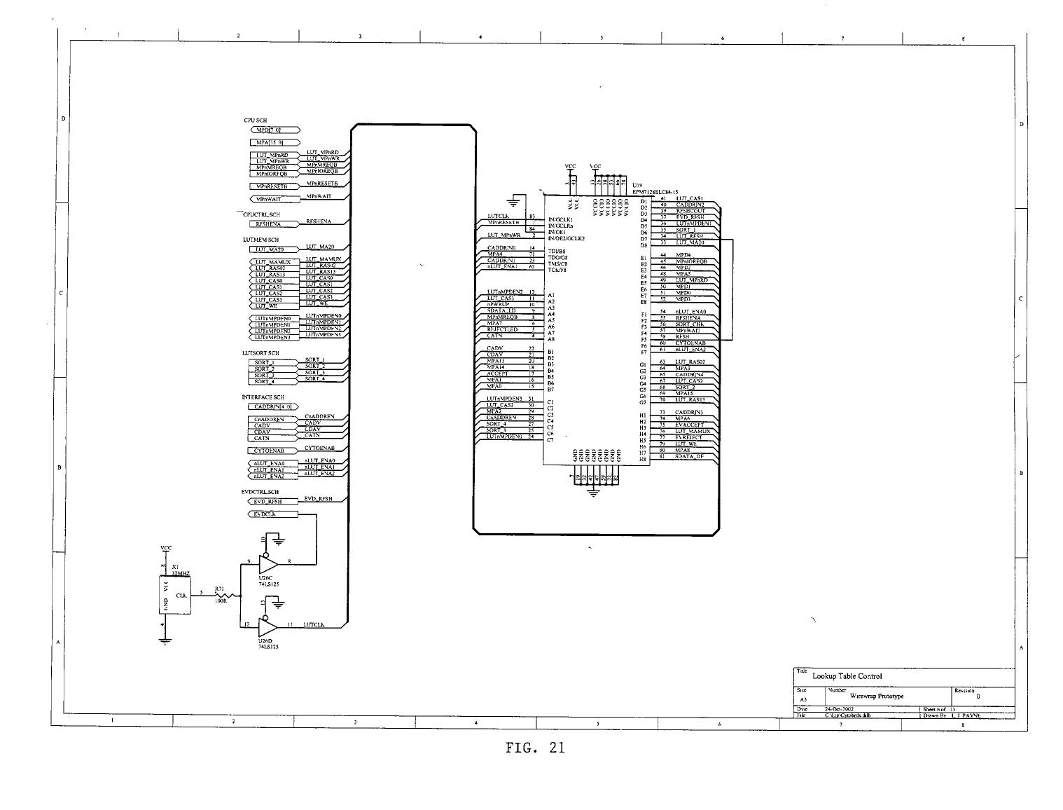

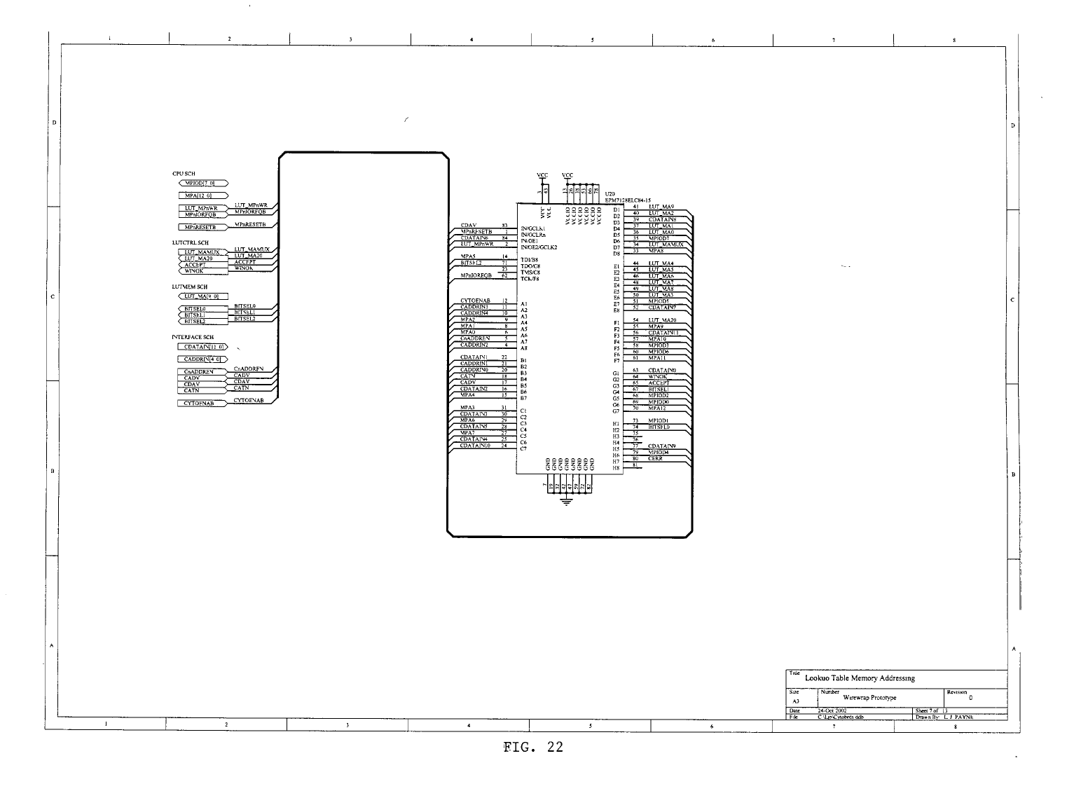

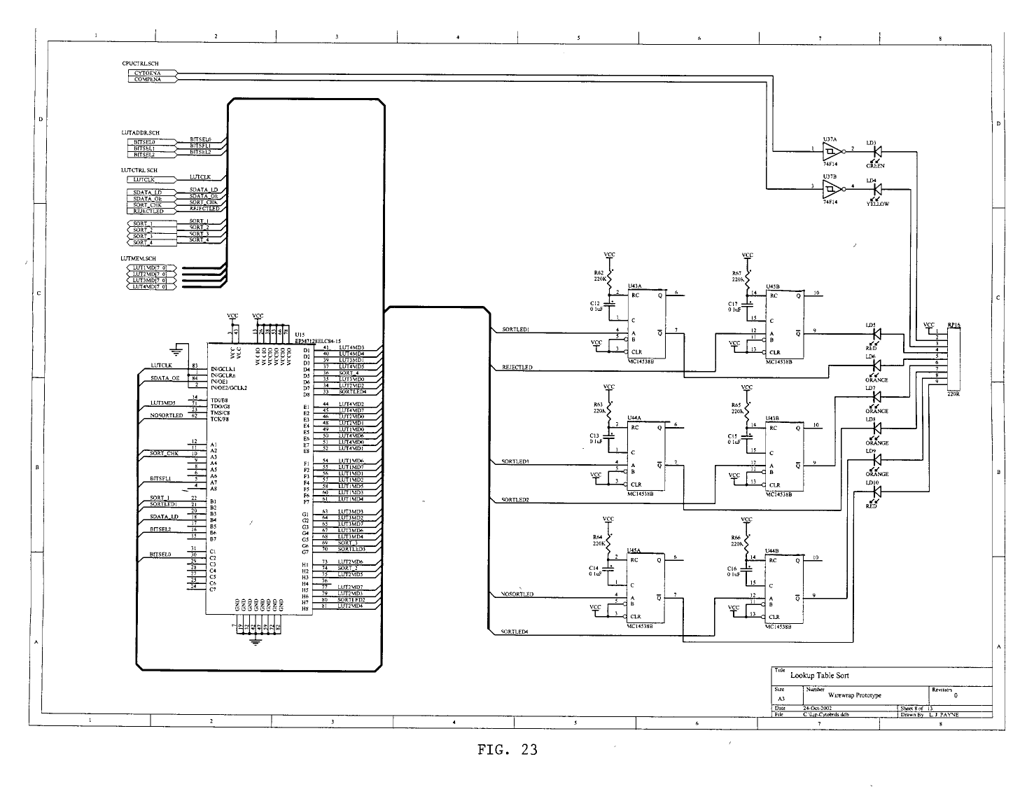

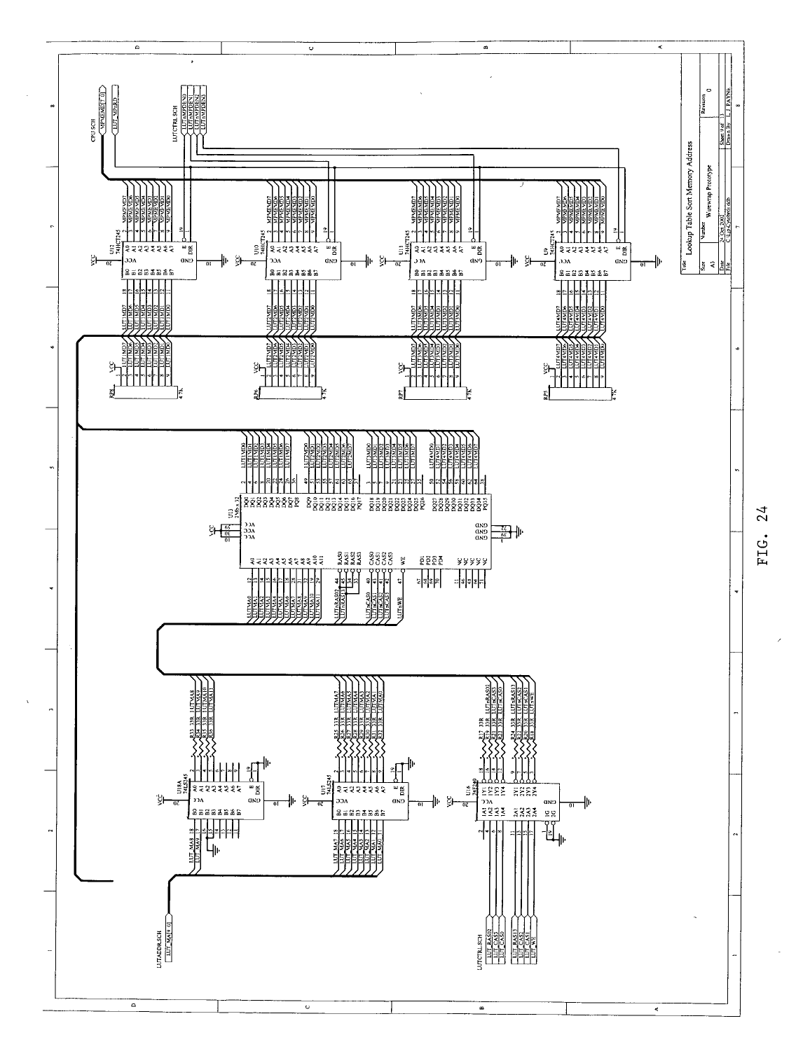

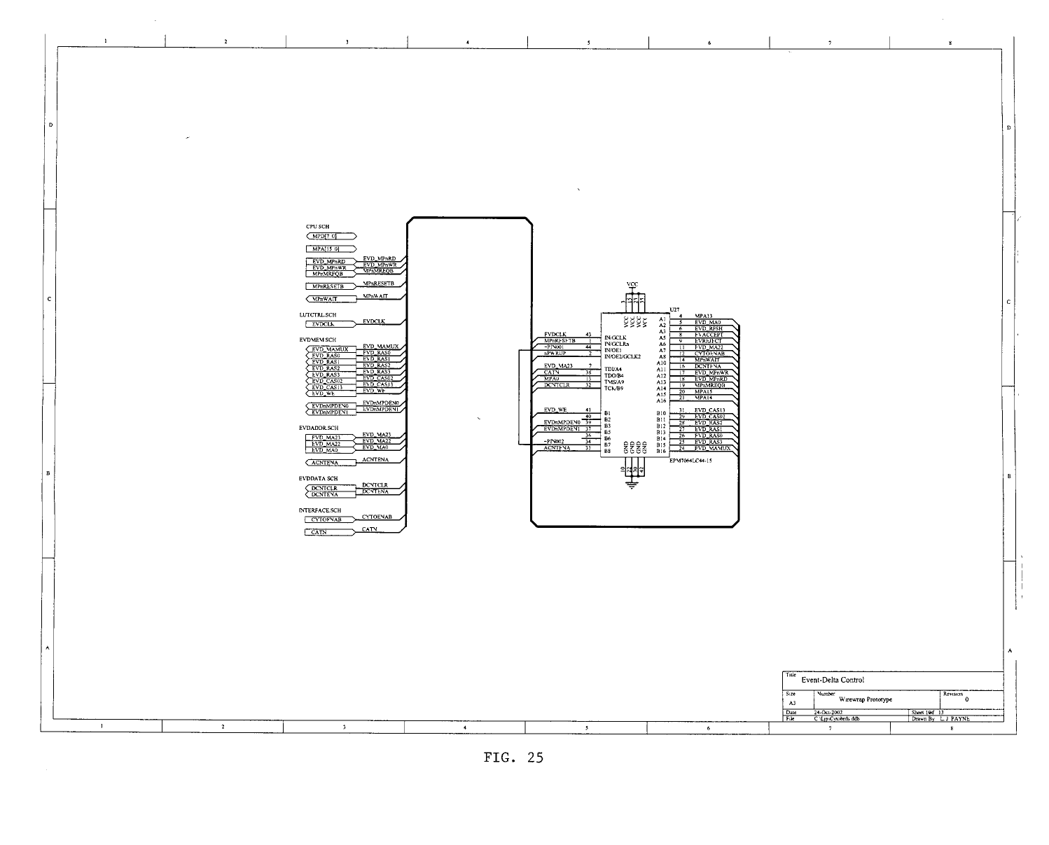

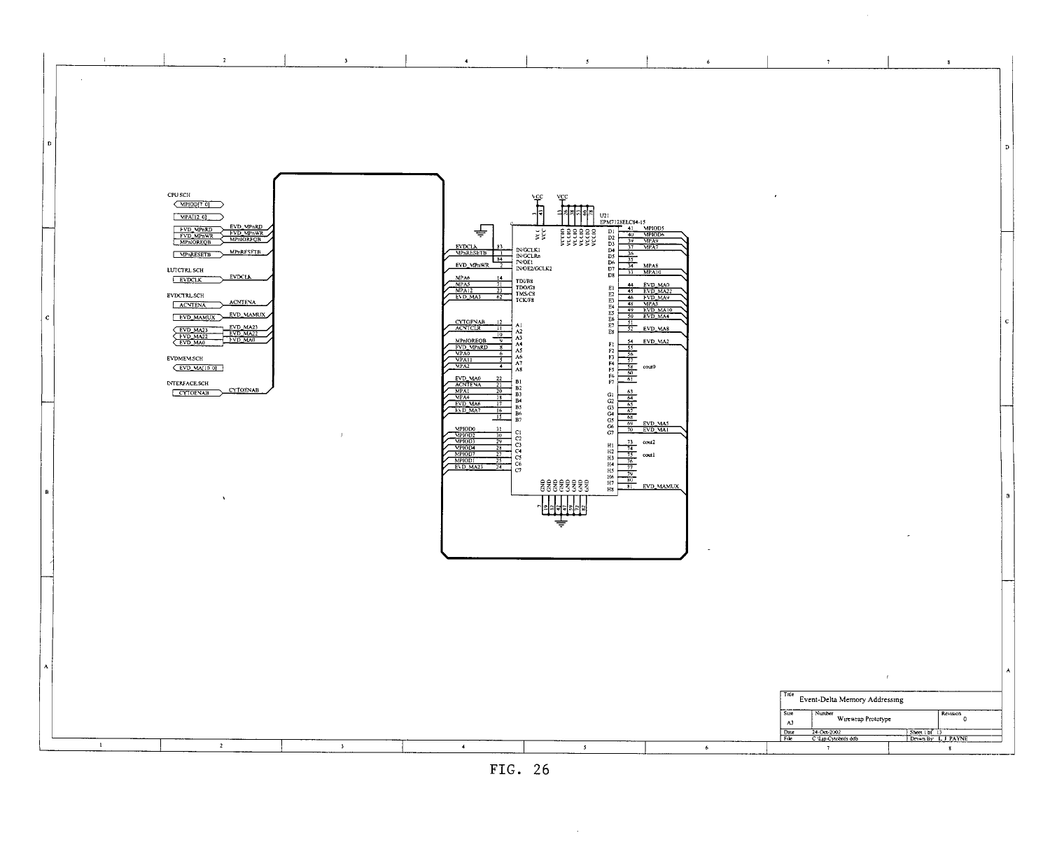

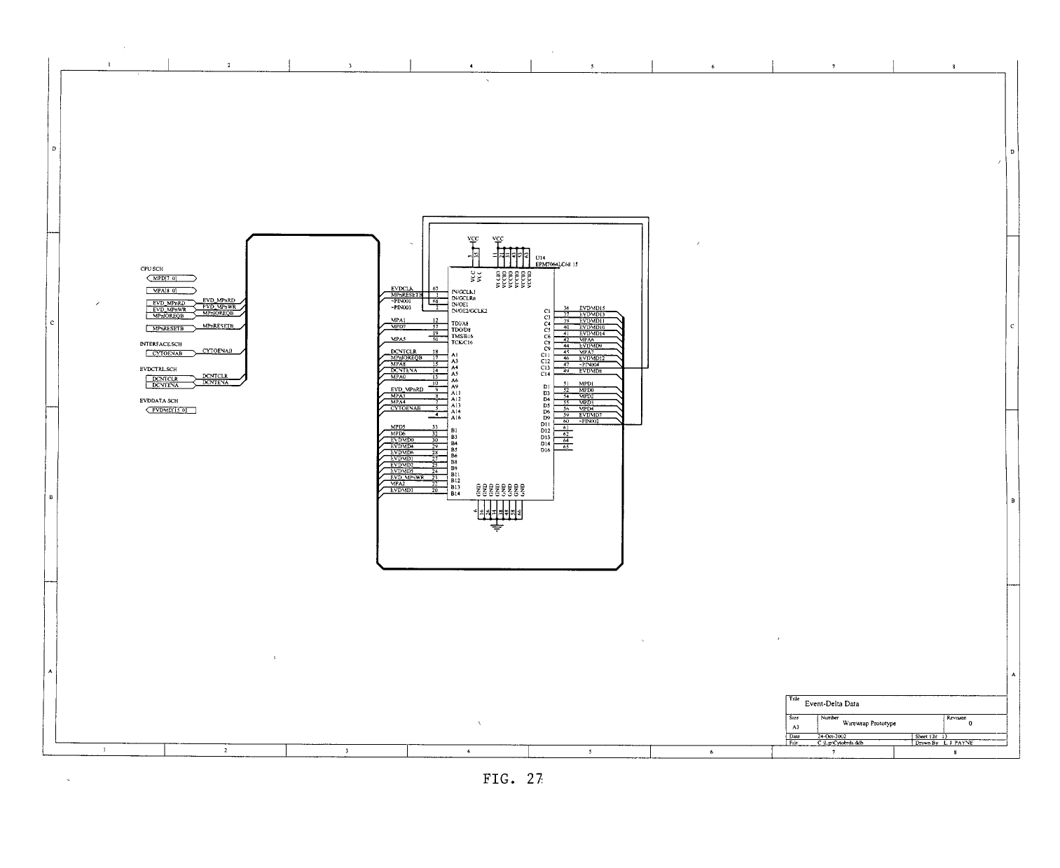

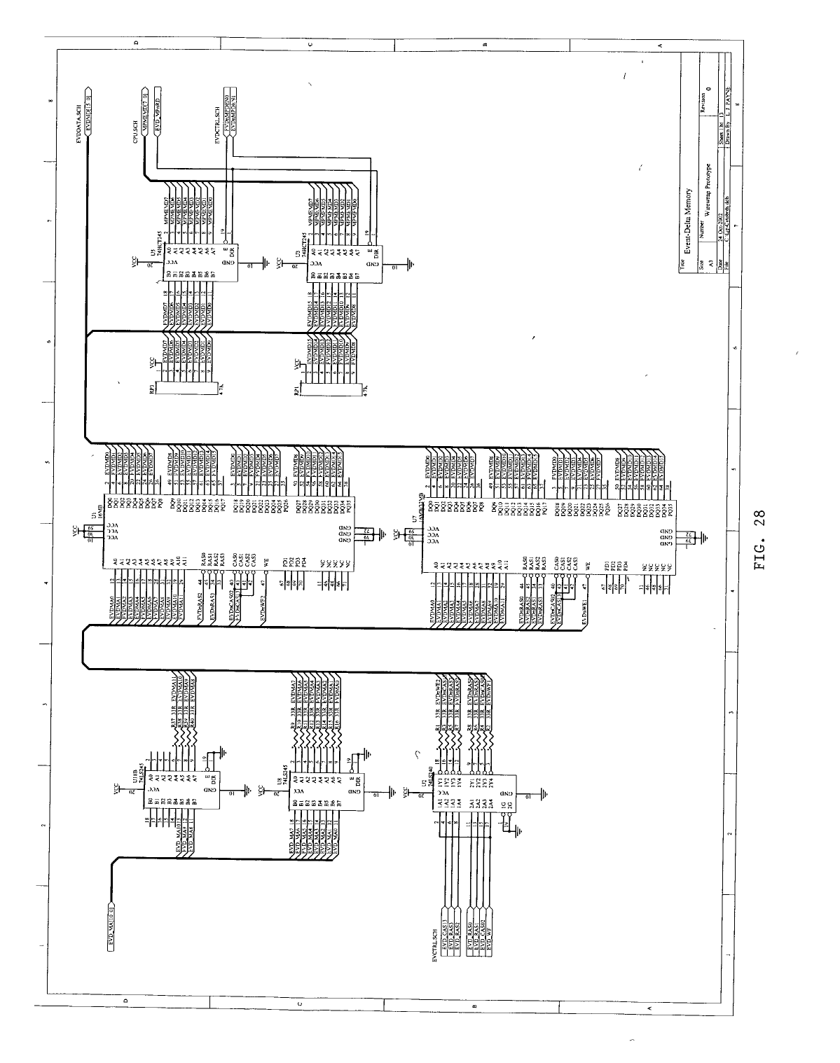

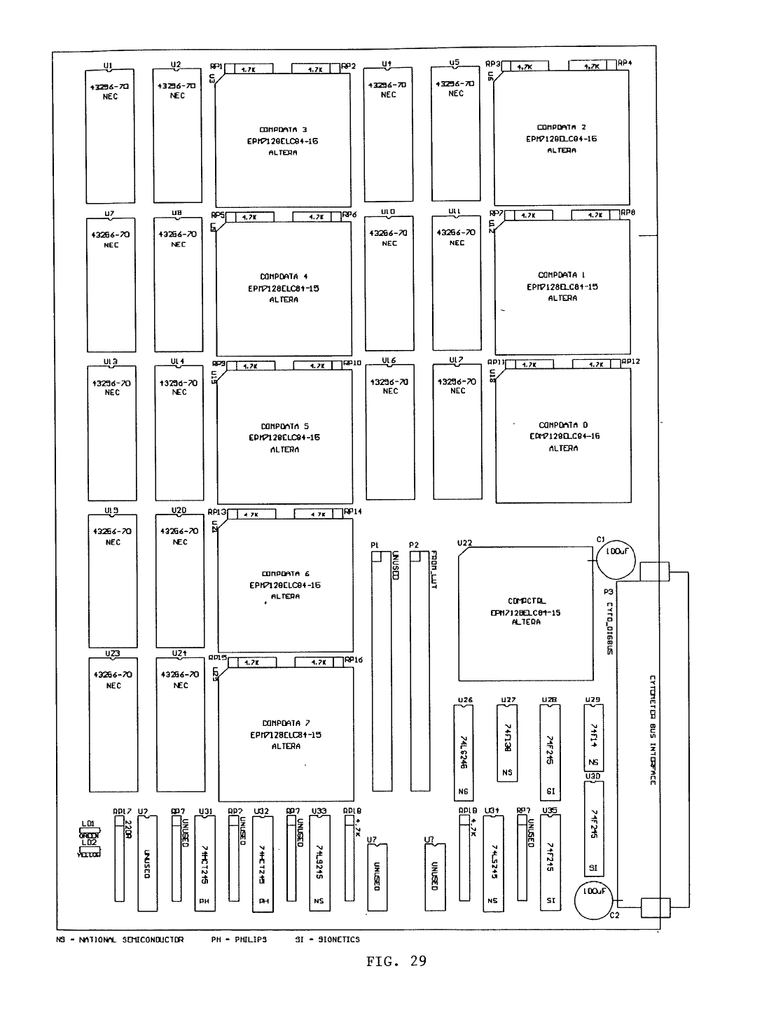

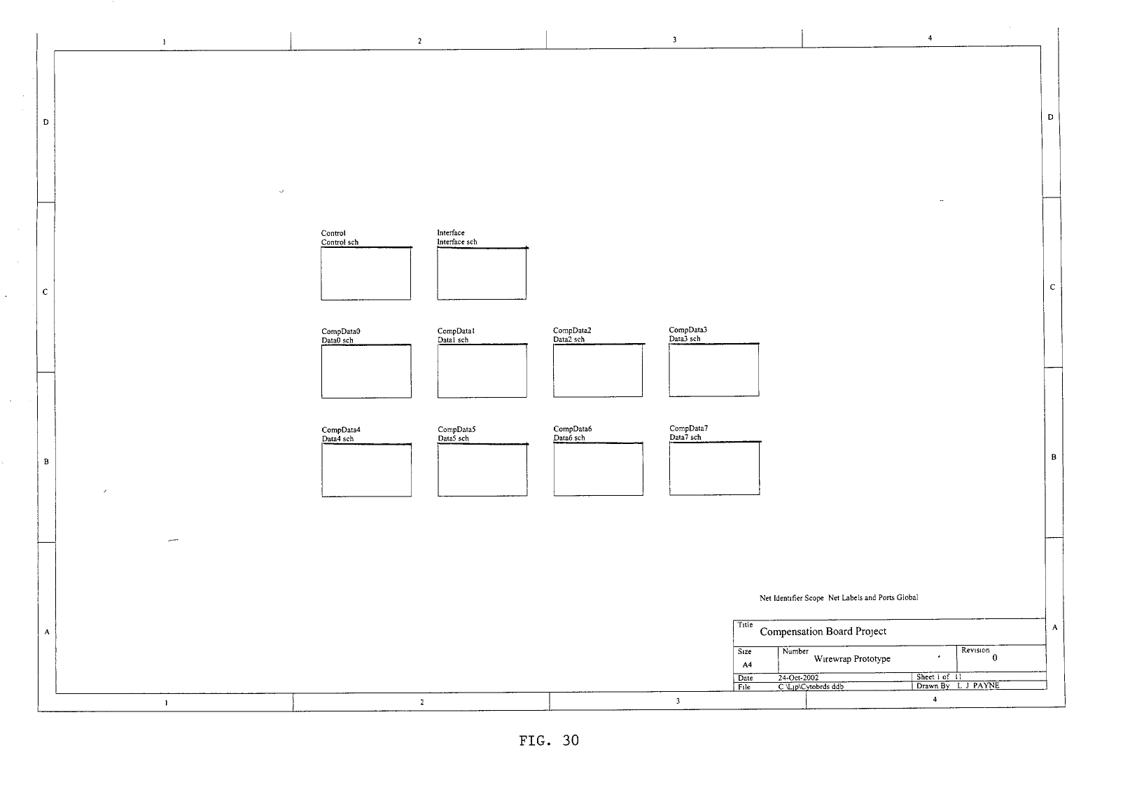

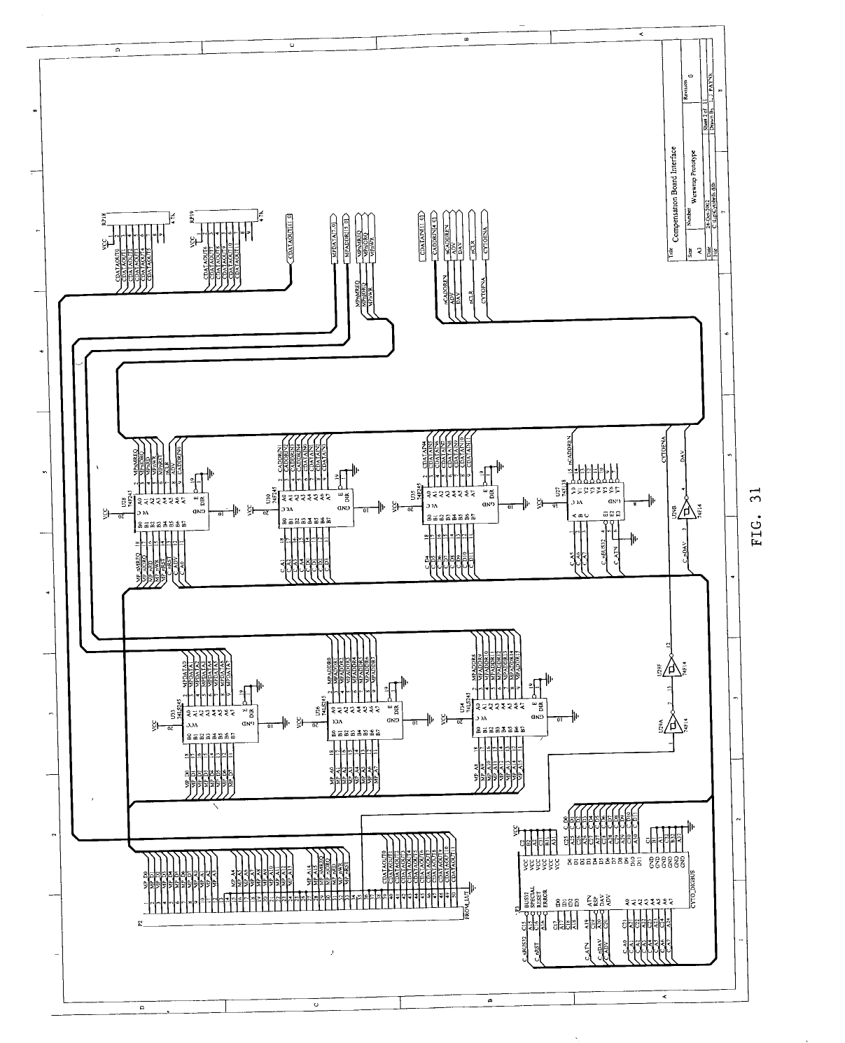

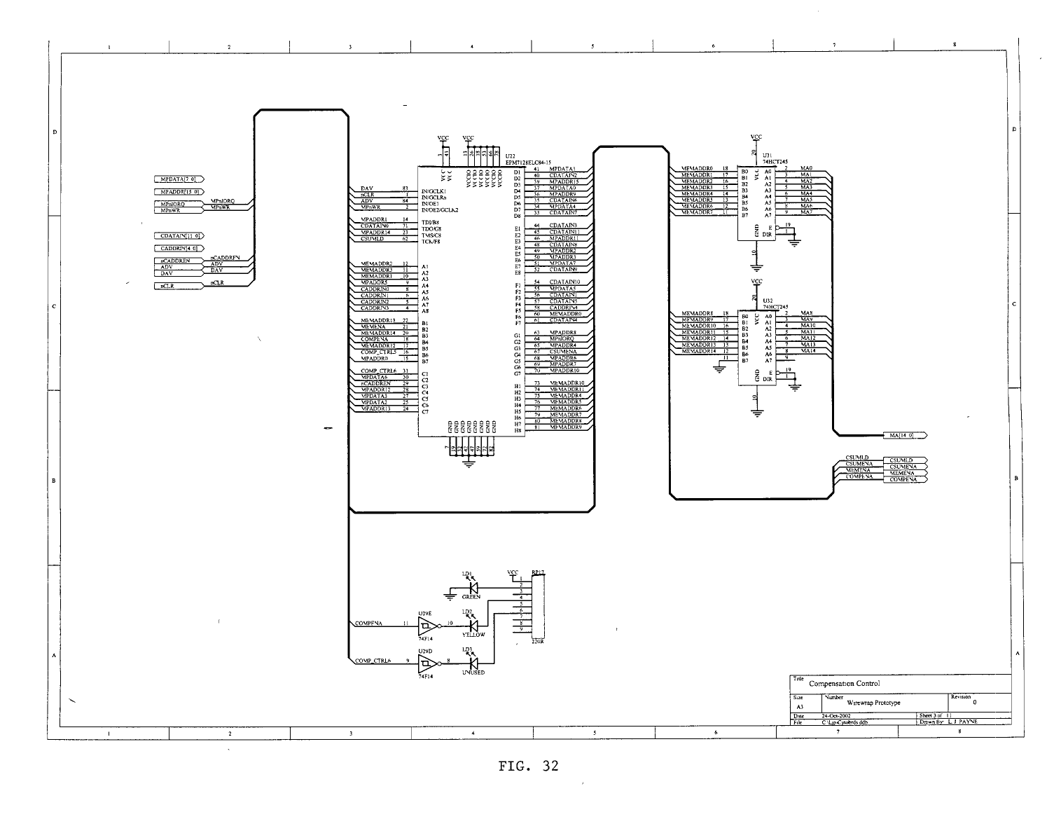

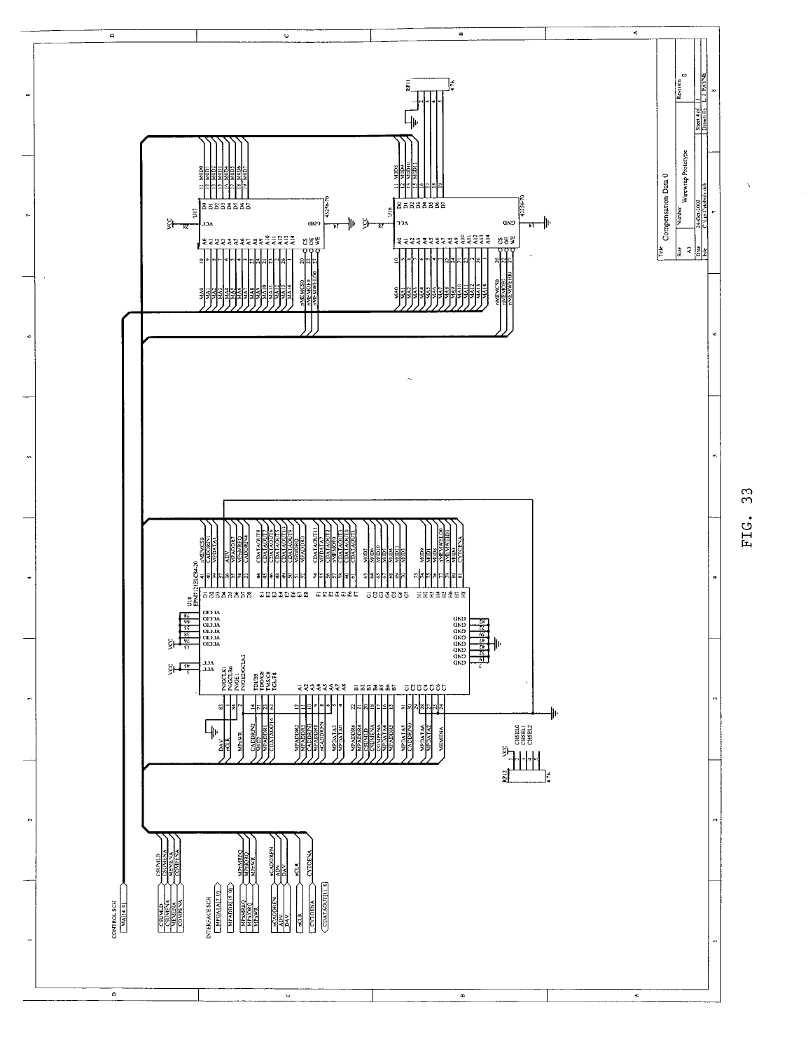

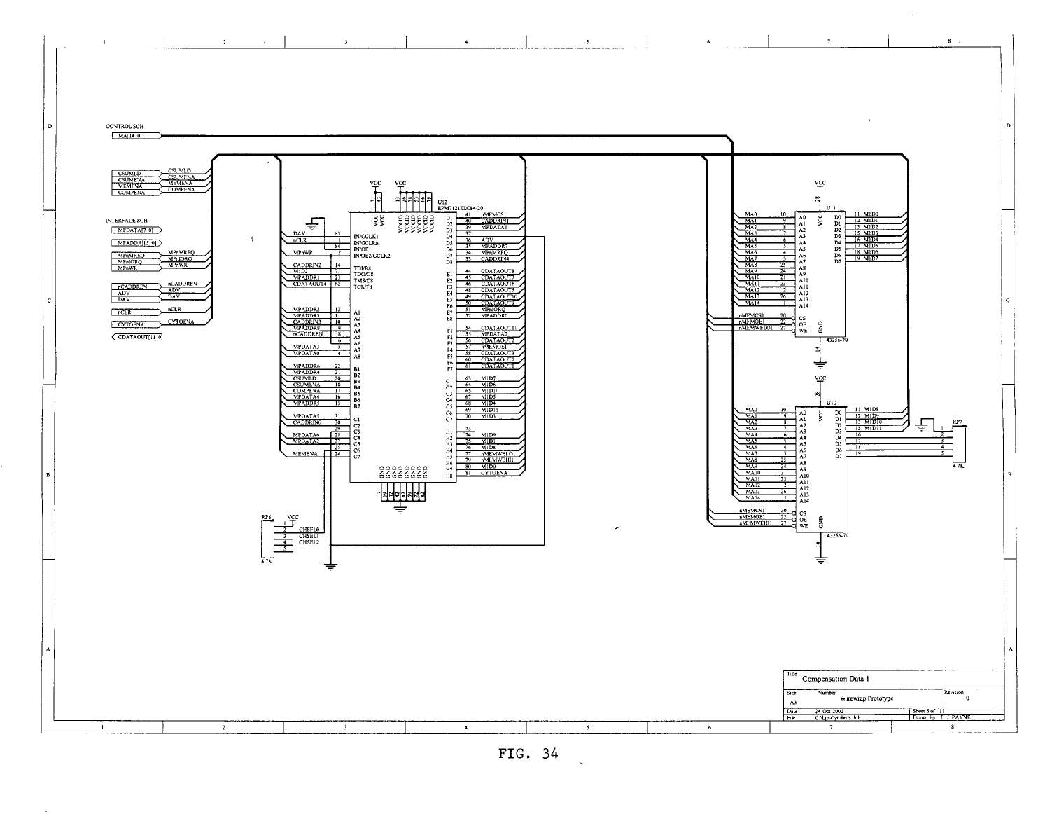

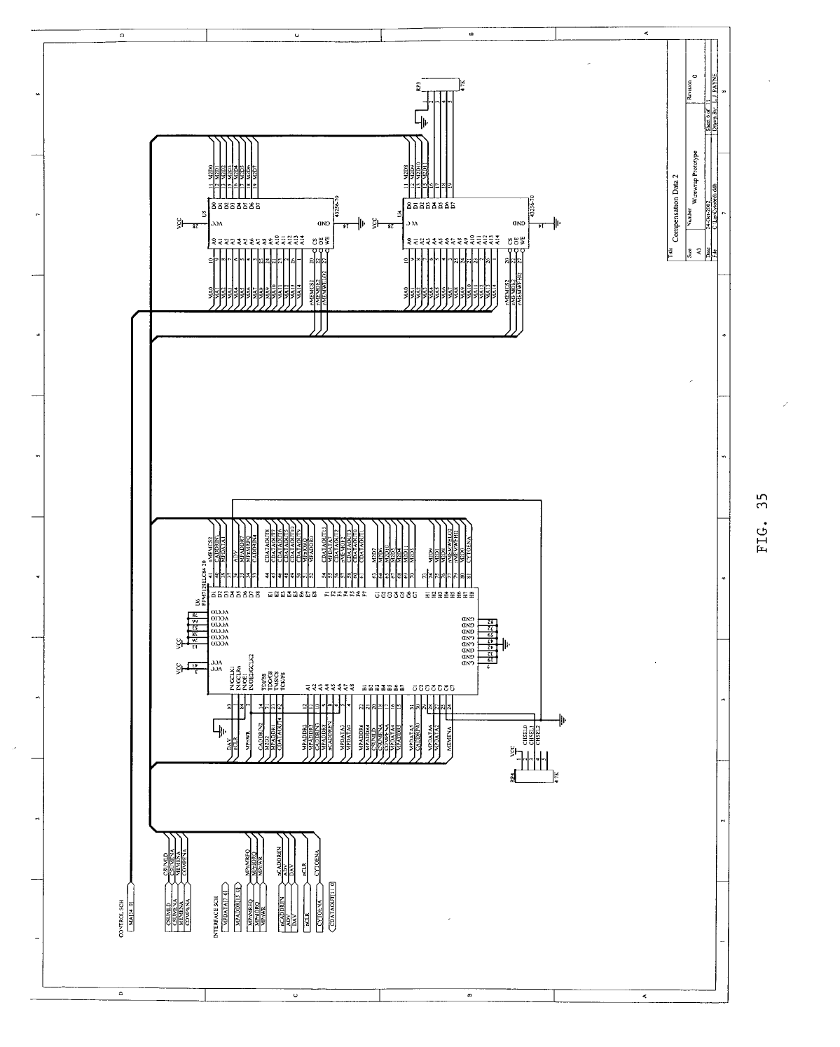

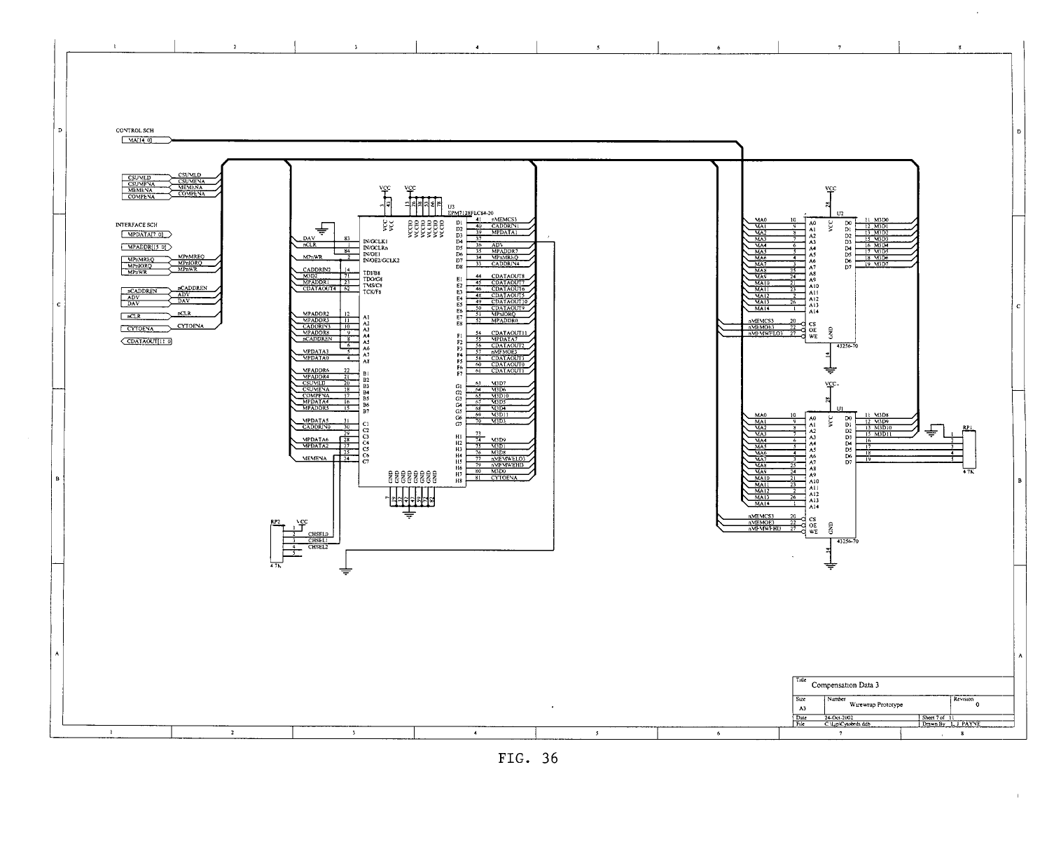

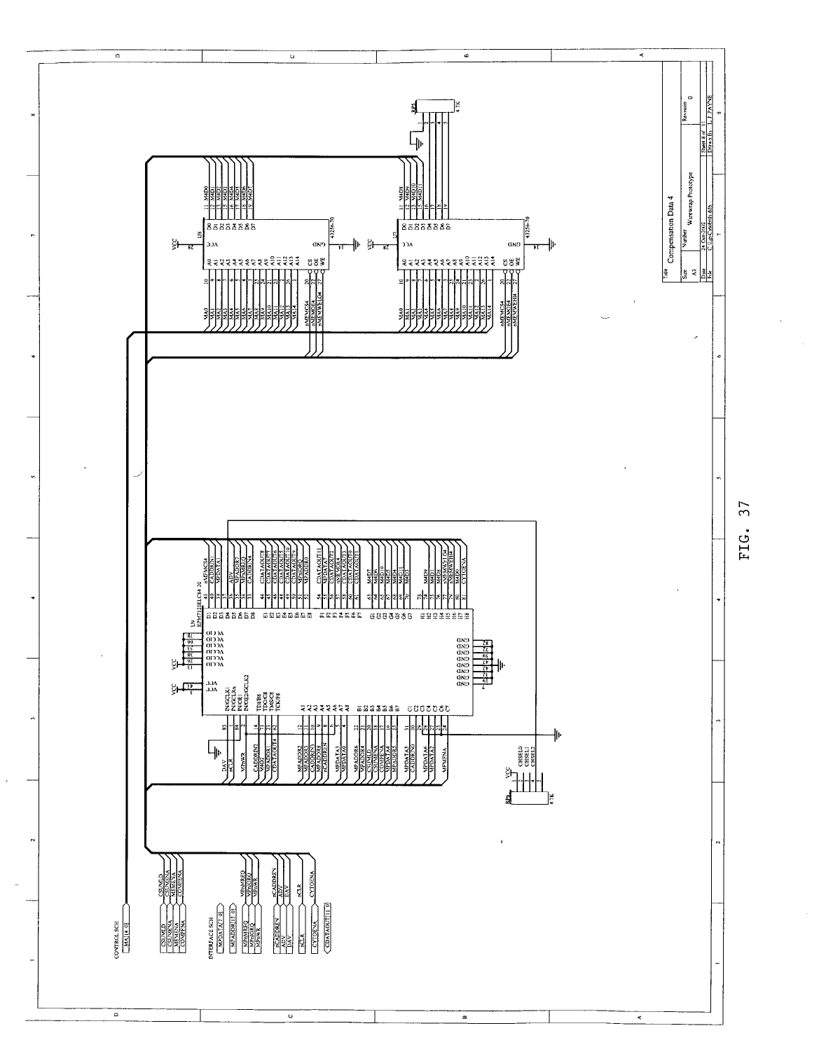

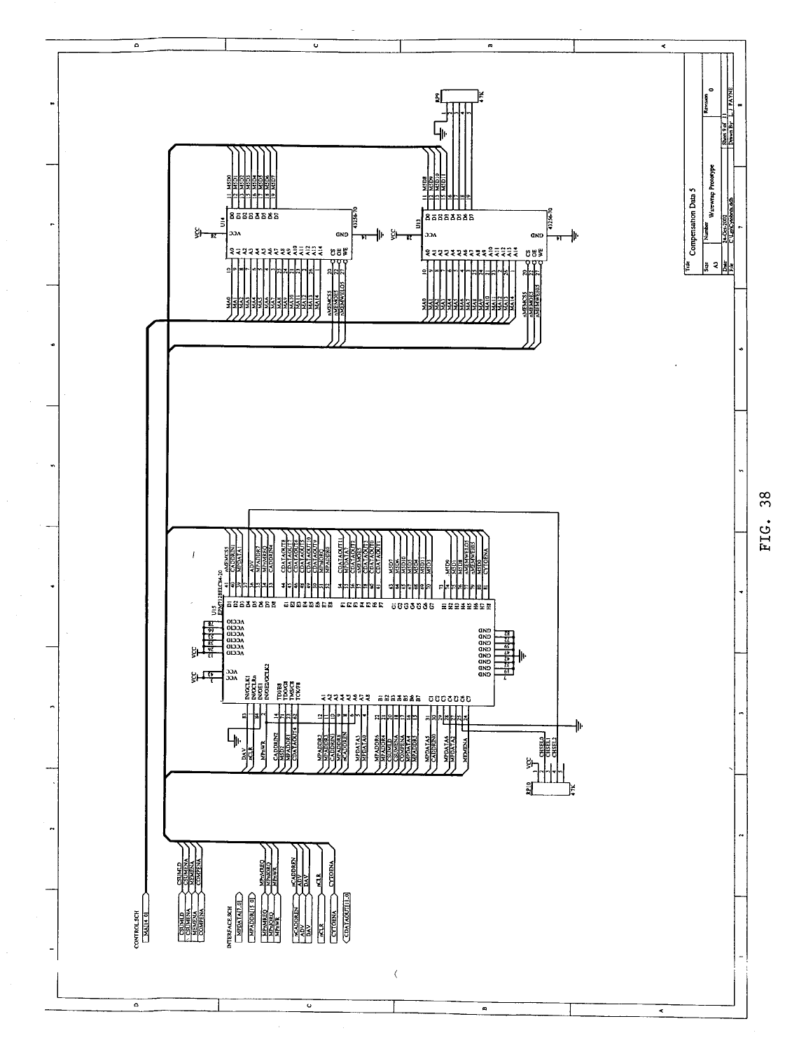

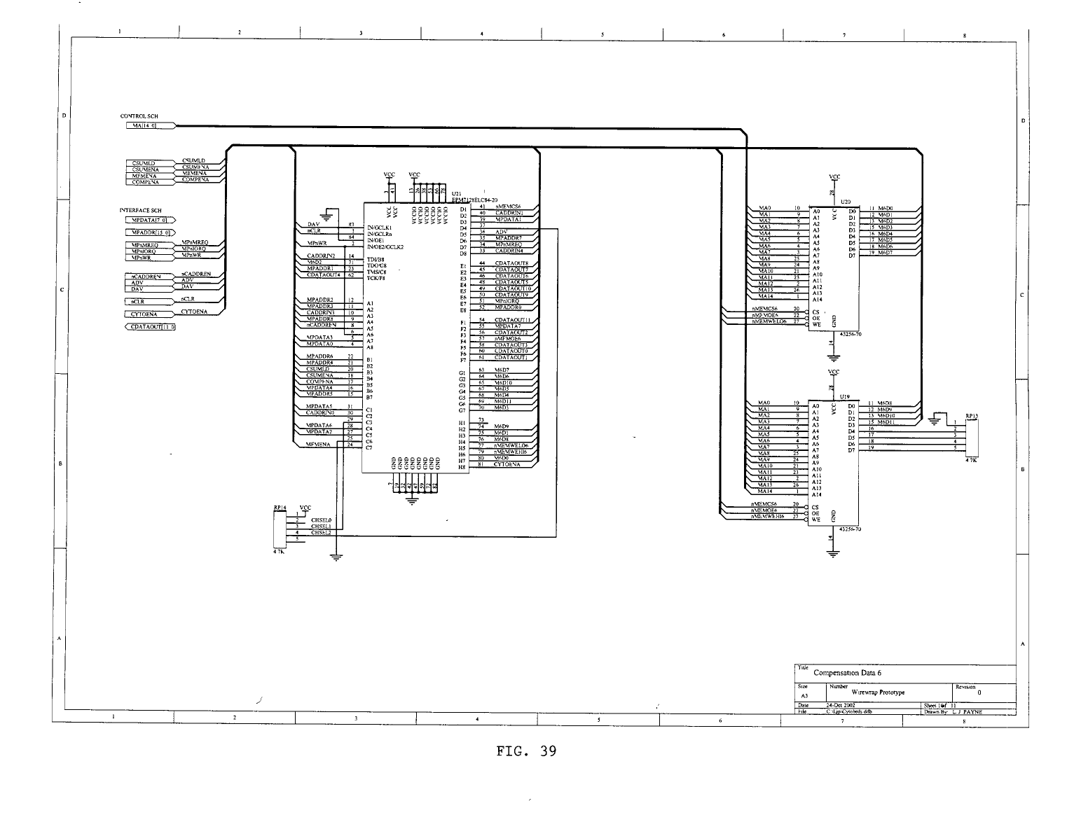

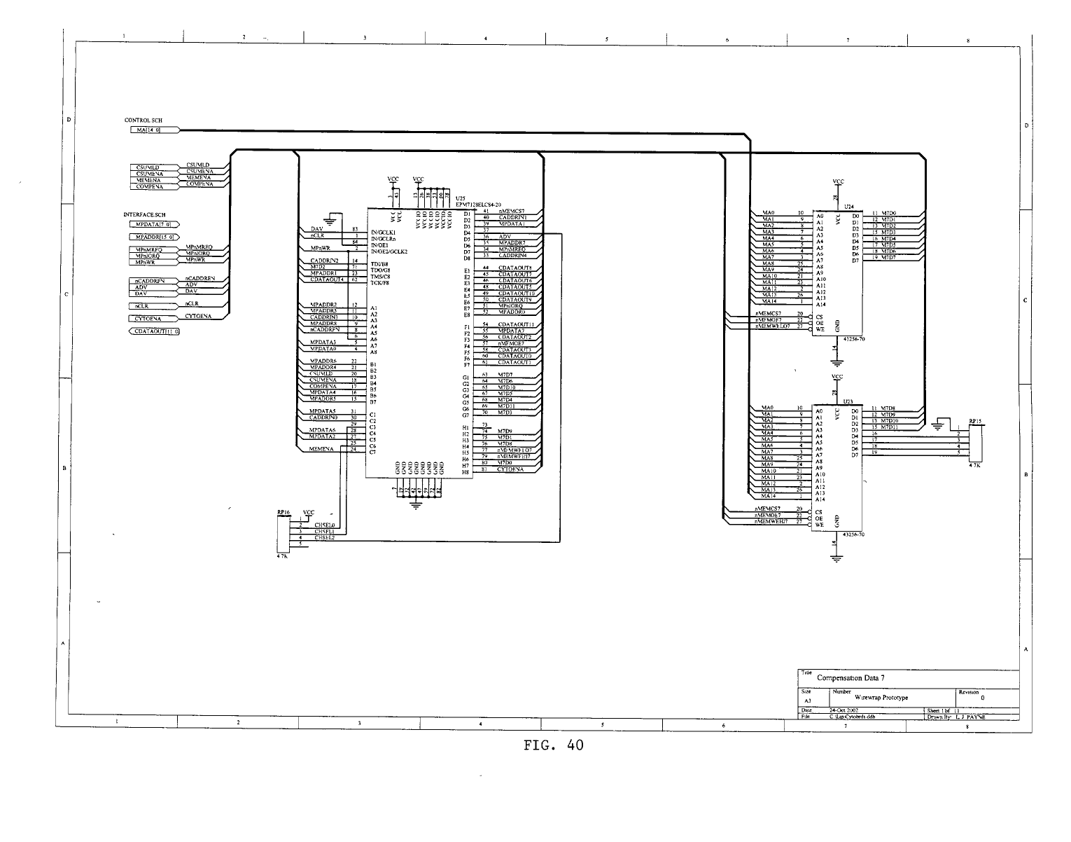

The circuit diagrams for both the sort computer board and the fluorescence compensation board are located in FIGS. 15-28 and 29-40, respectively.

Description of the Sort Computer Board:

The sort computer board replaces the role of the LUT board in the above description. If the fluorescence compensation board is enabled, the parameter values are obtained from the fluorescence compensation board ((a) in FIG. 14). If it is disabled, the parameter values are obtained from the data placed on the event bus by the DSP board ((b) in FIG. 14). Regardless of which input source is used, the result is placed back onto the event bus when the LUT boards would normally be expected to place data during the event packet (i.e., LUT A or B) (FIG. 14).

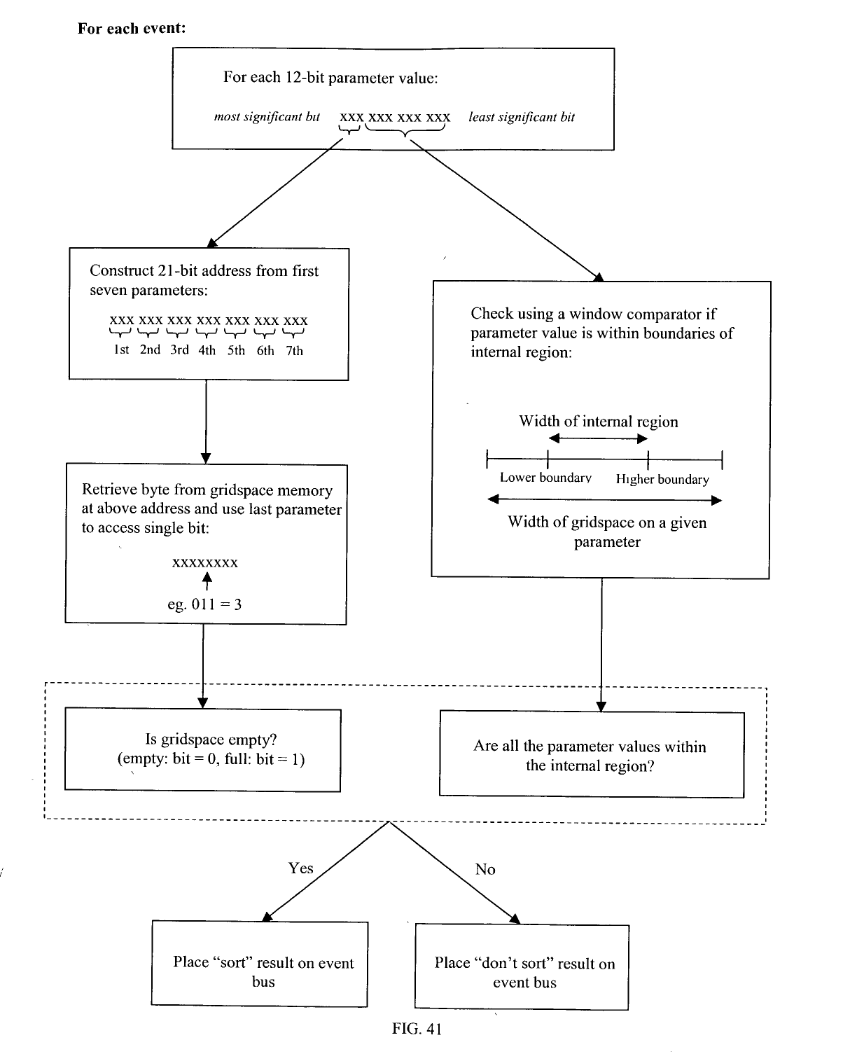

For each event that is detected, its parameter values are checked by the sort computer to see if the event should be sorted or not (FIG. 41). The three most significant bits of the first seven 12-bit parameter values are concatenated together to form a 21-bit memory address. This memory address is used to retrieve the corresponding byte from the grid space memory device. The three most significant bits from the eighth parameter is used to access a single bit in the byte. This bit represents the status of the grid space to which the event belongs. In addition, the nine least significant bits of each parameter value are passed through a window comparator to see if the parameter value is within the user-defined internal region as described above. The window comparator determines whether the parameter value is higher than the lower boundary, and lower than the higher boundary.

In desirable embodiments, if the bit representing the grid space indicates that the grid space is empty (i.e., bit=0) and every parameter value is within the internal region, then a sort result is placed onto the event bus. If the bit representing the grid space indicates that it is full (i.e., bit=1), or any parameter value is not within the internal region, then a “don't sort” result is placed onto the event bus.

The processing of an individual event by the sort computer occurs within the time taken for the event packet to be processed, and is independent of the size of the population of beads.

In other desirable embodiments, more than one bit could be used to represent each grid space. The number of bits used places an upper limit on the number of carriers that could be collected from each grid space. In this case, the most significant three bits from all eight parameters would be used to access the address in the grid space memory. A given event will now be sorted if the value at an address representing a grid space is less than the upper limit and every parameter value is within the internal region. A sort result would then be placed onto the event bus, and the value of in the grid space memory (number of events) is incremented by one.

Description of Fluorescence Compensation Board

If enabled, the fluorescence compensation board accesses the raw parameter values placed by the ADC boards onto the event bus. A user-defined compensation matrix located in the customized software on the master computer is matrix-inverted and uploaded to the fluorescence compensation board. The raw parameter values are then compensated using the method for compensation of n parameters described in Bagwell & Adams, Annals New York Academy of Sciences, 677, p.167, (1993). The compensated values are passed to the sort computer board via the interface between the sort computer board and the fluorescence compensation board. The fluorescence compensation board of the sort computer can perform real-time hardware linear fluorescence compensation between all parameters used in the grid space procedure.

Hardware linear fluorescence compensation may be required for two reasons: (a) fluorescent dyes are known to have broad emission spectrums, and thus spectral overlap into other detectors can often occur, and (b) the use of linear data simplifies the grid space procedure. The fluorescence compensation board may need to be enabled if a given sorting device is unable to perform hardware linear fluorescence compensation itself.

Description of Delta Event Log

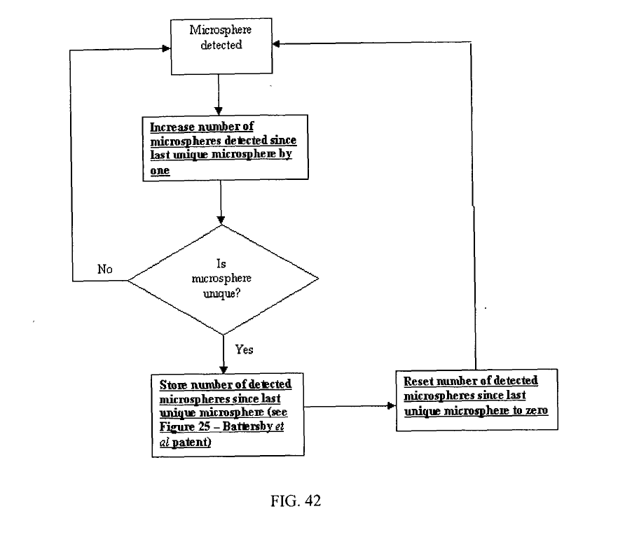

The delta event log records the number of events detected since the last sorted event, known as the delta event number. Initially, the delta event number is equal to zero. Every time an event is detected, the delta event number is incremented by one. When an event is sorted, the current delta event number is stored in the delta event log memory device. The delta event number is then reset to zero. This memory can later be downloaded to the master computer. This information is useful for determining the optical diversity of a given population of beads (FIG. 42).

Computer Memory Requirements

To determine memory requirements, an exemplary library calculation is performed as follows. If there are 10 divisions on 11 parameters, this can encode a 10¹¹ member library. For each bead in the library, there are 11 parameter values measured by the flow cytometer. In a MoFlo, each parameter value is represented by a 12-bit number. In decimal terms, that means it can represent any whole number from 0 to 4095. So, to hold 11 parameter values of 12-bits each for 10¹¹ beads would require 1.32×10¹³ bits of storage space. As there are 8 bits per byte, this equals 1.65×10¹² bytes, or 1.65×10¹²/(1024)3=1500 gigabytes.

However, the sort computer does not need to store all 12-bits of each parameter value. In fact, each unique bead can be completely represented by a single bit, either a 0 or a 1, indicating if it is there or not, that corresponds to one element of a 10×11 matrix. This matrix represents a 10×11 dimensional grid space that covers all of the measurements made during the experiment. Storing the information in this way is what allows the sort computer to make sort decisions for large libraries “on-the-fly,” as each bead is processed independently from the rest by checking the one-bit value of the grid space to see if a bead has already been sorted for that grid space or not. Hence, it only needs 10¹¹ bits, or 1.25×10¹⁰ bytes, which equals 11.6 gigabytes. If these values are stored in a contiguous block of memory on the sort computer, they are already sorted in order, and are easily downloaded or uploaded.

If more than one bead of a particular grid space is desired, the memory requirements will be increased accordingly. In the above example, if 11.6 gigabytes are required when one bit is used per grid space, then (11.6×n) gigabytes would be used when a value of n bits is used per grid space.

Any suitable memory may be used for storage of any electronic information, e.g., data and software. Exemplary forms of memory include diskette-bases, semiconductor, RAM, and ROM (e.g., CD-ROM and DVD-ROM).

Oligomer-Bead Database

In practice, a oligomer-bead database is used in synthesizing a diverse set of oligomers onto beads and is set up before the synthesis begins.

Two conceptual examples of an oligomer-bead database are shown below in Tables 1 and 2. The first database in Table 1 shows the sequences of sixteen different oligonucleotides associated with two different bead parameters that take four different values. In this example, for each step in the synthesis, the two parameters that make up the distinguishable feature of a bead are measured and compared to the database.

TABLE 1
Example of an Oligonucleotide-bead Database

| Pos. | Pos. | Pos. | Pos. | Pos. | Pos. | Pos. | Pos. | Pos. | First | Second |
|---|---|---|---|---|---|---|---|---|---|---|
| 1 | 2 | 3 | 4 | 5 | 6 | 7 | 8 | 9 | parameter | parameter |
| G | G | A | C | C | A | C | T | T | 1 | 1 |
| A | G | A | C | C | T | T | A | G | 2 | 1 |
| C | C | T | C | T | A | A | G | G | 3 | 1 |
| C | T | G | A | C | C | A | G | A | 4 | 1 |
| T | A | C | T | T | C | T | G | A | 1 | 2 |
| A | G | T | A | A | T | A | C | T | 2 | 2 |
| A | C | T | C | A | G | A | A | C | 3 | 2 |
| A | T | A | A | G | G | A | G | A | 4 | 2 |
| T | A | G | A | G | C | T | G | T | 1 | 3 |
| G | A | G | T | G | T | G | T | C | 2 | 3 |
| C | T | G | T | T | A | C | T | C | 3 | 3 |
| T | A | C | A | G | G | T | A | G | 4 | 3 |
| C | T | C | T | C | A | A | G | A | 1 | 4 |
| T | G | T | A | C | T | A | G | T | 2 | 4 |
| A | C | T | C | T | A | T | G | T | 3 | 4 |
| G | T | A | A | G | A | A | C | A | 4 | 4 |

In the second example shown in Table 2, the database consists of twelve oligopeptide sequences and three parameters. The first parameter has three possible values, while the second and third parameter have two possible values. In practice, since most flow cytometers do not have 20 channels that would correspond to the 20 amino acids, it is necessary to perform multiple sorting for each synthesis step.

TABLE 2
Example of an Oligopeptide-bead Database

| Pos. | Pos. | Pos. | Pos. | Pos. | Pos. | Pos. | Pos. | Pos. | First | Second | Third |
|---|---|---|---|---|---|---|---|---|---|---|---|
| 1 | 2 | 3 | 4 | 5 | 6 | 7 | 8 | 9 | parameter | parameter | parameter |
| Gly | Pro | Ala | Cys | Tyr | Ala | Trp | Tyr | Thr | 1 | 1 | 1 |
| Pro | Phe | Gly | His | His | Cys | Gln | Asn | Arg | 2 | 1 | 1 |
| Gln | Gly | Val | Arg | Arg | Lys | Arg | Ser | Trp | 3 | 1 | 1 |
| Ser | Gly | Phe | Met | Ile | Val | Leu | Gly | Asp | 1 | 2 | 1 |
| Tyr | Ala | Cys | Gly | His | His | Val | Arg | Arg | 2 | 2 | 1 |
| Ala | Trp | His | Val | Arg | Arg | Phe | Met | Ile | 3 | 2 | 1 |
| Ser | Trp | Arg | Phe | Met | Ile | Cys | Gly | His | 1 | 1 | 2 |
| Gly | Asp | Met | His | Cys | Gln | His | Val | Arg | 2 | 1 | 2 |
| Arg | Arg | Gln | Arg | Lys | Arg | Arg | Phe | Met | 3 | 1 | 2 |
| Met | Ile | Ser | Gly | Val | Arg | Arg | Asn | Phe | 1 | 2 | 2 |
| Gly | His | Gln | Glu | Phe | Met | Ile | Asp | Gly | 2 | 2 | 2 |
| Met | Arg | Glu | Arg | Gln | Arg | Lys | Arg | Arg | 3 | 2 | 2 |

A feature of a oligomer-bead database is that the elements of the oligomer are ordered. This order corresponds to an order of addition of elements to the oligomer. During a particular round of synthesis, information in the oligomer-bead database is used to generate a Lookup Table. For example, the first oligomer-bead database is organized to direct synthesis of oligonucleotides from left to right. Since solid phase chemical synthesis of oligonucleotides proceeds 3′ to 5′, the order of bases is opposite the conventional order for nucleic acids. During the first round of synthesis, beads are sorted into G, A, T, and C channels according to the following Lookup Table, which derives from the first column of the oligonucleotide database above.

TABLE 3
Example of a Lookup Table

| Sort | First | Second |
|---|---|---|
| direction | parameter | parameter |
| G | 1 | 1 |
| A | 2 | 1 |
| C | 3 | 1 |
| C | 4 | 1 |
| T | 1 | 2 |
| A | 2 | 2 |
| A | 3 | 2 |
| A | 4 | 2 |
| T | 1 | 3 |
| G | 2 | 3 |
| C | 3 | 3 |
| T | 4 | 3 |
| C | 1 | 4 |
| T | 2 | 4 |
| A | 3 | 4 |
| G | 4 | 4 |

The use of a very large oligomer-bead database is described in Example 2 below.

One feature of an oligomer-bead database is that a particular oligomer sequence may be associated with more than one set of bead parameters. However, a particular set of bead parameters may not be associated with more than one oligomer sequence.

Methods of Use

The Sort-Computer is a device that interfaces with a sorting device, for example a flow cytometer. The user inputs into the memory of the computer a sort logic. The sort logic may be a list of compounds to be synthesized, or, correspondingly, a list of reaction sequences that are desired. Alternatively, the sort logic may be specific optical properties of the beads themselves. Based on this user-defined sort logic, the sort computer may be employed in several ways as described below.

There are three exemplary uses for a sort computer in the field of combinatorial chemistry and related fields:

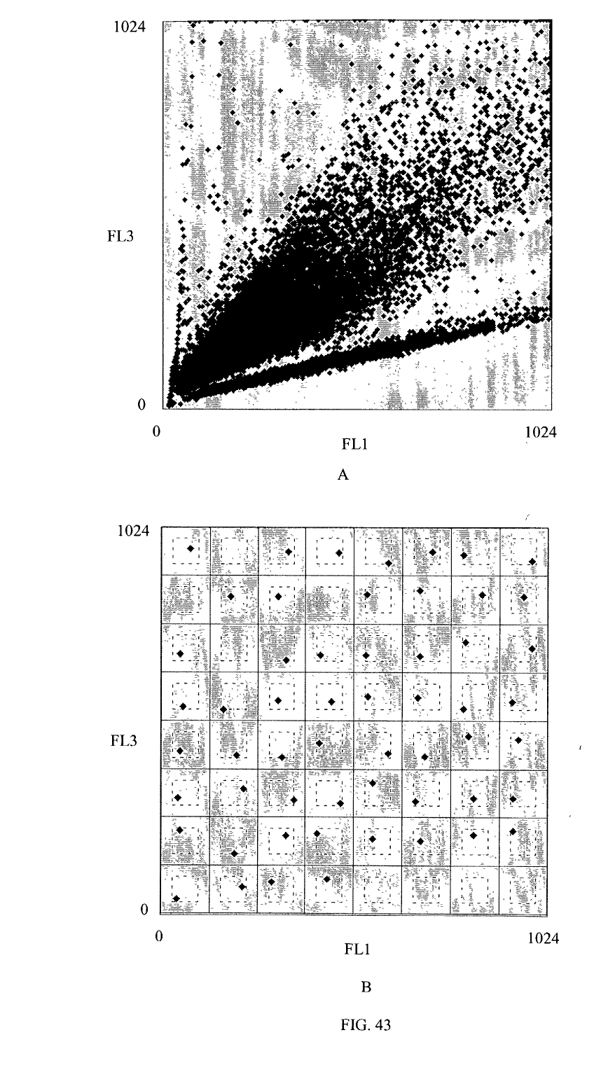

(a) a pre-encoded population of microspheres can be synthesised from an otherwise non-encoded population of microspheres (FIG. 43);

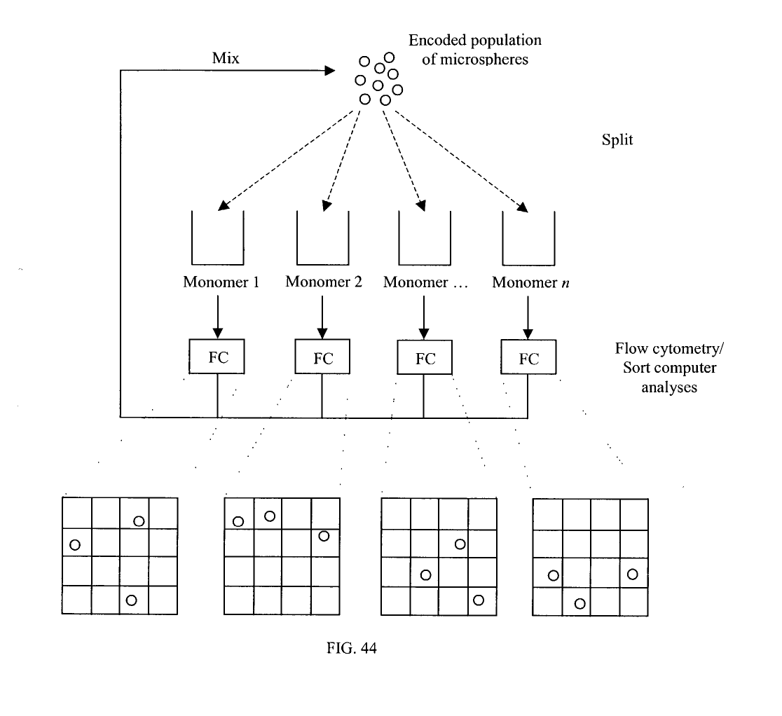

(b) the reaction history of a pre-encoded population of microspheres through a combinatorial synthesis scheme can be recorded (FIG. 44); and

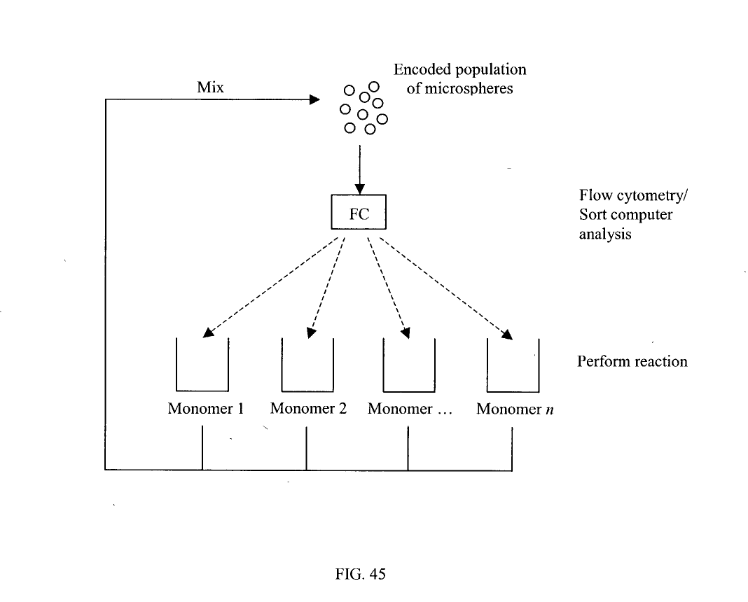

(c) a directed synthesis of a pre-encoded population of microspheres can be performed (FIG. 45).

Another novel feature of the sort computer is that it enables the directed synthesis of large combinatorial libraries by high-throughput flow cytometry.

Bead Manipulations

Formation of a Subpopulation of Beads. The sort computer may be used to isolate a subpopulation of beads from a larger population. Any arbitrary subpopulation of beads may be isolated from a larger population based on the user-defined sort logic. For example, a set of unique beads may be isolated from a larger population that contains many copies of the same bead. Alternatively, a subpopulation of beads with very similar properties, e.g., that vary only in the intensity of one parameter, may be isolated. In addition, a subpopulation of beads having very diverse properties, e.g., each bead is coated with a different fluorophore, may be obtained.

The method is simply based on deciding on a sort logic and encoding this logic in the appropriate grid space memories. Each sort direction has an associated grid space memory. For example, for every bead that is not desired a 1 is placed in its grid space memory, and for every bead that is desired a 0 is placed in its grid space memory. When a bead is detected by a sorting device, if its corresponding grid space memory has a 1, then the bead is discarded. If a desired bead is detected by the sorting device, it is sorted into a collection vessel, and its grid space memory is changed from 0 to 1.

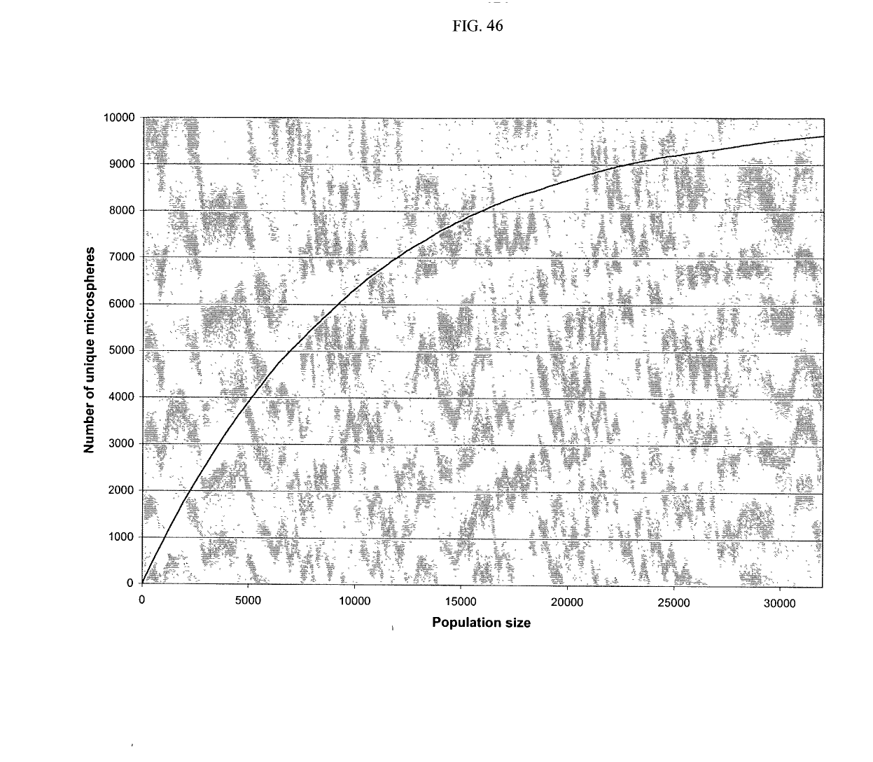

Statistical Analysis of Beads. By recording the number of detected events that occur between every sorted (i.e., unique) event, the sort computer allows for the examination of the diversity of a population of beads, which may be compared to theory. In the exemplary sort computer described above, memory for this function (delta event log) is incorporated in the sort computer board. For example, when encoding a given population of beads, not every bead detected is necessarily unique. Initially, there is a high probability that a given bead will be considered unique, but that probability decreases as the number of sorted beads increases. Hence, when the number of sorted events is plotted against the number of detected events an asymptotic relationship exists, with the asymptote equaling the total number of grid spaces available (FIG. 46). Note that this only applies to the encoding step of the invention. Once the population of beads is encoded, all beads are considered unique, and the relationship would be linear with a slope equal to 1.

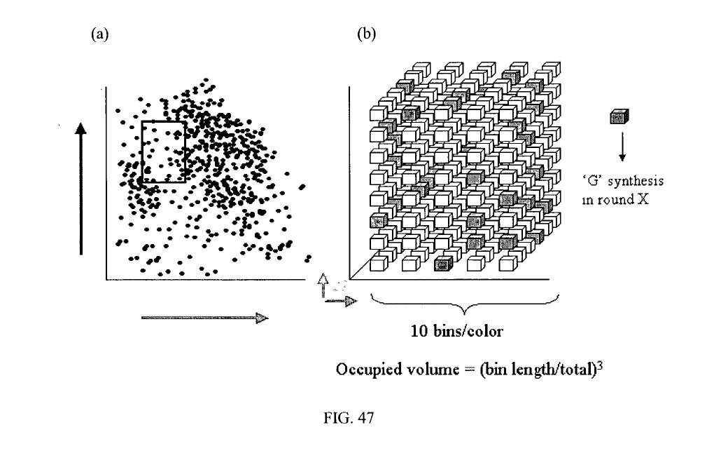

Encoding a population of beads in real-time. Using a grid space procedure as described above, the sort computer can sort an otherwise non-encoded population of beads into an encoded population of beads “on-the-fly”. Each detected bead has a set of n parameter values that can be considered a vector into n-dimensional parameter space. If the parameter space is subdivided into smaller non-overlapping n-dimensional regions (FIG. 47), known as grid spaces, then the non-origin point of a given vector will exist in one, and only one, grid space. The bead corresponding to that vector is said to belong to that grid space. It is possible that more than one bead in a given population will belong to the same grid space. The status of each grid space can be stored in the grid space memory using a single bit per grid space: a logical value of 1 indicates that at least one bead in a given population belongs to the grid space, a logical value of 0 indicates that no beads in a given population belong to the grid space. Hence, a given bead can be represented by the grid space to which it belongs, which in turn can be represented by a specific bit in the grid space memory.

To encode a population of beads, every bit in the grid space memory is initialized to 0 (FIG. 3). As each bead is detected, the bit representing the grid space to which the bead belongs is accessed. If the bit equals zero, then the bead is considered unique and is sorted by the flow cytometer. The bit is then made equal to 1. If the bit was already 1, then a bead has already been sorted with similar optical properties, and hence the duplicate bead is discarded by the flow cytometer. This sort decision occurs in real-time. By only sorting one bead per grid space, the sorted population is thus encoded. Any further flow cytometric analyses can decode a given bead by determining to which grid space it belongs.

Perform hardware linearfluorescence compensation in real-time. Hardware linear fluorescence compensation may be required for two reasons: (a) fluorescent dyes are known to have broad emission spectrums, and thus spectral overlap into other detectors can often occur, and (b) the grid space procedure uses linear data. The fluorescence compensation board may need to be enabled, e.g., if a given flow cytometer is unable to perform hardware linear fluorescence compensation itself.

The fluorescence compensation board of the sort computer can perform real-time hardware linear fluorescence compensation between all parameters used in the grid space procedure. Using an inverted user-defined compensation matrix, the raw parameter values are processed by the fluorescence compensation board following the method described in Bagwell & Adams, Annals New York Academy of Sciences, 677, p.167, (1993). The compensated values are then used in the sort computer board to determine in which grid space a given bead belongs.

Syntheses

New methods are provided for the directed synthesis of encoded libraries of oligonucleotides on beads. These methods allow the synthesis of libraries that are sufficiently large, for example, to permit complex genomic analyses to be carried out. The sort computer described herein can be in random combinatorial synthesis (e.g., split and mix methods) or in directed synthesis, as described below. In random synthesis, beads are randomly grouped and reacted with a monomer. After each round, all of the beads are combined and randomly split into reactions vessels for reaction with another monomer. In this method, after each monomer is added, the beads can be assayed by the sort computer, which records the distinguishing features of each bead on which a particular monomer was added during each round of synthesis. When the synthesis is complete, the record of the distinguishable features enables the identification of the compound on each bead by identifying the distinguishing features of each bead.

In one embodiment, encoded beads are functionalized so that solid-phase oligomer synthesis can be performed on the beads. The oligomers can be any oligomeric molecule amenable to synthesis in stepwise fashion, for example, the oligomers may be oligonucleotides, peptides, saccharides, peptide nucleic acids, or any other oligomeric molecules known in the art. The surface functionality of the beads can be modified to give the desired surface groups, depending on the final use for the beads. For peptide work and for cleavable oligomer linkers, a terminal amine group is preferable; for direct DNA synthesis, terminal hydroxy groups are preferable; and for coupling presynthesized DNA, terminal carboxylic acid groups are preferable. In one example, an amine group may be synthesized on the surface of the beads using 3-isocyanatopropyldimethylchlorosilane. For DNA synthesis, an amine group may be reacted with a 5′-o-(4,4′-dimethoxytrityl) base-3′-o-succinic acid (such as 5′-o-(4,4′-dimethoxytrityl)thymidine-3′-o-succinic acid) that when treated with a base, such as ammonia, is cleaved. Standard automated DNA synthesis can be performed on the bead after this first base has been coupled to it.

In one version of the method, oligonucleotides are synthesized with a cleavable bead-oligomer linker, for example, with a linker of the type that is commonly used in standard silica-based oligonucleotide synthesis. The linker may be cleaved after completion of oligonucleotide synthesis, for example during the deprotection step of oligonucleotide synthesis. In a second version, the linker is not cleaved following synthesis, or a non-cleavable linker is used, so that the oligonucleotide remains covalently attached to the bead.

Since one value of the invention is to be able to synthesize large numbers of oligonucleotides on a large number of beads, each of the separation steps is performed using a method that is capable of quickly separating large numbers of beads. For example, beads can be encoded using fluorescent dyes and then sorted in a multichannel fluorescence-activated cell sorter (FACS) or flow cytometer or any other optically-based sorting machine. Libraries of encoded beads can be constructed, for example, as described in PCT applications WO 99/24458 and WO 00/32542 and U.S. application Ser. No. 10/186,783, filed Jul. 1, 2002.

Chemical reactions which can be performed by direct synthesis or random combinatorial synthesis on these beads include, for example:

1. [2+2] cycloadditions including trapping of butadiene;

2. [2+3] cycloadditions including synthesis of isoxazolines, furans, and modified peptides;

3. acetal formation including immobilization of diols, aldehydes and ketones;

4. aldol condensation including derivatization of aldehydes, and synthesis of propanediols;

5. benzoin condensation including derivatization of aldehydes;

6. cyclocondensations including benzodiazepines and hydantoins, thiazolidines, -turn mimetics, porphyrins, and phthalocyanines;

7. Dieckmann cyclization including cyclization of diesters;

8. Diels-Alder reaction including derivitization of acrylic acid

9. electrophilic addition including addition of alcohols to alkenes;

10. Grignard reaction including derivitization of aldehydes;

11. Heck reaction including synthesis of disubstituted alkenes;

12. Henry reaction including synthesis of nitrile oxides in situ (see [2+3] cycloaddition);

13. catalytic hydrogenation including synthesis of pheromones and peptides (hydrogenation of alkenes);

14. Michael reaction including synthesis of sulfanyl ketones and bicyclo[2.2.2]octanes;

15. Mitsunobu reaction including synthesis of aryl ethers, peptidyl phosphonates, and thioethers;

16. nucleophilic aromatic substitutions including synthesis of quinolones;

17. oxidation including synthesis of aldehydes and ketones;

18. Pausen-Kband cycloaddition including cyclization of norbornadiene with pentynol;

19. photochemical cyclization including synthesis of helicenes;

20. reactions with organo-metallic compounds including derivitization of aldehydes and acyl chlorides;

21. reduction with complex hydrides and Sn compounds including reduction of carbonyl, carboxylic acids, esters, and nitro groups;

22. Soai reaction including reduction of carboxyl groups;

23. Stille reactions including synthesis of biphenyl derivatives;

24. Stork reaction including synthesis of substituted cyclohexanones;

25. reductive amination including synthesis of quinolones;

26. Suzuki reaction including synthesis of phenylacetic acid derivatives;

27. Wittig, Wittig-Horner reaction including reactions of aldehydes, pheromones, and sulfanyl ketones;

28. peptide nucleic acid reactions;

29. oligonucleotide synthesis;

30. peptide synthesis; and

31. peptide and oligonucleotide reactions with synthetic amino acids, nucleic acids, sugars, or peptide nucleic acids.

Reference may also be made to Patel et al., (April 1996, DDT 1(4): 134-144) who describe the manufacture or synthesis of N-substituted glycines, polycarbamates, mercaptoacylprolines, diketopiperazines, HIV protease inhibitors, 1-3 diols, hydroxystilbenes, B-lactams, 1,4-benzodiazepine-2-5-diones, dihydropyridines, and dihydropyrimidines. Reference may also be made to synthesis of polyketides as discussed, for example, in Rohr (1995, Angew. Int. Ed. Engl. 34: 881-884).

Chemical or enzymatic synthesis of the compound libraries of the present invention takes place on beads. Thus, those of skill in the art will appreciate that the materials used to construct the beads are limited primarily by their capacity for derivitization to attach any of a number of chemically reactive groups and compatibility with the chemistry of compound synthesis. Except as otherwise noted, the chemically reactive groups with which such carriers may be derivatized are those commonly used for solid state synthesis of the respective compound and thus will be well known to those skilled in the art. For example, these bead materials may be derivatized to contain functionalities or linkers including —NH₂, —COOH, —OH, —SH, or sulphate groups. Linkers for use with the carriers may be selected from base stable anchor groups as described in Table 2 of Fruchtel, J. S. and Jung, G. (1996, Polymer supported organic synthesis: a review. Combinatorial Peptide and Nonpeptide Libraries, 19-78) or acid stable anchor groups as described in Table 3 of Fruchtel et al. Suitable linkers are also described in International Publication WO93/06121 and U.S. application Ser. No. 10/186,783.

Generally the anchors developed for peptide chemistry are stable to either bases or weak acids but for the most part, they are suitable only for the immobilization of carboxylic acids. However, for the reversible attachment of special functional groups, known anchors have to be derivatized and optimized or, when necessary, completely new anchors must be developed. For example, an anchor group for immobilization of alcohols is (6 hydroxymethyl)-3,4 dihydro-2H-pyran, whereby the sodium salt is covalently bonded to chloromethylated Merrifield™ resin by a nucleophilic substitution reaction. The alcohol is coupled to the support by electrophilic addition in the presence of pyridinium toluene-4 sulphonate (PPTS) in dichloromethane. The resulting tetrahydropyranyl ether is stable to base but can be cleaved with 95% trifluoroacetic acid.

Benzyl halides may be coupled to a photolabile sulfanyl-substituted phenyl ketone anchor.

Directed Synthesis

Unlike traditional random split and mix methods of synthesis, the directed synthesis approach results in a combinatorial library that contains only the desired combination of monomers. In this method, each bead in the encoded population (at least one bead per desired compound) is represented by a grid space in the grid space memory array of the sort computer. In addition, each sort direction on the sorting device has its own grid space memory array in the sort computer, which is used for generating a separate encoded population for each monomer used for each round of synthesis.

Prior to synthesis, a list of a desired set or library of oligomers is generated. A collection of encoded beads is designated to have a particular oligomer synthesized upon its surface. The library can be designed such that each oligomer is present on one or more beads, but each bead contains oligomers having a single sequence. For each round of monomer addition, a particular bead is directed down a path in a sorting device based on the list of desired oligomers. For example, for nucleotide synthesis, the beads are divided according to the identity of each bead into four groups, corresponding to G, A, T, and C, depending on the first base of the oligonucleotide to be made on each bead. The beads are then subjected to a synthesis step where a nucleotide is added, after which the beads are pooled, then again separated according to the identity of each bead into four groups, G, A, T, and C, corresponding to the second base to be added, and so on. In this way, a bead-oligonucleotide library is constructed wherein the exact composition of the library is designed rather than random. In this application, the sort computer thus allows a precise chemical library to be “written” onto the beads. Similar strategies are employed for peptides and other oligomers.

Ideally, the sorting device has as many possible paths as there are monomers in a given round of synthesis, but this arrangement is not necessary. For instance, for peptide synthesis involving sixteen different amino acids, a sorting device with four sort directions can be used to first separate a population of beads into four groups, with beads in each group having one of four possible amino acids in the first position. Each individual group is then passed through the sorting device and subdivided into four more groups, with beads in each group having the same amino acid in the first position. For peptide synthesis involving twenty or more different amino acids, a third sorting step is required, following the same general logic as the method described above.

The general method of directed synthesis may be summarized as follows. A two-column list comprising the compounds/reaction sequences and the beads is generated, either by the user or by the sort computer. Methods for creating such lists are known in the art of computer science. The beads are then fed into a sorting device for a first cycle. As each bead is read by the device, the distinguishing characteristics of the bead are communicated to the sort computer. The sort computer then identifies the bead on the two-column list, finds the associated reaction sequence, and communicates to the sorting device to sort the bead into a bin of beads that will all undergo a particular first reaction. The beads are then fed into the sorting device again, and the process is repeated until the reactions are complete.

By uploading pre-determined grid space memory arrays into the sort computer, it is possible to determine which direction a given bead is sorted. In these uploaded grid space memory arrays (unlike normal encoding in which every grid space is initialized to zero), every grid space is initialized to one except for those grid spaces that correspond to beads that are to be sorted in that sort direction. Thus, when a given bead is detected, its corresponding grid space will be checked until a zero is found in the sort direction that was pre-determined for that bead. The sort directions represent an individual monomer that is to be added to a bead. In general, the beads must be passed through the sorting device once for every monomer (or unique reaction) that is to be incorporated onto the bead. The operations of the sort computer are further exemplified in FIGS. 7, 8, 14, 41, 42, 44, 45, 48, and 49.

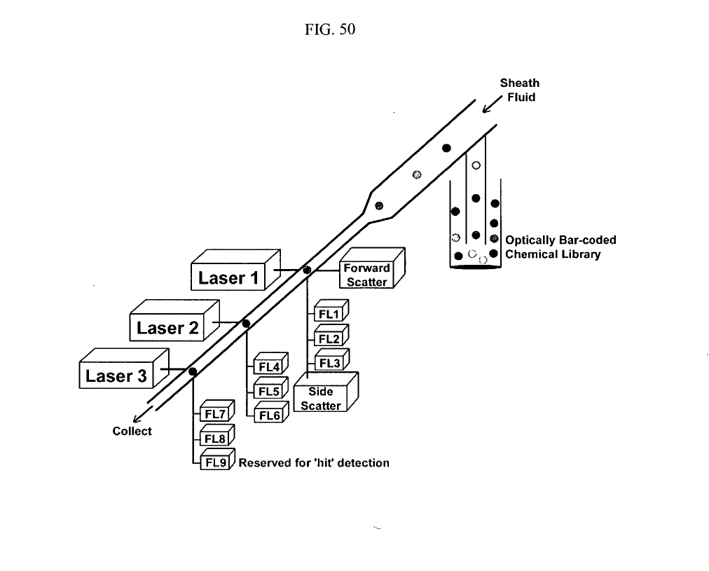

Assaying of the library is performed in the conventional manner with the ‘hits’ detected by the sorting device (FIG. 50). The structure of each ‘hit’ compound is identified by analyzing the optical signature of the particles on which the ‘hit’ resides. This analysis is done automatically using the data that is stored by the sort-computer during the oligomer synthesis.

One of the major advantages of directed combinatorial synthesis (FIG. 6) using a sort computer is the reduced number of analyses compared with random combinatorial synthesis (FIG. 5). For example, with the normal split-and-mix synthesis, the total number of sortings is the number of cycles multiplied by the number of monomers plus one (the pre-encoding step) plus one (hit detection), e.g., for a 15-mer oligonucleotide it would be 15×4+1+1=62 analyses. For directed synthesis, the sorting step is the splitting step, and hence there are only the number of monomers plus two analyses required, e.g., for a 15-mer oligonucleotide it would be 15+1+1=17 analyses.

Types of compounds that may be synthesized by the directed synthesis method include deoxyribonucleotides, ribonucleotides, peptides, sugars, peptide nucleic acids, and organic molecules.

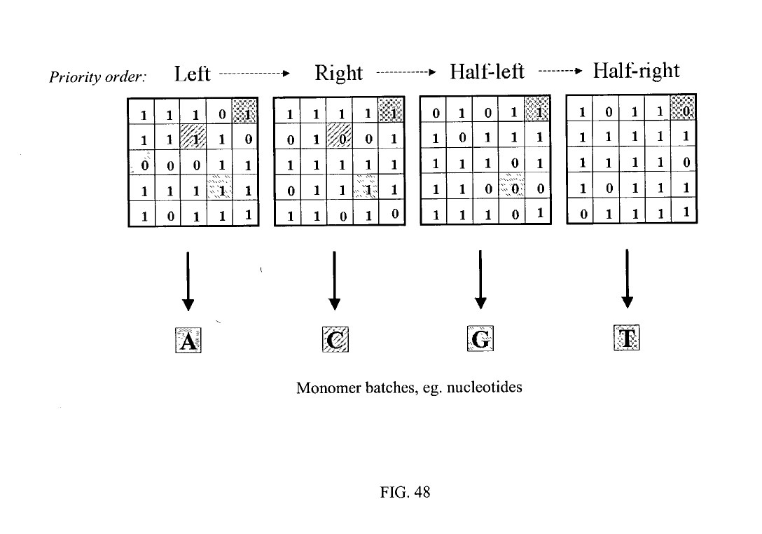

Enabling of directed synthesis in real-time. Using the exemplary sort computer described above, it is possible to enable directed synthesis for flow cytometers that possess more than one sort direction. The sort directions are placed in a priority order by the sort computer board, e.g., left, right, half-left, half-right. A separate grid space memory device is required for each sort direction. For a given grid space memory associated with a given sort direction, all of the bits in that grid space memory are initialized to 1 except for those grid spaces that are associated with beads that are to be sorted in that given sort direction, which are instead initialized to 0 (FIG. 48). These grid space memories are then uploaded to the sort computer board through the enhanced parallel port (EPP) connection from the master computer.

When a bead is detected, the normal grid space procedure is applied to the highest priority sort direction. If the bit representing the grid space to which the bead belongs equals 0, the bead is sorted in the highest priority sort direction. However, if the bit equals 1, the above process is repeated using the grid space memory associated with the next highest priority sort direction. In this manner, every bead in a given population can be sorted in real-time to a pre-determined sort direction. Thus, the sort computer allows the directed synthesis of a large encoded population of beads in real-time using high-throughput flow cytometry.

Hairpin Nucleic Acid Synthesis. Single stranded linear oligonucleotide probes are commonly used in hybridization reactions. However, it has been shown that a hairpin (HP) capture probe, which contains a duplex region adjacent to a single stranded target capture region, hybridizes to its target with a thermodynamic advantage over a similar linear probe. This target capturing advantage of the hairpin system can be attributed, at least in part, to the stacking interaction between the 5′ terminal base of the hairpin probe and the 3′ terminal base of the single-stranded target. Studies have shown that the duplex region of a partly double-stranded DNA capture molecule can enhance its target capture ability (Lane M J, Paner T, Kashin I, Faldasz B D, Li B, Gallo F J, Benight A S, Nucleic Acids Res Feb. 1, 1997; 25(3):611-617.). Hairpin capture probes have been developed, and their potential utility in various nucleic acid detection assays has been demonstrated (see, e.g., U.S. Pat. No. 5,770,365). For example, HP probes exhibit significantly higher rates of target capture relative to linear capture probes (up to 4×better performance). In addition, HP probes are capable of capturing greater quantities (up to 4×more) across a large target concentration range and perform significantly better at low target concentrations relative to linear probes. These properties result in greater assay sensitivity. Hence, HP probes may significantly enhance the performance of nucleic acid assays, such as high throughput diagnostics, single nucleotide polymorphism (SNP) detection, and microarray based gene expression profiling, where the current challenge is to develop more rapid and sensitive detection methods [Riccelli P V, Merante F, Leung K T, Bortolin S, Zastawny R L, Janeczko R, and Albert S. Benight, Nucleic Acids Research Feb. 15, 2001; 29(4): 996-1004].

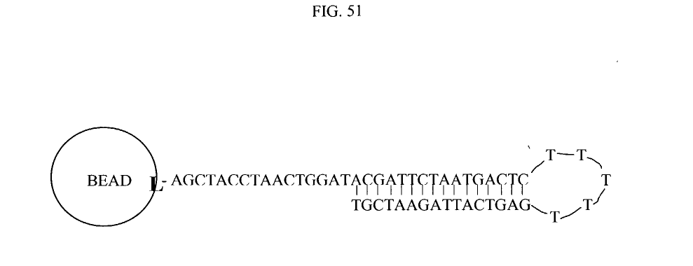

The subject of the present invention is the synthesis of a directed combinatorial library on encoded beads where on the end of each sequence a spacer group is synthesized, for example, a penta-thymidine sequence. This spacer group forms a hairpin when a sequence, complementary to the last X bases (where X=10-30 bases) of the oligonucleotide sequence already on the bead, is synthesized, as shown in FIG. 51.

Non-combinatorial Libraries. Pre-existing libraries of small molecules can be covalently linked to subpopulations of encoded beads to establish non-combinatorial encoded libraries. These libraries can then be screened against other large libraries or against selected targets.

An optically diverse set of beads is prepared according to methods described in the art. The beads have an appropriate linker group and/or functionality to permit covalent or physical binding of a full length (pre-synthesized, or preexisting) compound, such as a cDNA, or oligonucleotide. The sorting device, e.g., a flow cytometer, either in conjunction with the sort computer or not, sorts an optically diverse set of beads into subpopulations based on their similar optical signature (rather than their unique optical signature). The beads in each subpopulation have similar optical signatures within a chosen optical range, this range being different from any other range or fluorescence intensity.

Peptide synthesis and small-molecule synthesis. The invention can also be used to synthesize, for example, peptide libraries. The invention is particularly useful when it is desirable to synthesize a library where amino acids at two or more positions can have only certain side chains, such that the side chains are correlated to allow correct folding of a peptide. For example, it may be useful to construct a library in which, if an amino acid at a given position is a cysteine, the amino acid at a particular second position is always preferred to be a cysteine, and if the amino acid at the given position is not a cysteine, the amino acid at the second position should never be a cysteine. In this way, the peptides can be designed in such a way that they contain or lack a disulfide bond, but never contain an unpaired cysteine that could oxidize.

It is also useful to construct combinatorial chemistry libraries using the invention. Random combinatorial chemistry libraries generated by split-and-pool synthesis are often large in size. In some cases, for example, certain monomers are incompatible with certain other monomers (e.g., amino groups and activated esters), such that the resulting compounds are chemically unstable or have some other undesired feature. The method of the invention allows the synthesis of combinatorial chemistry libraries on beads in which the library does not contain undesired combinations of monomers.

It is also sometimes useful to create a relatively small library that samples a large area of chemical space. The invention allows the directed synthesis of a subset of all the compounds that would be created by a standard split-and-pool synthesis, such that diversity can be maintained.

Assays

Compounds prepared with by the methods of the present invention may be screened for an activity of interest. Such screening may be effected by flow cytometry as described by Needels et al. (1993, Proc. Natl. Acad. Sci. USA 90: 10700-10704) and WO 97/15390.

Compounds that may be screened include agonists and antagonists for cell membrane receptors, toxins, venoms, viral epitopes, hormones, sugars, cofactors, peptides, enzyme substrates, drugs inclusive of opiates and steroids, oligonucleotides, cDNA, RNA, proteins including antibodies, monoclonal antibodies, antisera reactive with specific antigenic determinants, nucleic acids, lectins, polysaccharides, cellular membranes and organelles.

Sequence by Hybridization. The present invention also provides methods that employ a plurality of unique polynucleotide or oligonucleotide sequences for sequence by hybridization (SBH) or gene expression analyses.

SBH uses a set of short oligonucleotide probes of defined sequence to search for complementary sequences on a longer target strand of DNA. The hybridization pattern is used to reconstruct the target DNA sequence. Accordingly, in the context of the present invention, an aqueous solution of fluorescently labeled single stranded DNA (ssDNA) of unknown sequence may be passed over the library of polynucleotide or oligonucleotide compounds and adsorption (hybridization) of the ssDNA will occur only on beads which contain polynucleotide or oligonucleotide sequences complementary to those on the ssDNA. These beads may be identified by their distinguishable features, which are indicative a nucleotide sequence bound to the beads. Beads may be detected by flow cytometry, fluorescence optical microscopy, or any other suitable technique.

Once a compound having the desired activity is obtained, the sequence of reaction steps experienced by the bead on which the compound was synthesized may be deconvoluted simply by analyzing the tracking data for that bead which was stored by the sort computer during combinatorial synthesis. The sequence of synthons defining the compound of interest may thus be ascertained and a molecule comprising this sequence can by synthesized by conventional means (e.g., amino acid synthesis, peptide nucleic acid synthesis, or oligonucleotide synthesis) as is known in the art.

Gene Expression/Comparative Gene Expression Profiling. With the completion of The Human Genome Project, attention is now firmly focused on developing ways to use the valuable information obtained. Individual genetic variation and gene expression are just two important types of information that can be exploited to identify new drug targets. By comparing the ways in which genes are expressed in a normal and diseased organ, the genes, and hence the associated proteins that are part of the disease process, can be identified. This information can then be used to synthesize drugs that interact with those proteins, thus reducing the effect of the disease on the body.

One of the key components of future genomic research will be the study of drug or environment induced changes in gene expression indicative of disease and/or pharmacological or environmental exposure. Whether a particular cell or tissue type is healthy or diseased can depend on which genes are being expressed and at what levels. Thus by comparative gene expression studies one may be able to determine an altered expression pattern that is indicative of disease or toxic shock. This approach will also allow investigators to determine the effect of therapeutics on gene expression and to discover which genes underlie a given pharmacological or physiological state.

Mapping ofsingle nucleotide polymorphisms using directed synthesis oligonucleotide-bead libraries. The invention further features methods of mapping single-nucleotide polymorphisms. In this case, for example, the sequences of human SNPs are obtained from a public resource such as the SNP Consortium. A list of SNPs whose analysis is desired is generated. It is estimated that there are between 100,000 and 1,000,000 SNPs in the human genome, and it is straightforward to generate a library of beads of this size using the methods described in WO 00/32542 and U.S. application Ser. No. 10/186,783.

A particular method for constructing a library is described here by way of illustration, although it will be clear to those skilled in the art of nucleic acid hybridization that several variant methods are possible. Oligonucleotides capable of hybridizing to allelic SNP regions are synthesized on beads. The oligonucleotides are about 25 bases long. For each SNP allele, about 10 to 20 different oligonucleotides are synthesized, consisting of distinct, overlapping DNA segments corresponding to the region including the SNP and adjacent sequences. Thus, depending on how many SNPs are to be scored, the entire bead library will have 1 to 20 million unique members. Depending on the purpose, it is generally useful to have duplicates of a given oligonucleotide present in a hybridization experiment.

Before performing the hybridization with genomic DNA, it is often useful to sort the beads by a sorting device, e.g., a FACS, coupled to a sort computer into several classes corresponding to the predicted melting temperature of the perfectly base-paired oligo. Separate hybridization reactions are then performed at temperatures correlated with the predicted melting temperatures of each class of bead-oligonucleotide.

Human genomic DNA is harvested, purified, and labeled according to standard techniques. For example, DNA is nick-translated with fluorescently labeled precursors, such that the products are about a hundred to a few hundred bases. The reaction product is denatured and then hybridized to the beads.

As described above for mRNA expression profiling, the fluorescent label on the nucleic acid sample is different from the labels used to encode the beads, and all of the labels can be independently scored by flow cytometry.

SNP Analysis. Analysis for known single nucleotide polymorphisms (SNPs) can be readily accomplished by the preparation of directed libraries of a combination of oligonucleotides that uniquely code for each SNP through overlapping hybridization. Given the massive directed libraries that can be synthesized using the technology, simultaneous detection of many thousands of SNPs could be readily accomplished. Further, the detection of the SNPs by this method would be sufficiently fast and inexpensive to allow routine diagnostic application of multiple SNP analysis at the hospital or clinic level.

SNP/Mutation Identification. It is estimated that the human genome contains between 100,000 and 1,000,000 SNPs, which are single nucleotide mutations that occur in at least 1% of the human population. These SNPs are expected to be important in genetic mapping studies of human disease genes and pharmacogenomic screening. Some SNPs produce a change in a gene or gene product in a manner which results in a functional consequence. For example, such consequences include genetic diseases such as cystic fibrosis and sickle cell anemia. Accurate identification of SNPs is expected to require hybridization with 10 to 30 test oligonucleotides each, such that 1 to 30 million hybridizations will be required to determine the SNPs in a human genome. This large number of hybridizations is beyond the capability of current two-dimensional array technology, but well within the capacity of the present invention. The speed of currently available off-the-shelf flow cytometers would allow 30 million bead-based hybridization tests to be scored in about 20 minutes thus making this application feasible for widespread clinical and diagnostic use.

Comparative SNP Analysis. By the use of massive libraries containing up to all possible oligonucleotides of an optimized number of bases to analyze pooled samples of patient DNA and pooled samples of control DNA, the whole family of SNPs or gene mutations associated with the disease state of the pooled patient DNA should be readily identified. This approach is beyond the capabilities of current methods.

Pharmacogenomics/Clinical Trials. Using the same approach as with comparative SNP analysis, the technology could provide the first opportunity to follow genetic markers prior to, during, and/or subsequent to clinical trials. This ability could significantly enhance the possibilities of new drug approvals as each year dozens of promising drugs fail to make it to market because they cause serious side effects in a very small number of test patients. By analyzing the DNA of each potential or actual participant in the trial, one may identify genetic markers which are unique to, and therefore predictive of, adverse reactions to the drugs being assayed. Such a method could thus be used to prescreen for patient selection in the trials or to identify those patients who should not be treated with an approved drug. This approach constitutes a major breakthrough in pharmacogenomics, the practice of identifying and studying genes that affect individual responses to drugs, that is simply not attainable with today's technology and could be used by clinical trial sponsors, either voluntarily or as required by regulatory authorities, and treating physicians.

Pathogen diagnosis with SNP/Mutation identification. Another clinical application is the diagnosis of pathogens by DNA hybridization. Using the directed synthesis technology, kits could be created that can simultaneously diagnose hundreds of different viral, bacterial, and parasitic pathogens in clinical samples, and also indicate the presence of drug-resistance genes and mutations in the pathogen genomes.

It is readily apparent to those skilled in the art of molecular biology that many variations of these biochemical procedures are possible. Targeted drug delivery systems, in situ diagnostics, rapid pathogen/toxin identification (biological warfare) and cell-based assays are but a few examples of this potential.

Other Applications

Other applications exist where a sort computer may be modified such that it can sort beads or cells in a high throughput way based on color (e.g., beads encoded with chromophores) or fluorescence spectrum (i.e., beads which give a convoluted fluorescence spectrum will give a certain optical fingerprint which may be sorted by a modified sort computer). The sort computer may be modified to sort based on other electromagnetic attributes wherein the electromagnetic radiation-related attribute is selected from the group for example consisting of fluorescence emission, luminescence, phosphorescence, infrared radiation, electromagnetic scattering including light and X-ray scattering, light transmittance, light absorbance, surface plasmon resonance and electrical impedance.

Beads

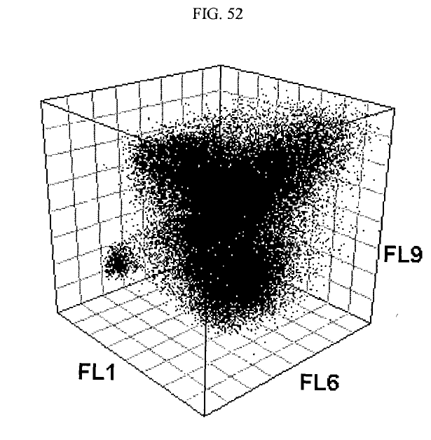

Beads suitable for use in the methods described herein are designed to resist the solvents and reagents used in solid phase organic synthesis (e.g., dimethylformamide, dichloromethane, and diisopropylethylamine) and assays and are derivatized with appropriate functional groups to permit on-bead synthesis. A wide variety of fluorescent dyes can be covalently bound into these beads. By careful selection of dye excitation and emission properties, as well as dye concentration, an optically diverse (optodiverse) population of particles can be produced (FIG. 52). This optical diversity can be exploited as a way of encoding millions of solid support beads onto which biologically interesting molecules (e.g., DNA, polypeptides, proteins, and polysaccharides) can be chemically attached. By measuring the types and intensities of dyes in the final bead, e.g., using a high performance flow cytometer (FIG. 50), one can uniquely identify a massive number of beads used to encode a library.

Synthesizing various fluorescent silica shells in a random order and with varying intensities around core particles gives the resulting multi-shell carrier beads a high degree of optical diversity. The synthesis of such beads is described in WO 00/32542. U.S. application Ser. No. 10/186,783 describes a new class of nanoarchitectured ceramic beads for use as solid support beads in high-throughput screening (HTS). These beads have a smooth external surface, with a controlled, porous internal structure. The beads are highly functionalized and organic linkers can be coupled onto the particles, thereby making the beads suitable for solid phase synthesis of chemical libraries. Other beads are known in the art.

The present inventors have found that the larger the diversity of detectable and/or quantifiable attributes of a bead, the greater the degree of decipherability or resolution of the bead in a large population of beads. In this regard, each detectable and/or quantifiable attribute of a bead provides at least a part of the information required to distinctively identify the bead. The larger the number of such attributes, the more detailed the identifying information that is compilable for a given bead, which may be used to distinguish that bead from others.

In general, any bead that is detectable and capable of withstanding the conditions under which an oligomer is coupled to its surface is suitable for use in the methods described herein. Distinguishable features that may be present on a bead include fluorescence emission, fluorescence intensity, size, refractive index profile, color, luminescence, phosphorescence, infrared radiation, light scatter, x-ray scatter, light absorbance, surface plasmon resonance, and electrical impedance. These attributes can be detected by an instrument such as a high-performance flow cytometer (HPFC) at an extremely high rate (up to 100,000 particles s⁻¹).

Beads may include any solid material capable of providing a base for combinatorial synthesis. For example, the carriers may be polymeric supports such as polymeric beads, which are preferably formed from polystyrene cross-linked with 1-5% divinylbenzene. Polymeric beads may also be formed from hexamethylenediamine-polyacryl resins and related polymers, poly[N-{2-(4-hydroxylphenyl)ethyl }] acrylamide (i.e., (one Q)), silica, cellulose beads, polystyrene (PS) beads, poly(halomethylstyrene) beads, poly(halostyrene) beads, poly(acetoxystyrene) beads, latex beads, grafted copolymer beads such as polyethylene glycol/polystyrene, porous silicates for example controlled pore-glass beads, polyacrylamide beads for example poly(acryloylsarcosine methyl ester) beads, dimethylacrylamide beads optionally cross-linked with N,N′-bis-acrylolyl ethylene diamine, glass particles coated with a hydrophobic polymer inclusive of cross-linked polystyrene or a fluorinated ethylene polymer which provides a material having a rigid or semi-rigid surface, poly(N-acryloylpyrrolidine) resins, Wang™ (p-Benzyloxybenzyl Alcohol) resins, PAM (4-hydroxymethylphenylacetomidomethyl) resins, Merrifield™ (chloromethylpolystyrene-divinylbenzene) resins, PAP (polyethyleneglycol is attached to the polystyrene backbone via a benzyl ether linkage) and SPARE polyamide resins, polyethylene functionalized with acrylic acid, kieselguhr/polyamide (Pepsyn K), polyHipe™ (Polymerized High Internal Phase Emulsions), polystyrene/polydimethylacrylamide copolymers, controlled pore glass, polystyrene macrobeads and Tentagel™ (polyethyleneglycol/polystyrene), and polyethyleneglycol-polystyrene/divinylbenzene copolymers.

It will also be appreciated that the polymeric beads may be replaced by other suitable supports such as pins or chips as is known in the art, e.g. as discussed in Gordon et al. (1994, J. Med. Chem. 37(10):1385-1401). The beads may also include pellets, discs, capillaries, hollow fibers, or needles as is known in the art. Reference also may be made to International Publication WO93/06121, which describes a broad range of supports that may constitute beads for use in the methods of the present invention. By way of example, these beads may be formed from appropriate materials inclusive of latex, glass, gold or other colloidal metal particles and the like. Reference may also be made to International Publications WO95/25737 and WO97/15390, which disclose examples of suitable beads.

Suitable tags, such as fluorescent dyes include fluorescein and its derivatives, rhodamine and its derivatives, dansyl, aminocoumarines umbelliferone, ALEXFLUOR® (from Molecular Probes Inc.), IC664, and BODIPY® (from Molecular Probes Inc.). Additional dyes are known in the art. Exemplary fluorescent dyes for encoding beads are succinimidyl ester and isothiocyanate functionalized dyes, such as fluorescein isothiocyanate, Alexafluor 350 succinimidyl ester, Oregon Green (from Molecular Probes Inc.), BODIPY 530 SE, BODIPY 581, BODIPY TR-X, Texas Red (from Molecular Probes Inc.), TAMRA, BODIPY 630 succinimidyl ester, BODIPY 650 succinimidyl ester, and Rhodamine B isothiocyanate, but any fluorescent dye that can react with a functional group present on a bead, e.g., thiol, amine, or activated ester, could be employed. When tagged oligomers will also be used, e.g., in a hybridization assay, the tag on the oligomer may limit the dyes used to label the beads. For example, when Cy3 is used to tag an oligomer, Rhodamine B is not used to label the beads, and when Cy5 is used to tag an oligomer, BODIPY 650 is not used to label the beads.

The beads and their encoding molecules (such as fluorescent dyes) are typically highly resistant to the harsh chemical conditions of combinatorial synthesis, obviating the primary limitation of previous bead-based combinatorial approaches to high throughput drug discovery. The beads preferably contain fluorescent dyes which undergo little or no photobleaching. Such dyes are known in the art. The beads desirably undergo little or no swelling so their optical signature can be reproducible in the sort computer and/or sorting device. Typically, in combinatorial synthesis, particle swelling desirably increases particle surface area. Particle swelling may alter the distinguishable features of a bead (e.g., by leaching a dye out of a bead) and may degrade the encoded information.

The following examples are merely intended to illustrate various aspects of the invention and are not intended to be limiting in any way.

### EXAMPLE 1

### Implementation of a Sort Computer on a Flow Cytometer

The following instructions use a Cytomation MoFlo Build 839 and Summit 3.1 (DakoCytomation, Fort Collins, Colo. 80525, USA):

Hardware:

1. Power off the MoFlo electronic rack.

2. Remove all LUT boards except for the first one. The order of the boards can be determined by reading the jumper switch at the base of each board. Sorting cannot occur unless at least one LUT board is present.

3. Connect the sort computer board to the event bus of the MoFlo electronic rack.

4. Connect the fluorescence compensation board to the event bus of the MoFlo electronic rack.

5. Connect the fluorescence compensation board to the sort computer board.

6. Connect the serial port on the sort computer board to the serial port on the master computer.

7. Connect the parallel port on the sort computer board to the parallel port on the master computer.

8. Connect the sort computer board to the external power supply.

9. Connect the fluorescence compensation board to the external power supply.

10. Power on the master computer and run customized software.

11. Power on the MoFlo electronic rack.

12. Power on the external power supply.

Software:

1. Run Summit 3.1.

2. Make sure there are no sort regions already defined.

3. Create five histograms using five different parameters. It is unimportant which parameters are chosen.

4. On the first histogram, define a sort region, R1, which spans the entire range of the parameter.

5. On the second histogram, define a sort region, R2, which spans the entire range of the parameter.

6. On the third histogram, define a sort region, R3, which spans the entire range of the parameter.

7. On the fourth histogram, define a sort region, R4, which spans the entire range of the parameter.

8. On the fifth histogram, define four non-overlapping sort regions, R5 to R8.

9. Make sure there are four sort directions available.

10. In the sort logic, define Left as: R1 and R2 and R3 and R4 and not R5.

11. In the sort logic, define Right as: R1 and R2 and R3 and R4 and not R6.

12. In the sort logic, define Half-Left as: R1 and R2 and R3 and R4 and not R7.

13. In the sort logic, define Half-Right as: R1 and R2 and R3 and R4 and not R8.

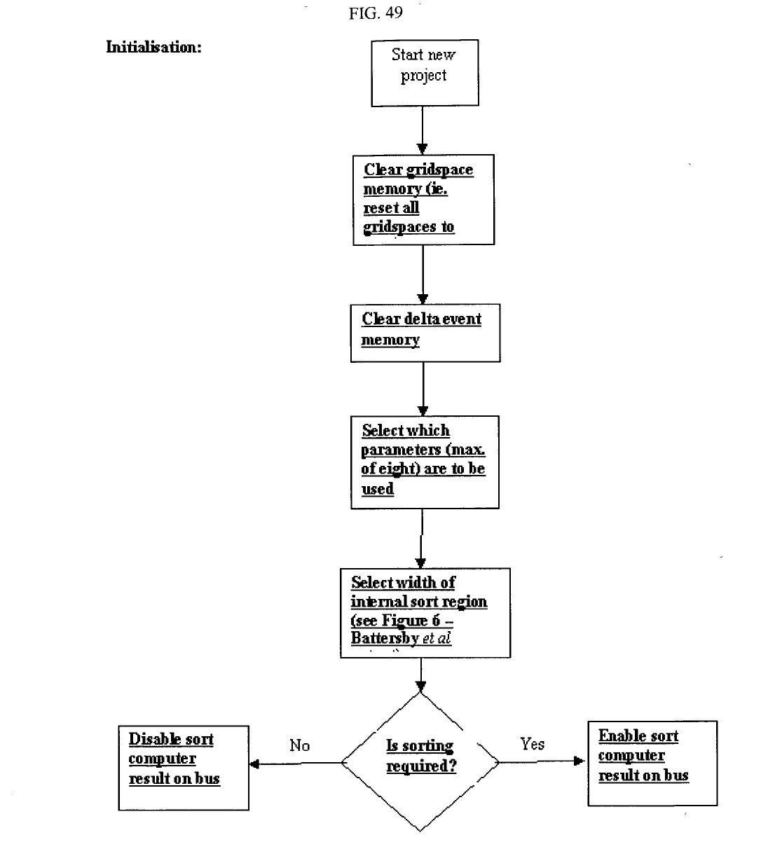

14. Select appropriate settings using customized software (FIG. 49).

15. On the customized software on the master computer, select the option that places results of sort computer onto the event bus in LUT A, bits 4-7. Note:

bits 0-3 of LUT A are provided by the remaining LUT board. Bits 8-11 on LUT A, and bits 0-11 on LUT B are all equal to 1 by default, as their corresponding LUT boards have been removed. By using the sort logic above, bits 0-3 will always equal 1 for every event.

The sort computer is now set up and ready to operate.

### EXAMPLE 2

### Directed Synthesis of Oligonucleotides for Synthesis of Hybridization Probes from a Genome.

This example illustrates how the invention can be used to synthesize a large family of oligonucleotides. For the purpose of this Example, the goal is to synthesize oligonucleotides corresponding to the 5′ and 3′ ends of all of the genes in Saccharomyces cerevisiae. As there are about 6,000 genes, about 12,000 oligonucleotides need to be synthesized. These oligonucleotides can then be used as primers in PCR to amplify all the coding sequences in yeast as in Hudson J R Jr, et al. (Genome Res. [1997] 7:1169-73). For the purposes of this example, essentially the same oligonucleotides described by Hudson et al. are synthesized, to illustrate the advantages of the compositions and methods of the invention. The only difference is that the oligonucleotides of Hudson have a variable length, while the oligonucleotides synthesized here will have a constant length, with 23 bases corresponding to the 5′ and 3′ ends of yeast genes.

The steps in this example include: 1) synthesis of a bead library; 2) construction of an encoded population of beads using the grid space procedure; 3) construction of a database associating grid spaces with oligonucleotide sequences; 4) synthesis of diverse oligonucleotides on beads to construct a bead-oligonucleotide library; and 5) sorting the desired oligonucleotide-bead conjugates from the remainder of the bead-oligonucleotide library, and 6) cleaving the desired oligonucleotides from the beads and using the oligomers for a desired purpose.

Encoded beads are first synthesized by one of the methods described herein. Desirable beads have about 16 micromoles/gram of reactive binding sites that can be used for labeling the beads, for example with fluorescent dyes, and as attachment sites for oligonucleotide synthesis. Beads of 100 micron diameter are used, for example. The beads have a weight of about 10⁻⁶ grams and thus about 10¹³ reactive sites per bead.

In the first step, the beads are fluorescently labeled according to the method of U.S. application Ser. No. 10/186,783 to generate a library of about 10⁵ to 10⁶ beads, which will have a total volume of about 1/10 to 1 milliliter. About 10⁶ beads are preferably used. An encoding strategy is used that involves five fluorescent dyes that can be distinguished by a high-end FACS machine such as the MoFlo machine of Cytomation. Eight different intensity levels will be distinguished, so this labeling scheme is capable of differently marking 65,536 beads. When constructing these beads, it is preferable to use less than 10% of the reactive sites on the beads for the labeling, so that most of the sites can be used for oligonucleotide synthesis. The following five dyes are preferably used: Alexafluor 350 succinimidyl ester, Oregon Green (from Molecular Probes Inc.), BODIPY 581, Texas Red (from Molecular Probes Inc.), BODIPY 630 succinimidyl ester.

The beads are labeled such that most of the beads contain between 0 and 10¹¹ molecules of a given dye, with about 10% of the beads having 0 to 10¹⁰ of a given dye molecule, 10% having 10¹⁰ to 2×10¹⁰ of a given dye molecule, and so on. It is important to keep the amounts of each dye per bead about the same, when labeling the beads. This is because the beads will ultimately be scored by flow cytometry, and it is desirable that the signal from one dye not be masked by the tail of the signal from another dye that might be present in much greater amounts. For this reason, it is also preferable to have a linear, rather than logarithmic, distribution of dye concentrations. The absolute number of dye molecules per bead is less important. For example, a starting population of beads with 0 to 10⁹ or 0 to 10⁸ dye molecules could be used.

Each bead is considered to occupy a position in a parameter space, which in this Example is five-dimensional, based on the amount of each of the five dyes in the bead. As a first step, the bead library is sorted using the sort computer of the invention into a first group of 8⁵=65,536 beads that is retained and a second group of other beads that is discarded, as follows. Beads in the first group have, for example, the following eight possible amounts of each dye: 0 to 0.75×10¹⁰ molecules, 1.25 to 2×10¹⁰ molecules, 2.5 to 2.75×10¹⁰ molecules, 3.75 to 4.5×10¹⁰ molecules, 5 to 5.75×10¹⁰ molecules, 6.25 to 7×10¹⁰ molecules, 7.5 to 8.25×10¹⁰ molecules, and 8.75 to 9.5×10¹⁰. The second group contains beads in which one or more of the dye amounts falls outside or in between these ranges. Thus, if the amount of dye in each bead is evenly distributed between 0 and 10¹¹ molecules, about (0.75/1.25)⁵=(3/5)⁵=243/3125 of the beads are retained in group 1, and the remaining about 92% of the beads are discarded. The resulting beads remaining in group 1 occupy 8⁵ discrete grid spaces in the 5-dimensional parameter space described above.

During the sorting of beads into group 1 and group 2, the number of beads in each grid space is recorded and stored in a database within the sort computer. Because the distribution of beads in the parameter space is often uneven and because of Poisson distribution effects, some grid spaces may have relatively few beads or no beads at all. An aspect of the invention is the recognition of the utility of creating a set of beads that are divided into grid spaces, which are topologically disconnected in the parameter space. Two reasons for the division into grid spaces are as follows. First, during the oligonucleotide synthesis described below (or oligopeptide synthesis), there can be some bleaching of the dyes in a bead, such that the position of the bead in the parameter space is shifted. Such shifts can accumulate and result in a significant total shift during the repeated rounds of synthesis and FACS sorting. For example, as described below, a given population of beads may be sorted 15 to 30 times during the combinatorial synthesis of the invention. It is for this reason that it is also preferable to use dyes with minimal tendency to bleach. Second, there is some error in the quantification of fluorescence by a FACS machine. The resulting encoded population of beads is suitable for synthesis of a directed library, such as the oligonucleotide library described by Hudson et al.

Each of the approximately 12,000 nucleotide sequences of Hudson et al. is placed in a computer database. Each of these sequences is then associated with one or more grid spaces to form a sequence/grid space database. In one variation of this method, the first 12,000 grid spaces containing at least a given number of beads are associated randomly with the oligo sequences. For example, after beginning with 10⁶ beads and recovering about 80,000 beads in the encoded population as described above, most grid spaces will have only one bead. Twelve thousand grid spaces containing one or more bead each are assigned to each oligo sequences, and then synthesis is initiated. Beads in unassigned grid spaces are discarded during synthesis. In a second variation, multiple grid spaces are assigned to a given oligo sequence, such that the total number of beads for each oligo is about the same.

The assignment of grid spaces to oligomer sequences is performed by a computer program, and is preferably run within the sort computer. The creation of such a computer program is within the capabilities of those skilled in the art of computer programming.

It is important to recall that the specific oligomers to be synthesized are either 5′ or 3′ oligomers. Each 5′ oligomer has the sequence 5′ GGAATTCCAGCTACCACCATGN₂₀ 3′, which corresponds to 19 bases common to all 5′ oligomers, a 3-base start codon, and the subsequent 20 bases of the 5′ end of a yeast gene. Each 3′ oligomer has the sequence 5′ GATCCCCGGGAATTGCCATG-END-N₂₀ 3′, which corresponds to 20 bases common to all 3′ oligomers, 3 bases complementary to a stop codon, and the adjacent 20 bases complementary to the 3′ end of a yeast gene. The purpose of the common sequences is for subsequent amplification by universal primers.

In the next step, oligonucleotide synthesis is initiated on the beads. A cleavable linker is used. When using a standard phosphoramidite synthesis, the 3′ base of an oligonucleotide is the first to be attached to a silica solid support, and synthesis proceeds in a 3′ to 5′ direction. The beads are mixed, placed into a FACS machine with an associated sort computer, and sorted into four groups corresponding to G, A, T, and C, which refer to the 3′-most base on each oligonucleotide. The four groups of beads are then reacted with standard, protected versions of G, A, T, and C coupled to a cleavable linker, such that the linker-base molecules covalently attach to the reactive groups on the bead.

The beads are then sorted again with the FACS machine/sort computer into G, A, T, and C groups, which now correspond to the second 3′-most base in the sequence of each oligonucleotide. The process is repeated a total of 23 times. After the final addition of the oligonucleotide-specific bases, the oligomer-bead library is sorted into two groups, corresponding to the 5′ oligomer-beads and the 3′ oligomer-beads.

In the next step, all of the 5′ beads are put through a series of reactions so that they all receive the same terminal 19 bases, and all of the 3′ beads are put through a separate series of reactions so that they receive a common set of 20 bases that are distinct from those on the 5′ beads. The oligonucleotides are now completely synthesized. It is convenient to store the beads with oligonucleotides together as a library, and when it is desirable to obtain two particular oligonucleotides to amplify a particular yeast gene, the oligomer-bead library is sorted with a FACS machine and sort-computer. The beads carrying the 5′ and 3′ oligomers for the gene of interest are sorted into either two or one channel, depending on the number of channels in the FACS machine, and all the other beads are sorted into another channel. The oligomers are then cleaved from the beads and deprotected using standard procedures. The concentration of the oligomers is optionally estimated and then the oligomers are used for a first round of PCR amplification of the desired yeast gene. The product of this amplification step is re-amplified with universal primers as described in Hudson et al.

The procedures described in this example produces about 10¹² to 10¹³ molecules of a given oligonucleotide. This corresponds to about 130 picomoles. Since a typical PCR reaction requires about 1 picomole of each oligonucleotide, the procedure produces enough for this purpose. The entire synthesis produces about 1.5 micromoles, or about 1.5 milligrams of total oligonucleotide.

It is possible to scale down the procedure such that 1 picomole or less is used. For example, smaller beads or fewer beads per oligomer are used. Since the oligomers are designed to allow for a second round of PCR using universal 5′ and 3′ primers as described by Hudson et al., it is reasonable to contemplate a synthesis strategy in which less than a picomole of each oligomer is generated, and then to perform a PCR reaction that is either suboptimal or is done in a smaller volume than the standard 25 to 50 microliters. It is important to note that the procedure could easily be modified to generate about 10-fold more oligonucleotides, such that oligomers capable of amplifying all the coding sequences in the human genome could be generated.

### EXAMPLE 3

### Summary of a Flow Cytometric Determination of Combinatorial Reaction Histories According to the Invention

A split-process-recombine procedure involving m steps, step 1, step 2, . . . , step m, and n(i) processes at step i (i=1,2, . . . , m) may be defined as follows. For i=1,2, . . . , m, let the n(i) processes at step i be P1(i), P2(i), . . . , Pn(i)(i). At each step i=,2, . . . , m:

the sort computer partitions the beads into n(i) subsets S1(i),S2(i), . . . , Sn(i)(i);

for j=1,2, . . . , n(i) process Pj(i) is performed on the beads in subset Sj(i);

the beads are recombined.

Examples of such processes include the combinatorial synthesis of oligonucleotide and oligopeptide chains. In these examples, insoluble beads (colloidal particles, typically 1-1000 μm in diameter) may be used as the carriers onto which monomers (e.g. nucleic acid, amino acid or peptide nucleic acid) are attached and sequentially grown. By performing a split-process-recombine procedure repeatedly for a large number of beads, with the sort computer directing beads into known vials, specific oligonucleotide or polypeptide sequences can be synthesized. Each bead thus contains an attached polymer with a unique sequence, which is defined by the sequence of processing events that the bead has experienced.

In view of the above, the present invention relates to a novel and convenient method to determine the sequence of processes applied to each of the beads involved in a split-process-recombine procedure. This procedure involves, for i=1,2, . . . , m and j=1,2, . . . , n(i), passing the carriers in the subset Sj(i) through a sorting device to obtain a signature or code for each of the beads present in the subset. The code of each bead will be determined by a combination of features of the beads as described above. The coding data is stored for the purpose of determining the sequence of processes (i.e., reaction history of the bead) applied to each of the beads.

The code of a particular bead for which the process history is required is checked against the list of codes which has been stored for each subset Sj(i). The set of subsets Sj(i) in which the particular bead's code occurs determines the set of processes Pj(i) which have been performed on the bead and hence its entire process history. It is desirable, therefore, that the code of any bead be reproducible and distinguishable from the code of any other bead which is used in the split-process-recombine procedure. In this regard, split-process-recombine procedures may be employed in the manufacture of beads in order to facilitate efficient production of extremely large numbers of distinguishable particles. In a preferred embodiment, flow cytometric techniques are used to sort and remove subpopulations of indistinguishable beads. However, partial or complete determination of process histories that are sought may be obtained without perfect code distinction and reproducibility. For example, if two beads become detectably indistinguishable in the seventh step of a 10-step split synthesis, and then the reaction history of either bead through steps 8 to 10 may be used to deduce the reaction history for those particles.

### EXAMPLE 4

### Synthesizing an Oligonucleotide Library Using the Directed Synthesis Method

An exemplary technique for synthesizing an oligonucleotide library using the directed synthesis method is carried out as follows.

(a) Optically distinguishable carriers suitable for oligonucleotide synthesis are prepared as described and sorted using the flow cytometer and sort computer according as above. Oligonucleotide sequences to be synthesized are selected and their length chosen.

(b) The beads are introduced into the fluidics of a flow cytometer (a Cytomation MoFlo, equipped with a sort computer) as normal. The sort computer apportions the beads into up to four reaction vessels (depending on the oligonucleotide sequences selected in step (a), for example, all of the sequence might start with an adenine, thus, all of the carriers would be directed into one vessel). The sort computer determines and records the codes of the beads in order to track the movement of these individual detectably distinct beads into the up to four reaction vessels.

(c) Once collected, each bead solution is thoroughly washed in acetonitrile to remove trace water. This step is done using centrifugation or cross-flow filtration.

(d) Each of the four bead/acetonitrile solutions is placed into four disposable Twist columns (manufactured by Glen Research, Stirling, Va., USA), which are designed to fit into a Beckman Coulter Oligo-1000M automated DNA synthesizer. This step is performed in the absence of humidity, for example under a nitrogen or argon atmosphere in a glove box.

(e) Each set of beads receives a different phosphoramidite containing one of the nucleic acids, adenine, thymine, cytosine, and guanine. These phosphoramidites, protected by a DMT protecting group, are covalently coupled to the linker groups present on the beads using conventional phosphoramidite chemistry in the automated synthesizer.

(f) After synthesis, the beads are pooled and washed with saline solution identical to that used in the flow cytometer.

(g) Steps (b) through (f) are repeated as necessary (according to the oligonucleotide length chosen in step (a)) to create a directed compound library wherein member compounds of the library are associated with the detectably distinct beads and wherein codes of the detectably distinct beads are deconvolutable using tracking data provided by said recordal steps to identify the sequence of reactions experienced by the said detectably distinct beads.

The conditions for hybridizaton of target single stranded, fluorescently labelled DNA to the bead-based oligonucleotide probes is established through testing under various temperature conditions. The following conditions are used as a starting point, but these conditions vary according to melting temperature. Buffer: HEPES 20 nM pH=7.5; KCl 300 mM; IGEPAL 0.1%. Target oligonucleotide concentration: 1-500 nM. Ideal hybridization temperature is investigated by conducting experiments at temperatures between 45° C and 75° C in intervals of 3-5° C for various time periods over one hour.

Hybridization is scored by flow cytometry in a Cytomation MoFlo, which has temperature control capability. A great advantage of this technology is that the beads do not require washing as is currently done with microarrays; thus, bead based libraries are allowed to come to equilibrium. The fluorophore used to label the target DNA is chosen to be spectroscopically different to those fluorophores used to encode the beads, thus, the target label can be read independently by a detector especially chosen to read the ‘hits’.

The bead sequences on which hits are found are decoded using data that was stored by the sort computer during library synthesis.

### EXAMPLE 5

### Gene Expression Analysis Using a Bead-Oligomer Library Synthesized Via a Directed Synthesis

In this example, a bead-oligo library is constructed in which each bead has an oligonucleotide sequence corresponding to a sequence in an mRNA from an organism. The bead-oligo library is synthesized via a directed synthesis as described herein.

The mRNA population to be studied is reverse-transcribed using fluorescent precursors, so that a labeled cDNA population is generated. The beads are synthesized such that the label on the cDNA is different from the fluorescent labels used to encode the beads, and bead labels and the cDNA label can be read independently. The labeled cDNA population is hybridized to the bead-oligo library and washed under standard conditions. The hybridized library is then scored for hybridization events by flow cytometry, in which the identity of each bead and the amount of hybridized material is quantified.

In this case, the following features may be incorporated into the library. There are multiple sequences corresponding to different regions of each MRNA and these sequences can be synthesized onto beads using the directed synthesis methods as described. The oligonucleotides on the beads can be any length amenable to synthesis, but are preferably 15 to 35 bases long, and more preferably 20 to 30 bases long. Twenty-five bases is a particularly convenient length to use. In one variation, the base composition of each oligonucleotide is chosen to be about 50% G+C, so that the hybridization experiment can be performed at a single temperature, and incorrect hybridization will be minimized. For each oligo that should hybridize to a given mRNA, there is a control oligo in which a central base is altered, which indicates when incorrect hybridization may be taking place. In one embodiment, about 50,000 oligonucleotide molecules per square micron are synthesized onto the surface of the bead. In some circumstances, it is useful to use other densities. For example, there are situations in which artifactual hybridization can result from an mRNA with a repeated mismatched sequence hybridizing to a bead, due to multivalent hybridization. In such cases it is useful to reduce the density of the oligomers on the beads.

Use of the encoded beads allows a more precise quantification of mRNA levels in a sample. As described above, a labeled cDNA population is generated from an mRNA population to be studied. A series of dilutions of the labeled cDNA, such as ten-fold dilutions, are then prepared. Each dilution is then hybridized to a replica of the oligo-bead library under conditions that allow the hybridization to proceed essentially to completion. With an appropriate starting concentration of cDNAs, more rare transcripts will simply be absent from the hybridization mixtures derived from higher dilutions of the starting cDNAs. In principle, such an experiment could also be performed using two-dimensional arrays, but the expense of these arrays precludes such an experiment in practice, and only a single array is used to examine a given mRNA population.

Induction of TNF-α gene in LPS-stimulated murine macrophage (RAW246) clones is investigated by using libraries of oligonucleotide prepared by directed synthesis as described herein.

Having optimized hybridization conditions and decided on an appropriate oligonucleotide probe length, induction of TNF-α gene in LPS-stimulated RAW246 clones is investigated. mRNA is isolated from five RAW264 clones with and without a four hour LPS stimulation, and labeled cDNA is produced by incorporating Cy3 or Cy5, respectively.

The mRNA population to be studied is reverse-transcribed using fluorescent precursors, so that a labeled cDNA population is generated. The beads are synthesized such that the label on the cDNA is different from the fluorescent labels used to encode the beads, and bead labels and the cDNA label can be read independently. The labeled cDNA population is hybridized to the bead-oligo library and washed under standard conditions. The hybridized library is then scored for hybridization events by flow cytometry, in which the identity of each bead and the amount of hybridized material is quantified.

### EXAMPLE 6

### Synthesis of a Directed Oligonucleotide Library Capable of Forming Hairpin Duplexes

Optically distinguishable carriers suitable for oligonucleotide synthesis are prepared as described. Oligonucleotide sequences to be synthesized are selected and their length chosen.

(a) The beads are introduced into the fluidics of the flow cytometer (e.g. a Cytomation MoFlo, equipped with a sort computer) as normal. The sort computer apportions the beads into up to four reaction vessels (depending on the oligonucleotide sequences selected in step (a), for example, all of the sequence might start with an adenine, thus, all of the carriers would be directed into one vessel). The sort computer determines and records the codes of the beads in order to track the movement of these individual detectably distinct beads into the up to four reaction vessels.

(b) Once collected, each bead solution is thoroughly washed in acetonitrile to remove trace water. This is done using centrifugation or cross-flow filtration.

(c) Each of the four bead/acetonitrile solutions is placed into four disposable Twist columns (manufactured by Glen Research, Stirling, Va., USA), which are designed to fit into a Beckman Coulter Oligo-1000M automated DNA synthesizer. This step is performed in the absence of humidity, for example under a nitrogen or argon atmosphere in a glove box.

(d) Each set of beads receives a different phosphoramidite containing one of the nucleic acids, adenine, thymine, cytosine and guanine. These phosphoramidites, protected by a DMT protecting group, are covalently synthesized onto the linker groups present on the beads using conventional phosphoramidite chemistry in the automated synthesizer.

(e) After synthesis, the beads are pooled and washed with saline solution identical to that used in the flow cytometer.

(f) Steps (b) through (f) are repeated as necessary (according to the oligonucleotide length chosen in step (a)) to create a directed compound library wherein member compounds of the library are associated with the detectably distinct beads and wherein codes of the detectably distinct beads are deconvolutable using tracking data provided by said recordal steps to identify the sequence of reactions experienced by the said detectably distinct beads.

(g) A flexible spacer group is synthesized or attached to the end of the oligonucleotide sequence. This spacer group must be able to undergo a conformation to a hairpin structure. These spacer groups may be one or more nucleotides for example.

(h) Since the exact sequence prior to the spacer group on each synthesized oligonucleotide is known by the sort computer, the complement of the prior sequence can be continued after the spacer group, such that hybridization can occur (under appropriate buffer and temperature conditions) on formation of the hairpin turn (FIG. 51).

The presence of a hairpin turn at the end of each oligonucleotide may permit the formation of a double helical structure formed between the two complementary oligonucleotide subsequences either side of the spacer group. The presence of this double helix assists in hybridization of target sequence to the oligonucleotide sequence.

### EXAMPLE 7

### Screening Libraries More Than Once to Obtain the Best Hit Discrimination

Screening of bead libraries involves exposure of the bead libraries to a fluorescently labeled target molecule. This target molecule may bind to one or more compounds which are attached to individual beads. This is known as a “hit”, and the consequence of this is that the bead fluoresces the same color as the label on the target molecule. Providing the fluorophores used to encode the bead itself are distinguishable from the target label, the “hit” sequence can be decoded. Sometimes, there is non-specific binding of a target sequence to a bead (rather than specific binding to a compound on the bead) or the target binds to a sequence on a bead that is not its completely complementary sequence (i.e., it forms a mismatched sequence). One method for enhancing the mismatch discrimination, is to expose the bead library more than once to the target sequence solution, with washing in between.

To obtain hit discrimination, an example method is as follows:

a. expose the bead libraries to the fluorescently labeled target,

b. send the beads through the FC as described, sort out hits and decode using the sort computer. The beads that display a hit fluorescence above (or below in some cases where the fluorophore gets cleaved off) a chosen threshold are removed from the other library members.

c. the chosen beads are again exposed to the fluorescently labeled target, and

d. steps (b) and (c) are repeated for a chosen number of steps until satisfied the real hits have been discovered. Since the sort computer stored the optical signature of the beads during library synthesis, decoding the hit sequences is simple. Note that the other beads which displayed some but not necessary high affinity for the target can also be investigated further at a later date. These sequences are also known, as they were stored by the sort computer during compound synthesis.

### EXAMPLE 8

### Preparation of a Subpopulation of Beads from an Optically Diverse Set of Beads

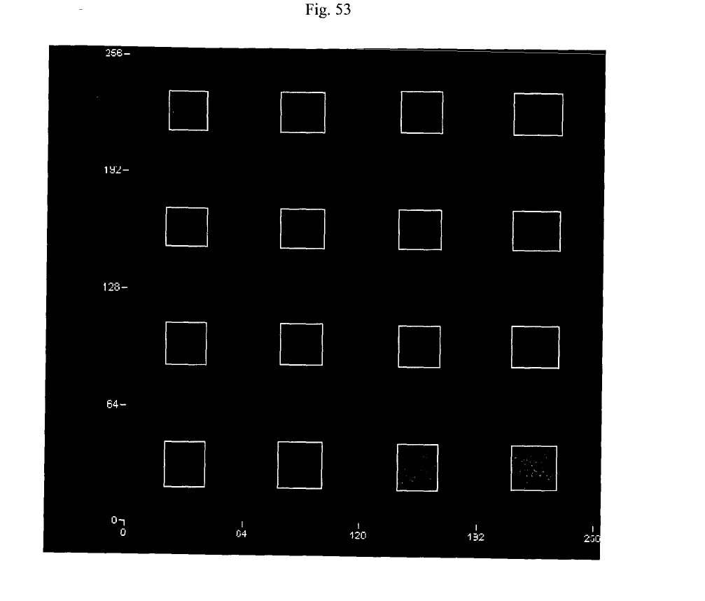

Many subpopulations of beads can be easily prepared from an optically diverse set, where beads within a subpopulation have a similar optical signature, and where beads from any subpopulation are optically distinguishable from beads in every other subpopulation. Rather than synthesizing each subpopulation individually, an optically diverse set of beads is run through the flow cytometer where the subpopulations are sorted. This sorting is accomplished using the software of the flow cytometer to form a gate around a particular region on the flow cyometry plot (e.g., rectangular, square, or circular gate that is X channels wide and Y channels high in each two dimensional plot), and collecting only those beads within that region into an individual vessel. This could be done in parallel with a number of gates, for example, sixteen, as shown in FIG. 53. Naturally, any combination of subpopulations can also be collected into the same vessel for later analysis or additional sorting. Fluorophores chosen for encoding include those suited towards each of the various commercial flow cytometers, which have slightly different optical filters as standard. These flow cytometers include the Cytomation MoFlo, Becton Dickinson FACSVantage, and the Coulter Epics XL and MXL, for example.

### EXAMPLE 9

### Preparation of Subpopulations of Beads from an Optically Diverse Set of Beads, Using the Sort Computer

As an alternative to Example 8, the sort computer (rather than the flow cytometer software) is used to direct beads into certain subpopulations, so that the beads within a subpopulation have similar optical signatures. Another variation is to use the sort computer in combination with the flow cytometer software to direct beads into certain subpopulations, so that the beads within a subpopulation have similar optical signatures.

Another method, is to use the sort computer to direct beads of widely varying optical signatures into the same vessel, and then coupling or synthesizing a chosen library compound onto the beads.

Each grid space may be represented by a value that may be encoded by one or more bytes. This value represents the upper limit of beads to sort in a particular sort direction. The sort computer could then be instructed to sort beads in predetermined grid spaces in only one sort direction by appropriate grid space memories uploaded to the sort computer board. This sorting could be accomplished by making the values in the grid spaces of interest equal to zero, and the values in every other grid space equal to the upper limit.

### EXAMPLE 10

### Methods for Speeding Up the Collection of Subpopulations from an Optically Diverse Set of Beads

Since the current state-of-the-art flow cytometers have only four way sorting, the methods for collecting subpopulations four at a time, can be time consuming. Improvements on this technique include:

(a) Running the optically diverse bead set through a multitude of flow cytometers running simultaneously, so that a different set of four subpopulations can be collected from each machine.

(b) Set up multiple streams on one flow cytometer so that more than four subpopulations can be collected simultaneously.

(c) Set up more capacitor plates underneath the current capacitor places used for collection of subpopulations. This would mean subpopulations of subpopulations etc could be collected, looking much like a family tree, but being collected all at the same time.

(d) Improve the number of directions a flow cytometer can sort.

### EXAMPLE 11

### Preparation of a Non-Combinatorial Library on Subpopulations of Beads

Once a chosen number of subpopulations of bead have been sorted according to one or more methods described herein, different compounds, for example amine modified oligonucleotides, cDNAs, or small organic molecules, are attached to the functional groups on each subpopulation of beads. The beads already have an appropriate linker group and/or functionality to permit covalent or physical binding of a full length (pre-synthesized, or preexisting) compound, such as a cDNA, or oligonucleotide. Also, the linker is chosen such that it is cleavable or non-cleavable, depending on the purpose of the screen. For example, if there is streptavidin already coupled to the beads, then biotinylated oligonucleotides can be attached to the beads under the normal buffer conditions used for streptavidin/biotin binding. As another example, if the beads are functionalized with carboxylic acid groups, and the compounds (e.g., oligonucleotides) are amine modified, then through the use of a carbodiimide or similar reagent, known in the prior art, covalent binding will occur under the appropriate conditions, thereby forming an amide bond.

To couple presynthesized oligonucleotides to the beads, for example, a standard coupling procedure of amine modified oligonucleotides to carboxylic acid beads is used. A 100 μl aliquot of beads is washed 3 times in pH 5 MES buffer with 0.01% Triton X100 and 70 μl of 25 μM amine DNA solution is added and allowed to stand for 30 min. 30 μl of 100 mg/ml solution of fresh, cold EDC solution is added to the reaction mixture and allowed to react for 90 min in the refrigerator. The oligonucleotide coupled beads are then washed 3 times with the pH 5 MES buffer with 0.01% Triton X100.

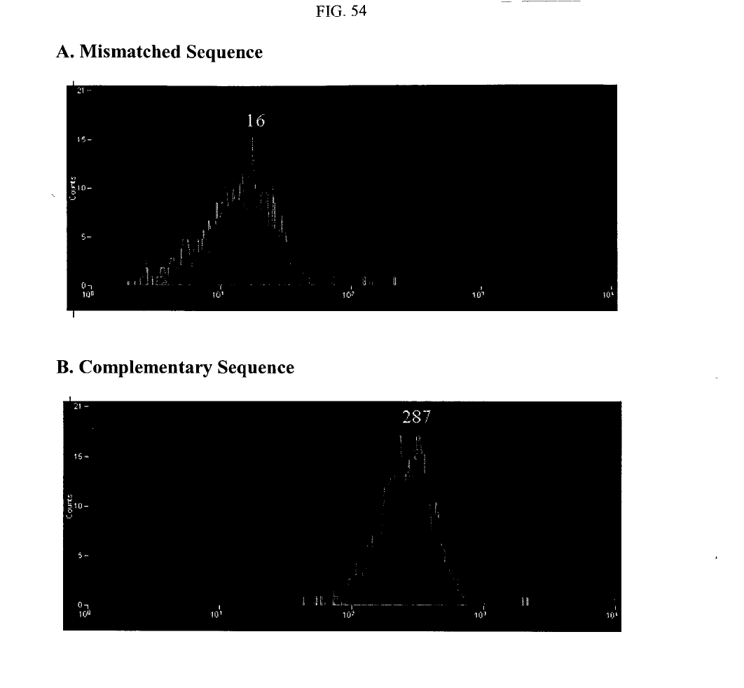

Aliquots of each subpopulation are removed, mixed together, and exposed to one or more fluorescently labeled target molecules under selected hybridization conditions. DNA hybridization of complementary (5′TACAGGCCTCACGTTACCTG) and mismatched (5′CAGGTAACGTGAGGCCTGTT) sequences was performed by hybridizing the particles with fluorescently labeled target sequences (5′CAGGTAACGTGAGGCCTGTT) in pH 8 MES with a 100 nM concentration of fluorescent probe (see FIG. 54) This data clearly shows that the complementary sequence (average fluorescent intensity of 287 A.U.) can be discriminated from the non-complementary mismatched sequence (average fluorescent intensity of 16 A.U.) using a flow cytometer.

Hits are scored by the flow cytometer and the beads are decoded by reviewing the position of the subpopulation on a flow cytometer plot, and/or by recalling the data that was stored by the sort computer during sorting of the beads into subpopulations. A significant advantage of this system is the improvement in hit discrimination. A hit sequence would only be accepted as a hit if a significant/chosen number of beads from the same aliquot from a subpopulation were displayed as hits (at least 10 beads, preferably up to 1000 or more).

### EXAMPLE 12

### Preparation of Directed Libraries on Encoded Subpopulations of Beads

Once a chosen number of subpopulations of bead have been sorted according to one or more methods as described herein, a different compound can be synthesized onto each subpopulation using conventional solid phase synthesis methods (e.g., peptide synthesis, oligonucleotide synthesis, or peptide nucleic acid oligomer synthesis). For example, an oligonucleotide library can be synthesized. Eight subpopulations of beads are washed in acetonitrile to remove trace water, placed into separate Twist columns which are fitted onto an automated oligonucleotide synthesizer which has capability to perform simultaneous reactions. Twist columns are desirable for the ability to remove beads easily after synthesis. Normally, automated synthesizers use controlled pore glass beads to synthesize oligonucleotides, but these oligonucleotides are cleaved off. In the case described here, the oligonucleotides must remain attached to the beads to enable screening of the oligonucleotides while they are still attached to beads. In this example, eight different oligonucleotide sequences are simultaneously synthesized on eight subpopulations of beads. This process is continued until all of the chosen subpopulations have a different oligonucleotide synthesized onto them. Aliquots of each subpopulation are removed, mixed together, and exposed to one or more fluorescently labeled target molecules under selected hybridization conditions. Hits are scored by the flow cytometer and the beads are decoded by reviewing the position of the subpopulation on a flow cytometer plot, and/or by recalling the data that was stored by the sort computer during sorting of the beads into subpopulations. A significant advantage of this system is the improvement in hit discrimination. A hit sequence would only be accepted as a hit if a significant/chosen number of beads from the same aliquot from a subpopulation were displayed as hits.

Two subpopulations of encoded beads, functionalized with a primary hydroxy group and sorted according to one or more methods as described, were chosen. A complementary oligonucleotide sequence (5′TACAGGCCTCACGTTACCTG) was synthesized on one subpopulation using the standard phosphoamidite chemistry of the automated DNA synthesizer, the Beckman-Coulter Oligo-1000M. A mismatched (5′CAGGTAACGTGAGGCCTGTT) sequence was synthesized on the other subpopulation using the standard phosphoamidite chemistry of the Beckman-Coulter Oligo-1000M.

DNA hybridization of complementary (5′TACAGGCCTCACGTTACCTG) and mismatched (5′CAGGTAACGTGAGGCCTGTT) sequences is performed by hybridizing the particles with fluorescently labeled target sequences (5′CAGGTAACGTGAGGCCTGTT) in pH 8 MES with a 100 nM concentration of fluorescent probe. The subpopulation with the complementary sequence is discriminated from the non-complementary mismatched sequence in the flow cytometer, with results similar to those shown in FIG. 54.

### EXAMPLE 13

### Control of Fluorescence Photobleaching on Multiple Passes Through the Flow Cytometer

Initially a set of particles (optically diverse in n dimensions) are passed through the flow cytometer and sorted into x intensity populations for each dye dimension. In this example a diverse population containing the dyes Oregon Green and Rhodamine B in 2 dimensions (n=2) was sorted into 4 intensity populations (x=4), to give 16 distinct populations. To make the populations distinguishable it is necessary to space the populations so that there is no cross contamination of the distinct populations. For this example the distance between the populations is double the width of the population.

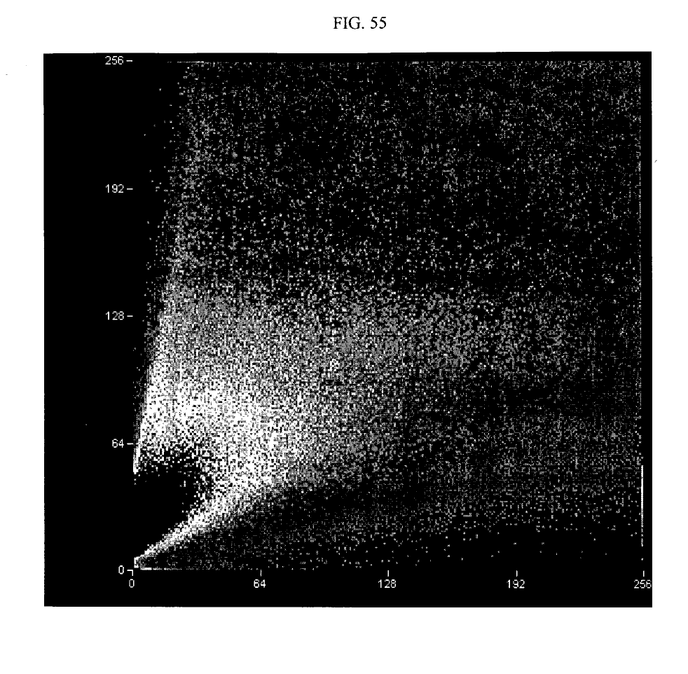

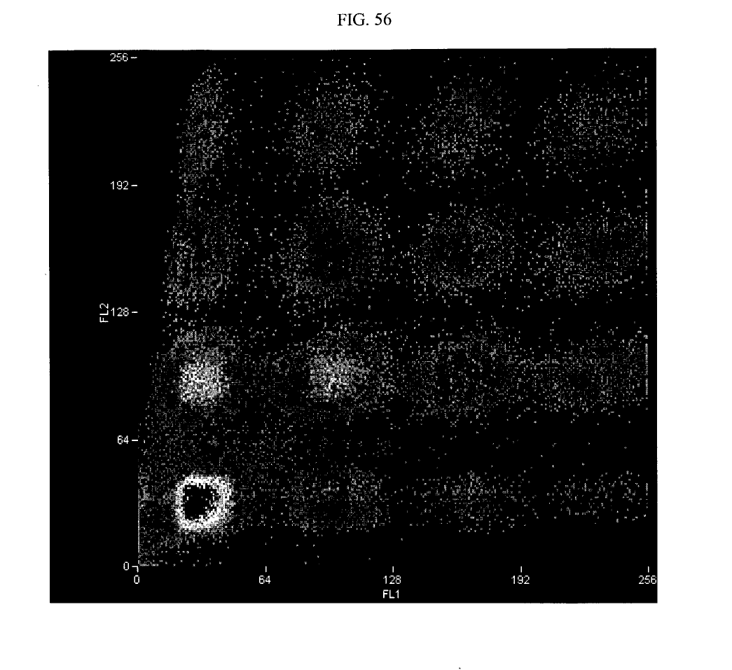

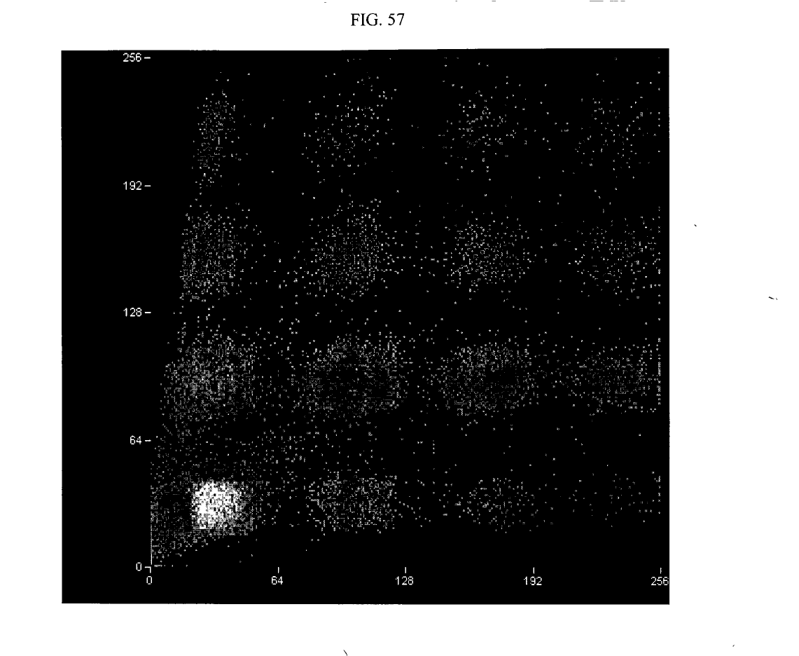

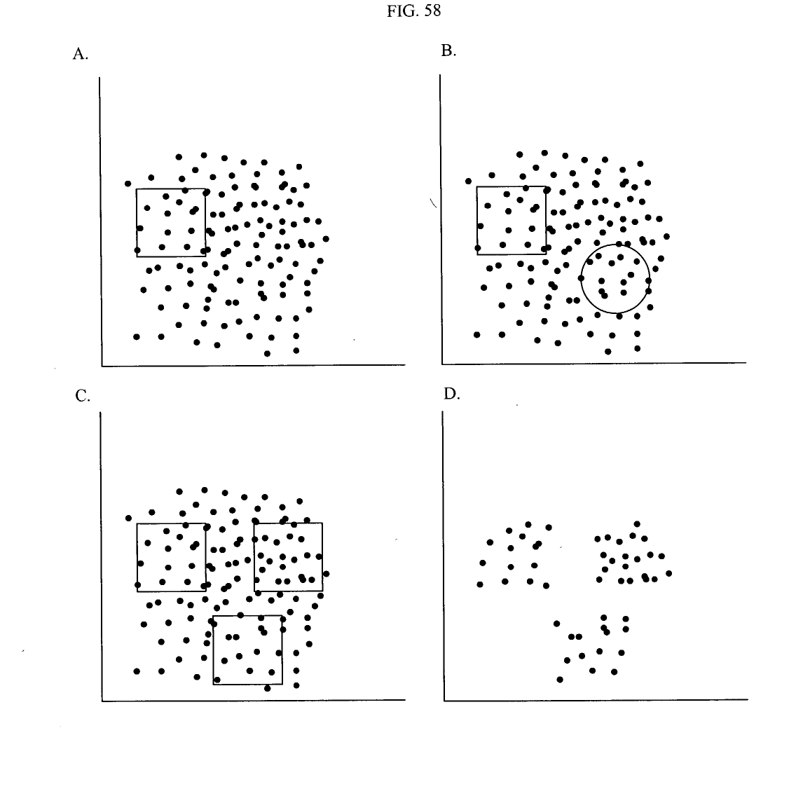

FIG. 55 shows the initial diverse set of beads before they are sorted in the flow cytometer. FIG. 56 shows the distinct populations of beads after they have been sorted by the flow cytometer and passed through the machine for a second time. FIG. 57 shows the same set of particles passed through the flow cytometer for a third time. This demonstrates that multiple passes through the flow cytometer do not significantly effect the optical signature of the particles, and are still distinguishable in distinct populations. The change in fluorescence intensity for each of the two dyes, as they undergo multiple passes through the flow cytometer, is presented in Tables 4 and 5.

TABLE 4
Change in fluorescence intensity for Oregon Green 488 dye
in beads encoded with Oregon Green and Rhodamine B,
after multiple passes through the flow cytometer.
Change in Fluorescence Intensity for Oregon Green Dye

| | Average Fluorescent Intensity | | | Difference in Intensity | |
|---|---|---|---|---|---|
| Population | Initial | 1^{st} Rerun | 2^{nd} Rerun | 1^{st} Rerun | 2^{nd} Rerun |
| 1 | 31.2 | 31.4 | 32.4 | +0.64% | +3.85% |
| 2 | 94.9 | 97.1 | 100.6 | +2.32% | +6.00% |
| 3 | 159.1 | 163.4 | 168.3 | +2.70% | +5.78% |
| 4 | 222.5 | 227.5 | 231.2 | +2.25% | +3.91% |

TABLE 5
Change in fluorescence intensity for Rhodamine B dye
in beads encoded with Oregon Green and Rhodamine B,
after multiple passes through the flow cytometer.
Change in Fluorescent Intensity for Rhodamine B Dye

| | Average Fluorescent Intensity | | | Difference in Intensity | |
|---|---|---|---|---|---|
| Population | Initial | 1^{st} Rerun | 2^{nd} Rerun | 1^{st} Rerun | 2^{nd} Rerun |
| 1 | 31.2 | 31.9 | 31.6 | +2.24% | +1.28% |
| 2 | 97.0 | 94.0 | 93.2 | −3.09% | −3.92% |
| 3 | 160.2 | 155.7 | 155.1 | −2.81% | −3.18% |
| 4 | 224.0 | 218.4 | 217.6 | −2.50% | −2.86% |

### Other Embodiments

Each patent, patent application, and publication referenced in this application is hereby incorporated by reference.

While the invention has been described in connection with specific embodiments, it will be understood that it is capable of further modifications. Therefore, this application is intended to cover any variations, uses, or adaptations of the invention that follow, in general, the principles of the invention, including departures from the present disclosure that come within known or customary practice within the art.

Other embodiments are in the claims.

What is claimed is:

1. A method for directing the synthesis of a combinatorial library of oligomers, said method comprising the steps of:
(a) prior to coupling, assigning a predetermined oligomer sequence to each of a plurality of carriers, wherein each of said plurality of carriers comprises a distinguishable feature;
(b) sorting said plurality of carriers into a plurality of reaction vessels, wherein the vessel into which each carrier is sorted is determined by the oligomer assigned to each carrier based on said distinguishable feature, and wherein each carrier is sorted independently of the other carriers;
(c) performing a reaction to couple a chemical moiety to each carrier in each vessel, wherein the chemical moiety is the same or different in different vessels;
(d) repeating steps (b) and (c) at least once, wherein, in each step, a subsequent chemical moiety is coupled to the previously added chemical moiety to produce a plurality of oligomers, thereby directing the synthesis of a combinatorial library of oligomers.

2. The method of claim 1, further comprising the step, between steps (c) and (d), of pooling the carriers in each of said vessels.

3. The method of claim 1, wherein each carrier in said plurality of carriers comprises a unique distinguishable feature.

4. The method of claim 1, wherein said chemical moiety comprises a deoxyribonucleotide, a ribonucleotide, an amino acid, a saccharide, a peptide nucleic acid, a carbonate, a sulphone, a sulfoxide, a nucleoside, a carbohydrate, a urea, a phosphonate, a lipid, or an ester.

5. The method of claim 1, wherein said chemical moiety is protected.

6. The method of claim 1, wherein prior to step (c), a linker is coupled to each of said plurality of carriers.

7. The method of claim 6, wherein said linker is cleavable.

8. The method of claim 7, further comprising, after step (e), cleaving said linker.

9. The method of claim 6, wherein said linker is not cleavable.

10. The method of claim 1, wherein each carrier comprises a reactive group.

11. The method of claim 1, wherein in step (a), said plurality of carriers is sorted into at least four vessels.

12. The method of claim 1, wherein in step (a), said carriers are sorted in a flow cytometer.

13. The method of claim 1, wherein said distinguishable feature is detectable by fluorescence, light scatter, color, luminescence, phosphorescence, infrared radiation, x-ray scatter, light absorbance, surface plasmon resonance, electrical impedance, or a combination thereof.

14. The method of claim 1, further comprising step (e), cleaving at least one of said plurality of oligomers from one of said plurality of carriers.

15. The method of claim 1, wherein said carrier is a bead.

16. A library of encoded carriers, said library comprising a plurality of carriers wherein each of said carriers comprises a unique distinguishing feature and a unique oligomer bound to said carrier.

17. The library of claim 16, wherein said library comprises at least 1,000, 10,000, 100,000, or 1,000,000 carriers.

18. The library of claim 16, wherein said library comprises between 1,000 and 1,000,000 carriers.

19. The library of claim 16, wherein said oligomer comprises a deoxyribonucleotide, a ribonucleotide, an amino acid, a saccharide, a peptide nucleic acid, a carbonate, a sulphone, a sulfoxide, a nucleoside, a carbohydrate, a urea, a phosphonate, a lipid, or an ester.

20. The library of claim 16, wherein said unique oligomer is bound to said carrier via a linker.

21. The library of claim 20, wherein said linker is cleavable.

22. The library of claim 20, wherein said linker is not cleavable.

23. The library of claim 16, wherein said carriers are beads.

24. A device for sorting carriers, said device comprising:
(a) a sorter comprising a flow path that splits into at least two branches into which carriers can be sorted;
(b) one or more detectors capable of detecting said carriers in said flow path, wherein said one or more detectors are disposed to detect said carriers prior to passing into one of said branches;
(c) a computer that determines the branch into which each carrier is sorted based on one or more signals from each carrier obtained from said one or more detectors.

25. The device of claim 24, wherein said sorter is a flow cytometer.

26. The device of claim 24, wherein said flow path splits into at least four branches.

27. The device of claim 24, wherein one of said one or more detectors detects fluorescence, light scatter, color, luminescence, phosphorescence, infrared radiation, x-ray scatter, light absorbance, surface plasmon resonance, or electrical impedance.

28. A sort computer, said computer comprising:
(a) an interface that is capable of receiving data that encodes a distinguishable feature of a carrier as it is passed through a sorting device comprising a flow path that splits into at least two branches;
(b) one or more memories that store the number of carriers having each distinguishable feature;
(c) a controller that is capable of controlling said sorting device to sort said carrier into one of said branches; and
(d) a sorting selector that determines into which branch said carrier is sorted based on the number of carriers having that distinguishable feature stored in said one or more memories.
